(19) United States
(12) Patent Application Publication
(10) Pub. No.: US 2009/0177409 A1
(43) Pub. Date: Jul. 9, 2009

(54) Method and system of computing and rendering the nature of atoms and atomic ions

(76) Inventor: Randell L. Mills, Cranbury, NJ (US)

Correspondence Address: MANELLI DENISON & SELTER, 2000 M STREET NW SUITE 700, WASHINGTON, DC, 20036-3307, US

(21) Appl. No.: 10/585,196

(22) PCT Filed: Jan. 5, 2005
(86) PCT No.: PCT/US05/00073

§ 371 Date: Jul. 3, 2006

Related U.S. Application Data
(60) Provisional application No. 60/542,278, filed on Feb. 9, 2004.
(60) Provisional application No. 60/534,112, filed on Jan. 5, 2004.
(60) Provisional application No. 60/640,213, filed on Jan. 3, 2005.

(51) Int. Cl. G01N 31/00; G06F 17/11; G06F 19/00

(52) U.S. Cl. 702/22; 703/2

(57) ABSTRACT

A method and system of physically solving the charge, mass, and current density functions of atoms and atomic ions using Maxwell's equations and computing and rendering the nature of bound using the solutions. The results can be displayed on visual or graphical media. The display can be static or dynamic such that electron spin and rotation motion can be displayed in an embodiment. The displayed information is useful to anticipate reactivity and physical properties. The insight into the nature of bound electrons can permit the solution and display of other atoms and atomic ions and provide utility to anticipate their reactivity and physical properties.

This application claims priority to U.S. Provisional Appl'n Ser. Nos. 60/542,278, filed Feb. 9, 2004, and 60/534,112, filed Jan. 5, 2004, the complete disclosures of which are incorporated herein by reference.

This application also claims priority to U.S. Provisional Appl'n entitled “The Grand Unified Theory of Classical Quantum Mechanics” filed Jan. 3, 2005, attorney docket No. 62226-BOOK1, the complete disclosure of which is incorporated herein by reference.

### 1. FIELD OF THE INVENTION

This invention relates to a method and system of physically solving the charge, mass, and current density functions of atoms and atomic ions and computing and rendering the nature of these species using the solutions. The results can be displayed on visual or graphical media. The displayed information is useful to anticipate reactivity and physical properties, as well as for educational purposes. The insight into the nature of bound electrons can permit the solution and display of other atoms and ions and provide utility to anticipate their reactivity and physical properties.

### 2. BACKGROUND OF THE INVENTION

While it is true that the Schrödinger equation can be solved exactly for the hydrogen atom, the result is not the exact solution of the hydrogen atom since electron spin is missed entirely and there are many internal inconsistencies and nonphysical consequences that do not agree with experimental results. The Dirac equation does not reconcile this situation. Many additional shortcomings arise such as instability to radiation, negative kinetic energy states, intractable infinities, virtual particles at every point in space, the Klein paradox, violation of Einstein causality, and “spooky” action at a distance. Despite its successes, quantum mechanics (QM) has remained mysterious to all who have encountered it. Starting with Bohr and progressing into the present, the departure from intuitive, physical reality has widened. The connection between quantum mechanics and reality is more than just a “philosophical” issue. It reveals that quantum mechanics is not a correct or complete theory of the physical world and that inescapable internal inconsistencies and incongruities arise when attempts are made to treat it as a physical as opposed to a purely mathematical “tool”. Some of these issues are discussed in a review by Laloë [Reference No. 1]. But, QM has severe limitations even as a tool. Beyond one-electron atoms, multielectron-atom quantum mechanical equations can not be solved except by approximation methods involving adjustable-parameter theories (perturbation theory, variational methods, self-consistent field method, multi-configuration Hartree Fock method, multi-configuration parametric potential method, 1/Z expansion method, multi-configuration Dirac-Fock method, electron correlation terms, QED terms, etc.)—all of which contain assumptions that can not be physically tested and are not consistent with physical laws. In an attempt to provide some physical insight into atomic problems and starting with the same essential physics as Bohr of e⁻ moving in the Coulombic field of the proton and the wave equation as modified after Schrödinger, a classical approach was explored which yields a model which is remarkably accurate and provides insight into physics on the atomic level [2-4].

Physical laws and intuition are restored when dealing with the wave equation and quantum mechanical problems. Specifically, a theory of classical quantum mechanics (CQM) was derived from first principles that successfully applies physical laws on all scales. Rather than use the postulated Schrödinger boundary condition: “Ψ→0 as r→∞”, which leads to a purely mathematical model of the electron, the constraint is based on experimental observation. Using Maxwell's equations, the classical wave equation is solved with the constraint that the bound n=1-state electron cannot radiate energy. The electron must be extended rather than a point. On this basis with the assumption that physical laws including Maxwell's equation apply to bound electrons, the hydrogen atom was solved exactly from first principles. The remarkable agreement across the spectrum of experimental results indicates that this is the correct model of the hydrogen atom. In the present invention, the physical approach was applied to multielectron atoms that were solved exactly disproving the deep-seated view that such exact solutions can not exist according to quantum mechanics. The general solutions for one through twenty-electron atoms are given. The predictions are in remarkable agreement with the experimental values known for 400 atoms and ions.

### Classical Quantum Theory of the Atom Based on Maxwell's Equations

The old view that the electron is a zero or one-dimensional point in an all-space probability wave function Ψ(x) is not taken for granted. The theory of classical quantum mechanics (CQM), derived from first principles, must successfully and consistently apply physical laws on all scales [2-7]. Historically, the point at which QM broke with classical laws can be traced to the issue of nonradiation of the one electron atom that was addressed by Bohr with a postulate of stable orbits in defiance of the physics represented by Maxwell's equations [2-9]. Later physics was replaced by “pure mathematics” based on the notion of the inexplicable wave-particle duality nature of electrons which lead to the Schrödinger equation wherein the consequences of radiation predicted by Maxwell's equations were ignored. Ironically, both Bohr and Schrödinger used the electrostatic Coulomb potential of Maxwell's equations, but abandoned the electrodynamic laws. Physical laws may indeed be the root of the observations thought to be “purely quantum mechanical”, and it may have been a mistake to make the assumption that Maxwell's electrodynamic equations must be rejected at the atomic level. Thus, in the present approach, the classical wave equation is solved with the constraint that a bound n=1′-state electron cannot radiate energy.

Thus, herein, derivations consider the electrodynamic effects of moving charges as well as the Coulomb potential, and the search is for a solution representative of the electron wherein there is acceleration of charge motion without radiation. The mathematical formulation for zero radiation based on Maxwell's equations follows from a derivation by Haus [16]. The function that describes the motion of the electron must not possess spacetime Fourier components that are synchronous with waves traveling at the speed of light. Similarly, nonradiation is demonstrated based on the electron's electromagnetic fields and the Poynting power vector.

It was shown previously [2-6] that CQM gives closed form solutions for the atom including the stability of the n=1 state and the instability of the excited states, the equation of the photon and electron in excited states, the equation of the free electron, and photon which predict the wave particle duality behavior of particles and light. The current and charge density functions of the electron may be directly physically interpreted. For example, spin angular momentum results from the motion of negatively charged mass moving systematically, and the equation for angular momentum, r×p, can be applied directly to the wave function (a current density function) that describes the electron. The magnetic moment of a Bohr magneton, Stem Gerlach experiment, g factor, Lamb shift, resonant line width and shape, selection rules, correspondence principle, wave particle duality, excited states, reduced mass, rotational energies, and momenta, orbital and spin splitting, spin-orbital coupling, Knight shift, and spin-nuclear coupling, and elastic electron scattering from helium atoms, are derived in closed form equations based on Maxwell's equations. The calculations agree with experimental observations. In contrast to the failure of the Bohr theory and the nonphysical, adjustable-parameter approach of quantum mechanics, the nature of the chemical bond is given in exact solutions of hydrogen molecular ions and molecules that match the data for 26 parameters [3]. In another published article, rather than invoking renormalization, untestable virtual particles, and polarization of the vacuum by the virtual particles, the results of QED such as the anomalous magnetic moment of the electron, the Lamb Shift, the fine structure and hyperfine structure of the hydrogen atom, and the hyperfine structure intervals of positronium and muonium (thought to be only solvable using QED) are solved exactly from Maxwell's equations to the limit possible based on experimental measurements [6].

In contrast to short comings of quantum mechanical equations, with CQM, multielectron atoms can be exactly solved in closed form. Using the nonradiative wave equation solutions that describe the bound electron having conserved momentum and energy, the radii are determined from the force balance of the electric, magnetic, and centrifugal forces that corresponds to the minimum of energy of the system. The ionization energies are then given by the electric and magnetic energies at these radii. One through twenty-electron atoms are solved exactly except for nuclear hyperfine structure effects of atoms other than hydrogen. (The spreadsheets to calculate the energies are available from the internet [17]). For 400 atoms and ions the agreement between the predicted and experimental results are remarkable.

Using the same unique physical model for the two-electron atom in all cases, it was confirmed that the CQM solutions give the accurate model of atoms and ions by solving conjugate parameters of the free electron, ionization energy of helium and all two electron atoms, electron scattering of helium for all angles, and all He I excited states as well as the ionization energies of multielectron atoms provided herein. Over five hundred conjugate parameters are calculated using a unique solution of the two-electron atom without any adjustable parameters to achieve overall agreement to the level obtainable considering the error in the measurements and the fundamental constants in the closed-form equations [5].

The background theory of classical quantum mechanics (CQM) for the physical solutions of atoms and atomic ions is disclosed in R. Mills, The Grand Unified Theory of Classical Quantum Mechanics, January 2000 Edition, BlackLight Power, Inc., Cranbury, N.J., (“'00 Mills GUT”), provided by BlackLight Power, Inc., 493 Old Trenton Road, Cranbury, N.J., 08512; R. Mills, The Grand Unified Theory of Classical Quantum Mechanics, September 2001 Edition, BlackLight Power, Inc., Cranbury, N.J., Distributed by Amazon.com (“'01 Mills GUT”), provided by BlackLight Power, Inc., 493 Old Trenton Road, Cranbury, N.J., 08512; R. Mills, The Grand Unified Theory of Classical Quantum Mechanics, July 2004 Edition, BlackLight Power, Inc., Cranbury, N.J., (“'04 Mills GUT”), provided by BlackLight Power, Inc., 493 Old Trenton Road, Cranbury, N.J., 08512; R. Mills, The Grand Unified Theory of Classical Quantum Mechanics, January 2005 Edition, BlackLight Power, Inc., Cranbury, N.J., (“'05 Mills GUT”), provided by BlackLight Power, Inc., 493 Old Trenton Road, Cranbury, N.J., 08512 (posted at www.blacklightpower.com and filed as a U.S. Provisional Application on Jan. 3, 2005, entitled “The Grand Unified Theory of Classical Quantum Mechanics,” attorney docket No. 62226-BOOK1); in prior PCT applications PCT/US02/35872; PCT/US02/06945; PCT/US02/06955; PCT/US01/09055; PCT/US01/25954; PCT/US00/20820; PCT/US00/20819; PCT/US00/09055; PCT/US99/17171; PCT/US99/17129; PCT/US 98/22822; PCT/US98/14029; PCT/US96/07949; PCT/US94/02219; PCT/US91/08496; PCT/US90/01998; and PCT/US89/05037 and U.S. Pat. No. 6,024,935; the entire disclosures of which are all incorporated herein by reference; (hereinafter “Mills Prior Publications”).

### SUMMARY OF THE INVENTION

An object of the present invention is to solve the charge (mass) and current-density functions of atoms and atomic ions from first principles. In an embodiment, the solution is derived from Maxwell's equations invoking the constraint that the bound electron does not radiate even though it undergoes acceleration.

Another objective of the present invention is to generate a readout, display, image, or other output of the solutions so that the nature of atoms and atomic ions can be better understood and applied to predict reactivity and physical properties of atoms, ions and compounds.

Another objective of the present invention is to apply the methods and systems of solving the nature of bound electrons and its rendering to numerical or graphical form to all atoms and atomic ions.

These objectives and other objectives are met by a system of computing and rendering the nature of bound atomic and atomic ionic electrons from physical solutions of the charge, mass, and current density functions of atoms and atomic ions, which solutions are derived from Maxwell's equations using a constraint that the bound electron(s) does not radiate under acceleration, comprising:

processing means for processing and solving the equations for charge, mass, and current density functions of electron(s) in a selected atom or ion, wherein the equations are derived from Maxwell's equations using a constraint that the bound electron(s) does not radiate under acceleration; and

a display in communication with the processing means for displaying the current and charge density representation of the electron(s) of the selected atom or ion.

These objectives and other objectives are also met by a system of computing the nature of bound atomic and atomic ionic electrons from physical solutions of the charge, mass, and current density functions of atoms and atomic ions, which solutions are derived from Maxwell's equations using a constraint that the bound electron(s) does not radiate under acceleration, comprising:

processing means for processing and solving the equations for charge, mass, and current density functions of electron(s) in selected atoms or ions, wherein the equations are derived from Maxwell's equations using a constraint that the bound electron(s) does not radiate under acceleration; and

output means for outputting the solutions of the charge, mass, and current density functions of the atoms and atomic ions.

These objectives and other objectives are further met by a method comprising the steps of;

a.) inputting electron functions that are derived from Maxwell's equations using a constraint that the bound electron(s) does not radiate under acceleration;

b.) inputting a trial electron configuration;

c.) inputting the corresponding centrifugal, Coulombic, diamagnetic and paramagnetic forces,

d.) forming the force balance equation comprising the centrifugal force equal to the sum of the Coulombic, diamagnetic and paramagnetic forces;

e.) solving the force balance equation for the electron radii;

f.) calculating the energy of the electrons using the radii and the corresponding electric and magnetic energies;

g.) repeating Steps a-f for all possible electron configurations, and

h.) outputting the lowest energy configuration and the corresponding electron radii for that configuration.

The invention will now be described with reference to classical quantum mechanics. A theory of classical quantum mechanics (CQM) was derived from first principles that successfully applies physical laws on all scales [2-6], and the mathematical connection with the Schrödinger equation to relate it to physical laws was discussed previously [27]. The physical approach based on Maxwell's equations was applied to multielectron atoms that were solved exactly. The classical predictions of the ionization energies were solved for the physical electrons comprising concentric orbitspheres (“bubble-like” charge-density functions) that are electrostatic and magnetostatic corresponding to a constant charge distribution and a constant current corresponding to spin angular momentum. Alternatively, the charge is a superposition of a constant and a dynamical component. In the latter case, charge density waves on the surface are time and spherically harmonic and correspond additionally to electron orbital angular momentum that superimposes the spin angular momentum. Thus, the electrons of multielectron atoms all exist as orbitspheres of discrete radii which are given by rₙ of the radial Dirac delta function, δ(r−rₙ). These electron orbitspheres may be spin paired or unpaired depending on the force balance which applies to each electron. Ultimately, the electron configuration must be a minimum of energy. Minimum energy configurations are given by solutions to Laplace's equation. As demonstrated previously, this general solution also gives the functions of the resonant photons of excited states [4]. It was found that electrons of an atom with the same principal and [symbol] quantum numbers align parallel until each of the [symbol] levels are occupied, and then pairing occurs until each of the [symbol] levels contain paired electrons. The electron configuration for one through twenty-electron atoms that achieves an energy minimum is: 1 s<2s<2p<3s<3p<4s. In each case, the corresponding force balance of the central Coulombic, paramagnetic, and diamagnetic forces was derived for each n-electron atom that was solved for the radius of each electron. The central Coulombic force was that of a point charge at the origin since the electron charge-density functions are spherically symmetrical with a time dependence that was nonradiative. This feature eliminated the electron-electron repulsion terms and the intractable infinities of quantum mechanics and permitted general solutions. The ionization energies were obtained using the calculated radii in the determination of the Coulombic and any magnetic energies. The radii and ionization energies for all cases were given by equations having fundamental constants and each nuclear charge, Z, only. The predicted ionization energies and electron configurations given in TABLES I-XXIII are in remarkable agreement with the experimental values known for 400 atoms and ions.

The presented exact physical solutions for the atom and all ions having a given number of electrons can be used to predict the properties of elements and engineer compositions of matter in a manner which is not possible using quantum mechanics.

In an embodiment, the physical, Maxwellian solutions for the dimensions and energies of atom and atomic ions are processed with a processing means to produce an output. Embodiments of the system for performing computing and rendering of the nature of the bound atomic and atomic-ionic electrons using the physical solutions may comprise a general purpose computer. Such a general purpose computer may have any number of basic configurations. For example, such a general purpose computer may comprise a central processing unit (CPU), one or more specialized processors, system memory, a mass storage device such as a magnetic disk, an optical disk, or other storage device, an input means such as a keyboard or mouse, a display device, and a printer or other output device. A system implementing the present invention can also comprise a special purpose computer or other hardware system and all should be included within its scope.

### BRIEF DESCRIPTION OF THE DRAWINGS

FIG. 1 shows the orbitsphere in accordance with the present invention that is a two dimensional spherical shell of zero thickness with the Bohr radius of the hydrogen atom, r=a_{H}.

FIG. 2 shows the current pattern of the orbitsphere in accordance with the present invention from the perspective of looking along the z-axis. The current and charge density are confined to two dimensions at rₙ=nr₁. The corresponding charge density function is uniform.

FIG. 3 shows that the orbital function modulates the constant (spin) function (shown for t=0; three-dimensional view).

FIG. 4 shows the normalized radius as a function of the velocity due to relativistic contraction, and

FIG. 5 shows the magnetic field of an electron orbitsphere (z-axis defined as the vertical axis).

### DETAILED DESCRIPTION OF THE INVENTION

The following preferred embodiments of the invention disclose numerous calculations which are merely intended as illustrative examples. Based on the detailed written description, one skilled in the art would easily be able to practice this invention within other like calculations to produce the desired result without undue effort.

### One-Electron Atoms

One-electron atoms include the hydrogen atom, He⁺, Li²⁺, Be³⁺, and so on. The mass-energy and angular momentum of the electron are constant; this requires that the equation of motion of the electron be temporally and spatially harmonic. Thus, the classical wave equation applies and

$$[ {∇}^{2} - \frac{1}{{v}^{2}} \frac{{\partial }^{2}}{\partial {t}^{2}} ] ρ ( r , θ , φ , t ) = 0 \qquad ( 1 )$$

where ρ(r,θ,φ,t) is the time dependent charge density function of the electron in time and space. In general, the wave equation has an infinite number of solutions. To arrive at the solution which represents the electron, a suitable boundary condition must be imposed. It is well known from experiments that each single atomic electron of a given isotope radiates to the same stable state. Thus, the physical boundary condition of nonradiation of the bound electron was imposed on the solution of the wave equation for the time dependent charge density function of the electron [2, 4]. The condition for radiation by a moving point charge given by Haus [16] is that its spacetime Fourier transform does possess components that are synchronous with waves traveling at the speed of light. Conversely, it is proposed that the condition for nonradiation by an ensemble of moving point charges that comprises a current density function is
For non-radiative states, the current-density function must NOT possess spacetime Fourier components that are synchronous with waves traveling at the speed of light.
   The time, radial, and angular solutions of the wave equation are separable. The motion is time harmonic with frequency ωₙ. A constant angular function is a solution to the wave equation. Solutions of the Schrödinger wave equation comprising a radial function radiate according to Maxwell's equation as shown previously by application of Haus' condition [4]. In fact, it was found that any function which permitted radial motion gave rise to radiation. A radial function which does satisfy the boundary condition is a radial delta function

$$f ( r ) = \frac{1}{{r}^{2}} δ ( r - {r}_{n} ) \qquad ( 2 )$$

This function defines a constant charge density on a spherical shell where rₙ=nr₁ wherein n is an integer in an excited state, and Eq. (1) becomes the two-dimensional wave equation plus time with separable time and angular functions. Given time harmonic motion and a radial delta function, the relationship between an allowed radius and the electron wavelength is given by

2πrₙ=λₙ (3)

where the integer subscript n here and in Eq. (2) is determined during photon absorption as given in the Excited States of the One-Electron Atom (Quantization) section of Ref. [4]. Using the observed de Broglie relationship for the electron mass where the coordinates are spherical,

$${λ}_{n} = \frac{h}{{p}_{n}} = \frac{h}{{m}_{e} {v}_{n}} \qquad ( 4 )$$

and the magnitude of the velocity for every point on the orbitsphere is

$${v}_{n} = \frac{ℏ}{{m}_{e} {r}_{n}} \qquad ( 5 )$$

The sum of the |Lᵢ|, the magnitude of the angular momentum of each infinitesimal point of the orbitsphere of mass mᵢ, must be constant. The constant is .

$$\sum \vert {L}_{i} \vert = \sum \vert r \times {m}_{i} v \vert = {m}_{e} {r}_{n} \frac{ℏ}{{m}_{e} {r}_{n}} = ℏ \qquad ( 6 )$$

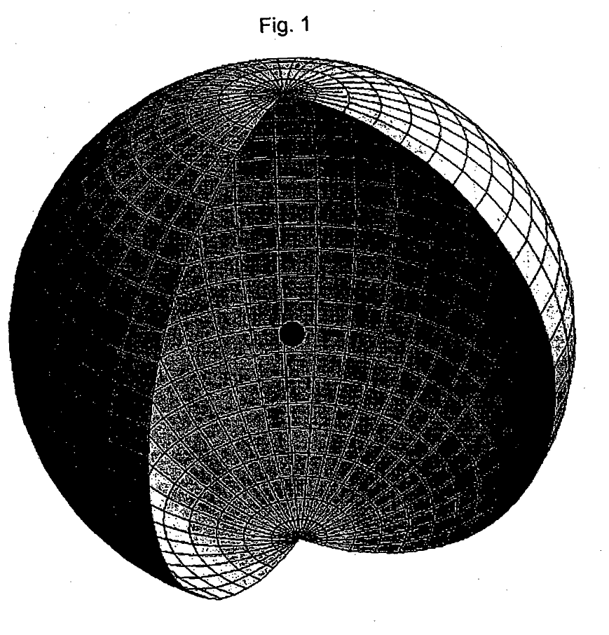

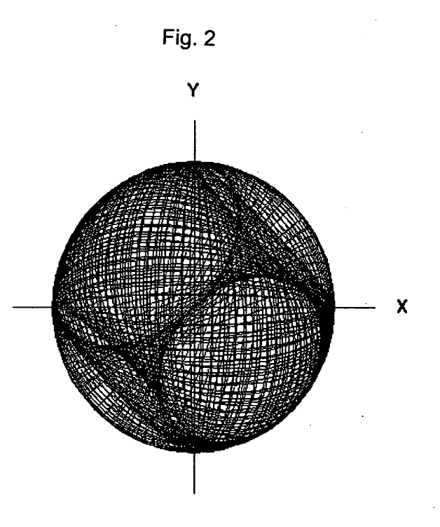

Thus, an electron is a spinning, two-dimensional spherical surface (zero thickness), called an electron orbitsphere shown in FIG. 1, that can exist in a bound state at only specified distances from the nucleus determined by an energy minimum. The corresponding current function shown in FIG. 2 which gives rise to the phenomenon of spin is derived in the Spin Function section. (See the Orbitsphere Equation of Motion for l=0 of Ref. [4] at Chp. 1.)

Nonconstant functions are also solutions for the angular functions. To be a harmonic solution of the wave equation in spherical coordinates, these angular functions must be spherical harmonic functions [18]. A zero of the spacetime Fourier transform of the product function of two spherical harmonic angular functions, a time harmonic function, and an unknown radial function is sought. The solution for the radial function which satisfies the boundary condition is also a delta function given by Eq. (2). Thus, bound electrons are described by a charge-density (mass-density) function which is the product of a radial delta function, two angular functions (spherical harmonic functions), and a time harmonic function.

$$\begin{matrix}ρ ( r , θ , φ , t ) = f ( r ) A ( θ , φ , t ) \\ = \frac{1}{{r}^{2}} δ ( r - {r}_{n} ) A ( θ , φ , t ) ; \\ A ( θ , φ , t ) = Y ( θ , φ ) k ( t )\end{matrix} \qquad ( 7 )$$

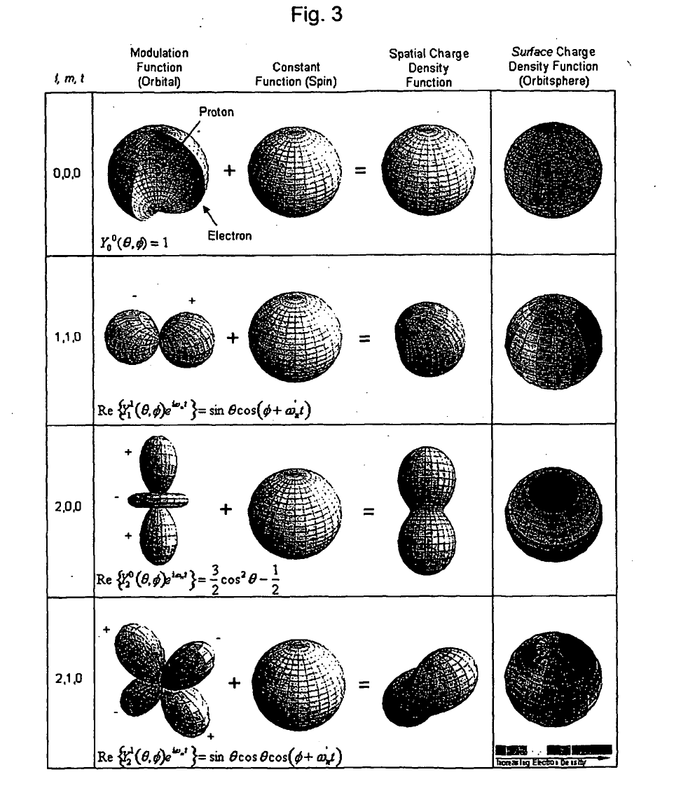

In these cases, the spherical harmonic functions correspond to a traveling charge density wave confined to the spherical shell which gives rise to the phenomenon of orbital angular momentum. The orbital functions which modulate the constant “spin” function shown graphically in FIG. 3 are given in the Angular Functions section.

### Spin Function

The orbitsphere spin function comprises a constant charge (current) density function with moving charge confined to a two-dimensional spherical shell. The magnetostatic current pattern of the orbitsphere spin function comprises an infinite series of correlated orthogonal great circle current loops wherein each point charge (current) density element moves time harmonically with constant angular velocity

$${ω}_{n} = \frac{ℏ}{{m}_{e} {r}_{n}^{2}} \qquad ( 8 )$$

The uniform current density function Y₀⁰(φ,θ), the orbitsphere equation of motion of the electron (Eqs. (13-14)), corresponding to the constant charge function of the orbitsphere that gives rise to the spin of the electron is generated from a basis set current-vector field defined as the orbitsphere current-vector field (“orbitsphere-cvf”). This in turn is generated over the surface by two complementary steps of an infinite series of nested rotations of two orthogonal great circle current loops where the coordinate axes rotate with the two orthogonal great circles that serve as a basis set. The algorithm to generate the current density function rotates the great circles and the corresponding x′y′z′coordinates relative to the xyz frame. Each infinitesimal rotation of the infinite series is about the new i′-axis and new j′-axis which results from the preceding such rotation. Each element of the current density function is obtained with each conjugate set of rotations. In Appendix III of Ref. [4], the continuous uniform electron current density function Y₀⁰(φ,θ) having the same angular momentum components as that of the orbitsphere-cvf is then exactly generated from this orbitsphere-cvf as a basis element by a convolution operator comprising an autocorrelation-type function.

For Step One, the current density elements move counter clockwise on the great circle in the y′z′-plane and move clockwise on the great circle in the x′z′-plane. The great circles are rotated by an infinitesimal angle ±Δα_{i′} (a positive rotation around the x′-axis or a negative rotation about the z′-axis for Steps One and Two, respectively) and then by ±Δα_{j′} (a positive rotation around the new y′-axis or a positive rotation about the new x′-axis for Steps One and Two, respectively). The coordinates of each point on each rotated great circle (x′,y′,z′) is expressed in terms of the first (x,y,z) coordinates by the following transforms where clockwise rotations and motions are defined as positive looking along the corresponding axis:

$$\begin{matrix}Step One & \\ [ \begin{matrix}x \\ y \\ z\end{matrix} ] = [ \begin{matrix}cos ( {Δα}_{y} ) & 0 & - sin ( {Δα}_{y} ) \\ 0 & 1 & 0 \\ sin ( {Δα}_{y} ) & 0 & cos ( {Δα}_{y} )\end{matrix} ] [ \begin{matrix}1 & 0 & 0 \\ 0 & cos ( {Δα}_{x} ) & sin ( {Δα}_{x} ) \\ 0 & - sin ( {Δα}_{x} ) & cos ( {Δα}_{x} )\end{matrix} ] [ \begin{matrix}{x}^{′} \\ {y}^{′} \\ {z}^{′}\end{matrix} ] \\ [ \begin{matrix}x \\ y \\ z\end{matrix} ] = [ \begin{matrix}cos ( {Δα}_{y} ) & sin ( {Δα}_{y} ) sin ( {Δα}_{x} ) & - sin ( {Δα}_{y} ) cos ( {Δα}_{x} ) \\ 0 & cos ( {Δα}_{x} ) & sin ( {Δα}_{x} ) \\ sin ( {Δα}_{y} ) & - cos ( {Δα}_{y} ) sin ( {Δα}_{x} ) & cos ( {Δα}_{y} ) cos ( {Δα}_{x} )\end{matrix} ] [ \begin{matrix}{x}^{′} \\ {y}^{′} \\ {z}^{′}\end{matrix} ] & ( 9 ) \\ Step Two & \\ [ \begin{matrix}x \\ y \\ z\end{matrix} ] = [ \begin{matrix}1 & 0 & 0 \\ 0 & cos ( {Δα}_{x} ) & sin ( {Δα}_{x} ) \\ 0 & - sin ( {Δα}_{x} ) & cos ( {Δα}_{x} )\end{matrix} ] [ \begin{matrix}cos ( {Δα}_{z} ) & sin ( {Δα}_{z} ) & 0 \\ - sin ( {Δα}_{z} ) & cos ( {Δα}_{z} ) & 0 \\ 0 & 0 & 1\end{matrix} ] [ \begin{matrix}{x}^{′} \\ {y}^{′} \\ {z}^{′}\end{matrix} ] \\ [ \begin{matrix}x \\ y \\ z\end{matrix} ] = [ \begin{matrix}cos ( {Δα}_{z} ) & sin ( {Δα}_{z} ) & 0 \\ - cos ( {Δα}_{x} ) sin ( {Δα}_{z} ) & cos ( {Δα}_{x} ) cos ( {Δα}_{z} ) & sin ( {Δα}_{x} ) \\ sin ( {Δα}_{x} ) sin ( {Δα}_{z} ) & - sin ( {Δα}_{x} ) cos ( {Δα}_{z} ) & cos ( {Δα}_{x} )\end{matrix} ] [ \begin{matrix}{x}^{′} \\ {y}^{′} \\ {z}^{′}\end{matrix} ] & ( 10 )\end{matrix}$$

where the angular sum is

$${lim}_{Δ α \to 0} {\sum }_{n = 1}^{\frac{\frac{\sqrt{2}}{2} π}{\vert Δ {α}_{{i}^{′} {j}^{′}} \vert}} \vert Δ {α}_{{i}^{′} , {j}^{′}} \vert = \frac{\sqrt{2}}{2} π .$$

The orbitsphere-cvf is given by n reiterations of Eqs. (9) and (10) for each point on each of the two orthogonal great circles during each of Steps One and Two. The output given by the non-primed coordinates is the input of the next iteration corresponding to each successive nested rotation by the infinitesimal angle ±Δα_{i′} or ±Δα_{j′} where the magnitude of the angular sum of the n rotations about each of the i′-axis and the j′-axis is

$$\frac{\sqrt{2}}{2} π .$$

Half of the orbitsphere-cvf is generated during each of Steps One and Two.

Following Step Two, in order to match the boundary condition that the magnitude of the velocity at any given point on the surface is given by Eq. (5), the output half of the orbitsphere-cvf is rotated clockwise by an angle of π/4 about the z-axis. Using Eq. (10) with

$$Δ {α}_{{z}^{′}} = \frac{π}{4}$$

and Δα_{x′}=0 gives the rotation. Then, the one half of the orbitsphere-cvf generated from Step One is superimposed with the complementary half obtained from Step Two following its rotation about the z-axis of π/4 to give the basis function to generate Y₀⁰(φ,θ), the orbitsphere equation of motion of the electron.

The current pattern of the orbitsphere-cvf generated by the nested rotations of the orthogonal great circle current loops is a continuous and total coverage of the spherical surface, but it is shown as a visual representation using 6 degree increments of the infinitesimal angular variable ±Δα_{i′} and ±Δα_{j′} of Eqs. (9) and (10) from the perspective of the z-axis in FIG. 2. In each case, the complete orbitsphere-cvf current pattern corresponds all the orthogonal-great-circle elements which are generated by the rotation of the basis-set according to Eqs. (9) and (10) where ±Δα_{i′} and ±Δα_{j′} approach zero and the summation of the infinitesimal angular rotations of ±Δα_{i′} and ±Δα_{j′} about the successive i′-axes and j′-axes is

$$\frac{\sqrt{2}}{2} π$$

for each Step. The current pattern gives rise to the phenomenon corresponding to the spin quantum number. The details of the derivation of the spin function are given in Ref. [2] and Chp. 1 of Ref. [4].

The resultant angular momentum projections of

$${L}_{xy} = \frac{ℏ}{4} and {L}_{z} = \frac{ℏ}{2}$$

meet the boundary condition for the unique current having an angular velocity magnitude at each point on the surface given by Eq. (5) and give rise to the Stern Gerlach experiment as shown in Ref. [4]. The further constraint that the current density is uniform such that the charge density is uniform, corresponding to an equipotential, minimum energy surface is satisfied by using the orbitsphere-cvf as a basis element to generate Y₀⁰ (φ,θ) using a convolution operator comprising an autocorrelation-type function as given in Appendix III of Ref. [4]. The operator comprises the convolution of each great circle current loop of the orbitsphere-cvf designated as the primary orbitsphere-cvf with a second orbitsphere-cvf designated as the secondary orbitsphere-cvf wherein the convolved secondary elements are matched for orientation, angular momentum, and phase to those of the primary. The resulting exact uniform current distribution obtained from the convolution has the same angular momentum distribution, resultant, L_{R}, and components of

$${L}_{xy} = \frac{ℏ}{4} and {L}_{z} = \frac{ℏ}{2}$$

as those of the orbitsphere-cvf used as a primary basis element.

### Angular Functions

The time, radial, and angular solutions of the wave equation are separable. Also based on the radial solution, the angular charge and current-density functions of the electron, A(θ,φ,t), must be a solution of the wave equation in two dimensions (plus time),

$$\begin{matrix} [ {∇}^{2} - \frac{1}{{v}^{2}} \frac{{\partial }^{2}}{\partial {t}^{2}} ] A ( θ , φ , t ) = 0 \\ where \\ ρ ( r , θ , φ , t ) = f ( r ) A ( θ , φ , t ) = \frac{1}{{r}^{2}} δ ( r - {r}_{n} ) A ( θ , φ , t ) \\ and A ( θ , φ , t ) = Y ( θ , φ ) k ( t ) & ( 11 ) \\ [ \frac{1}{{r}^{2} sin θ} \frac{\partial }{\partial θ} {( sin θ \frac{\partial }{\partial θ} )}_{r , φ} + \frac{1}{{r}^{2} {sin}^{2} θ} {( \frac{\partial }{\partial {φ}^{2}} )}_{r , θ} - \frac{1}{{v}^{2}} \frac{{\partial }^{2}}{\partial {t}^{2}} ] A ( θ , φ , t ) = 0 & ( 12 )\end{matrix}$$

where v is the linear velocity of the electron. The charge-density functions including the time-function factor are

$$\begin{matrix}l = 0 \\ ρ ( r , θ , φ , t ) = \frac{e}{8 π {r}^{2}} [ δ ( r - {r}_{n} ) [ {Y}_{0}^{0} ( θ , φ ) + {Y}_{l}^{m} ( θ , φ ) ] & ( 13 ) \\ l ? 0 \\ ρ ( r , θ , φ , t ) = \frac{e}{4 π {r}^{2}} [ δ ( r - {r}_{n} ) ] [ {Y}_{0}^{0} ( θ , φ ) + Re \{ {Y}_{l}^{m} ( θ , φ ) {e}^{i {ω}_{n} t} \} ] & ( 14 )\end{matrix}$$

where Yₗ^{m}(θ,φ) are the spherical harmonic functions that spin about the z-axis with angular frequency ωₙ with Y₀⁰(θ,φ) the constant function.
Re{Yₗ^{m}(θ,φ)e^{iω}^{ₙ}^{t}}=Pₗ^{m}(cos θ)cos(mφ+ω′ₙt) where to keep the form of the spherical harmonic as a traveling wave about the z-axis, ω′ₙ=mωₙ.
Acceleration without Radiation

### Special Relativistic Correction to the Electron Radius

The relationship between the electron wavelength and its radius is given by Eq. (3) where λ is the de Broglie wavelength. For each current density element of the spin function, the distance along each great circle in the direction of instantaneous motion undergoes length contraction and time dilation. Using a phase matching condition, the wavelengths of the electron and laboratory inertial frames are equated, and the corrected radius is given by

$${r}_{n} = {r}_{n}^{′} [ \begin{matrix}\sqrt{1 - {( \frac{v}{c} )}^{2}} sin [ \frac{π}{2} {( 1 - {( \frac{v}{c} )}^{2} )}^{3 / 2} ] + \\ \frac{1}{2 π} cos [ \frac{π}{2} {( 1 - {( \frac{v}{c} )}^{2} )}^{3 / 2} ]\end{matrix} ] \qquad ( 15 )$$

where the electron velocity is given by Eq. (5). (See Ref. [4] Chp. 1, Special Relativistic Correction to the Ionization Energies section).

$$\frac{e}{{m}_{e}}$$

of the electron, the electron angular momentum of , and μ_{B} are invariant, but the mass and charge densities increase in the laboratory frame due to the relativistically contracted electron radius. As

$$v \to c , r / {r}^{′} \to \frac{1}{2 π}$$

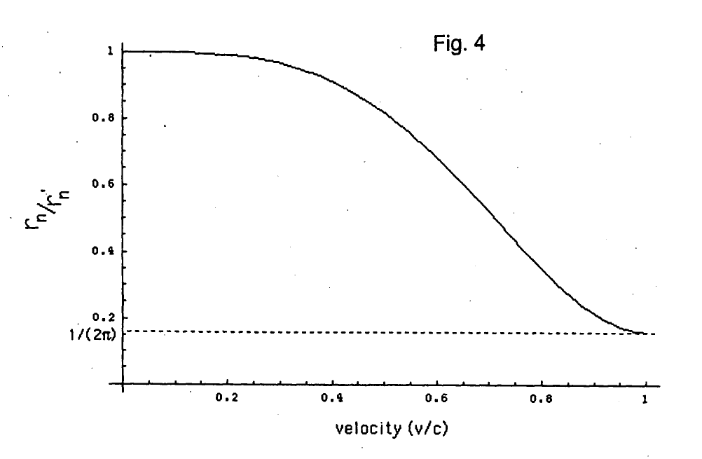

and r=λ as shown in FIG. 4.

### Nonradiation Based on the Spacetime Fourier Transform of the Electron Current

Although an accelerated point particle radiates, an extended distribution modeled as a superposition of accelerating charges does not have to radiate [14, 16, 19-21]. The Fourier transform of the electron charge density function given by Eq. (7) is a solution of the three-dimensional wave equation in frequency space (k,ω space) as given in Chp 1, Spacetime Fourier Transform of the Electron Function section, of Ref. [4]. Then the corresponding Fourier transform of the current density function K(s,Θ,Φ,ω) is given by multiplying by the constant angular frequency.

$$K ( s , Θ , Φ , ω ) = 4 π {ω}_{n} \frac{sin ( 2 {s}_{n} {r}_{n} )}{2 {s}_{n} {r}_{n}} ⊗ 2 π {\sum }_{υ = 1}^{∞} \frac{{( - 1 )}^{υ - 1} {( π sin Θ )}^{2 ( υ - 1 )}}{( υ - 1 ) ! ( υ - 1 ) !} \frac{Γ ( \frac{1}{2} ) Γ ( υ + \frac{1}{2} )}{{( π cos Θ )}^{2 υ + 1} {2}^{υ + 1} ( υ - 1 ) !} {s}^{- 2 υ} ⊗ 2 π {\sum }_{υ = 1}^{∞} \frac{{( - 1 )}^{υ - 1} {( π sin Φ )}^{2 ( υ - 1 )}}{( υ - 1 ) ! ( υ - 1 ) !} \frac{Γ ( \frac{1}{2} ) Γ ( υ + \frac{1}{2} )}{{( π cos Φ )}^{2 υ + 1} {2}^{υ + 1}} \frac{2 υ !}{( υ - 1 ) !} {s}^{- 2 υ} \frac{1}{4 π} [ δ ( ω - {ω}_{n} ) + δ ( ω + {ω}_{n} ) ] \qquad ( 16 )$$

sₙ·vₙ=sₙ·c=ωₙ implies rₙ=λₙ which is given by Eq. (15) in the case that k is the lightlike k⁰. In this case, Eq. (16) vanishes. Consequently, spacetime harmonics of

$$\frac{{ω}_{n}}{c} = k or \frac{{ω}_{n}}{c} \sqrt{\frac{ɛ}{{ɛ}_{o}}} = k$$

for transform of the current-density function is nonzero do not exist. Radiation due to charge motion does not occur in any medium when this boundary condition is met. Nonradiation is also determined from the fields based on Maxwell's equations as given in the Nonradiation Based on the Electromagnetic Fields and the Poynting Power Vector section infra.

### Nonradiation Based on the Electron Electromagnetic Fields and the Poynting Power Vector

A point charge undergoing periodic motion accelerates and as a consequence radiates according to the Larmor formula:

$$P = \frac{1}{4 π {ɛ}_{0}} \frac{2 {e}^{2}}{3 {c}^{3}} {a}^{2} \qquad ( 17 )$$

where e is the charge, a is its acceleration, ε₀ is the permittivity of free space, and c is the speed of light. Although an accelerated point particle radiates, an extended distribution modeled as a superposition of accelerating charges does not have to radiate [14, 16, 19-21]. In Ref. [2] and Appendix I, Chp. 1 of Ref. [4], the electromagnetic far field is determined from the current distribution in order to obtain the condition, if it exists, that the electron current distribution must satisfy such that the electron does not radiate. The current follows from Eqs. (13-14). The currents corresponding to Eq. (13) and first term of Eq. (14) are static. Thus, they are trivially nonradiative. The current due to the time dependent term of Eq. (14) corresponding to p, d, f, etc. orbitals is

$$\begin{matrix}J = \frac{{ω}_{n}}{2 π} \frac{e}{4 π {r}_{n}^{2}} N [ δ ( r - {r}_{n} ) ] Re \{ {Y}_{l}^{m} ( θ , φ ) \} [ u ( t ) \times r ] \\ = \frac{{ω}_{n}}{2 π} \frac{e}{4 π {r}_{n}^{2}} {N}^{′} [ δ ( r - {r}_{n} ) ] ( {P}_{l}^{m} ( cos θ ) cos ( m φ + {ω}_{n}^{′} t ) ) [ u \times r ] \\ = \frac{{ω}_{n}}{2 π} \frac{e}{4 π {r}_{n}^{2}} {N}^{′} [ δ ( r - {r}_{n} ) ] ( {P}_{l}^{m} ( cos θ ) cos ( m φ + {ω}_{n}^{′} t ) ) sin θ \hat{φ}\end{matrix} \qquad ( 18 )$$

where to keep the form of the spherical harmonic as a traveling wave about the z-axis, ω′ₙ=mωₙ and N and N′ are normalization constants. The vectors are defined as

$$\begin{matrix}\hat{φ} = \frac{\hat{u} \times \hat{r}}{\vert \hat{u} \times \hat{r} \vert} = \frac{\hat{u} \times \hat{r}}{sin θ} ; \hat{u} = \hat{z} = orbital axis & ( 19 ) \\ \hat{θ} = \hat{φ} \times \hat{r} & ( 20 )\end{matrix}$$

“̂” denotes the unit vectors

$$\hat{u} ≡ \frac{u}{\vert u \vert} ,$$

non-unit vectors are designed in bold, and the current function is normalized. For the electron source current given by Eq. (18), each comprising a multipole of order (l,m) with a time dependence e^{iω}^{ₙ}^{t}, the far-field solutions to Maxwell's equations are given by

$$B = - \frac{i}{k} {a}_{M} ( l , m ) ∇ \times {g}_{l} ( kr ) {X}_{l , m} \\ E = {a}_{M} ( l , m ) {g}_{l} ( kr ) {X}_{l , m} \qquad ( 21 )$$

and the time-averaged power radiated per solid angle

$$\frac{d P ( l , m )}{d Ω}$$

is

$$\frac{d P ( l , m )}{d Ω} = \frac{c}{8 π {k}^{2}} {\vert {a}_{M} ( l , m ) \vert}^{2} {\vert {X}_{l , m} \vert}^{2} \qquad ( 22 )$$

where α_{M}(l,m) is

$${a}_{M} ( l , m ) = \frac{- e {k}^{2}}{c \sqrt{l ( l + 1 )}} \frac{{ω}_{n}}{2 π} N {j}_{l} ( {kr}_{n} ) Θsin ( mks ) \qquad ( 23 )$$

In the case that k is the lightlike k⁰, then k=ωₙ/c, in Eq. (23), and Eqs. (21-22) vanishes for

s=vTₙ=R=rₙ=λₙ (24)

There is no radiation.

### Magnetic Field Equations of the Electron

The orbitsphere is a shell of negative charge current comprising correlated charge motion along great circles. For [symbol] =0, the orbitsphere gives rise to a magnetic moment of 1 Bohr magneton [22]. (The details of the derivation of the magnetic parameters including the electron g factor are given in Ref. [2] and Chp. 1 of Ref. [4].)

$${μ}_{B} = \frac{e ℏ}{2 {m}_{e}} = 9.274 \times {10}^{- 24} {JT}^{- 1} \qquad ( 25 )$$

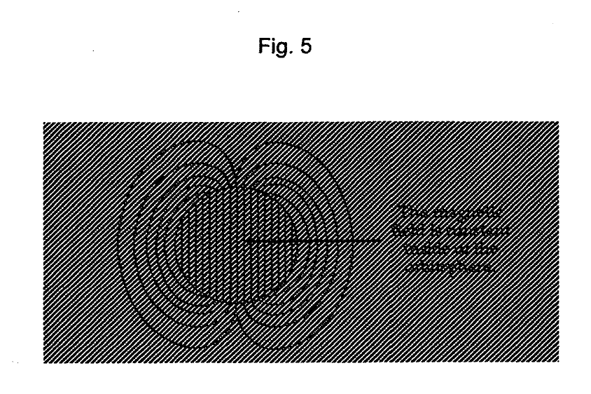

The magnetic field of the electron shown in FIG. 5 is given by

$$\begin{matrix}H = \frac{e ℏ}{{m}_{e} {r}_{n}^{3}} ( {i}_{r} cos θ - {i}_{θ} sin θ ) for r < {r}_{n} & ( 26 ) \\ H = \frac{e ℏ}{2 {m}_{e} {r}^{3}} ( {i}_{r} 2 cos θ + {i}_{θ} sin θ ) for r > {r}_{n} & ( 27 )\end{matrix}$$

The energy stored in the magnetic field of the electron is

$$\begin{matrix}{E}_{mag} = \frac{1}{2} {μ}_{0} {\int }_{0}^{2 π} {\int }_{0}^{π} {\int }_{0}^{∞} {H}^{2} {r}^{2} sin θ d r d θ d Φ & ( 28 ) \\ {E}_{mag total} = \frac{{πμ}_{o} {e}^{2} {ℏ}^{2}}{{m}_{e}^{2} {r}_{1}^{3}} & ( 29 )\end{matrix}$$

### Stern-Gerlach Experiment

The Stem-Gerlach experiment implies a magnetic moment of one Bohr magneton and an associated angular momentum quantum number of ½. Historically, this quantum number is called the spin quantum number, s

$$( s = \frac{1}{2} ; {m}_{s} = \pm \frac{1}{2} ) .$$

The superposition of the vector projection of the orbitsphere angular momentum on the z-axis is /2 with an orthogonal component of /4. Excitation of a resonant Larmor precession gives rise to on an axis S that precesses about the z-axis called the spin axis at the Larmor frequency at an angle of

$$θ = \frac{π}{3}$$

to give a perpendicular projection of

$${S}_{⊥} = \pm \sqrt{\frac{3}{4}} ℏ \qquad ( 30 )$$

and a projection onto the axis of the applied magnetic field of

$${S}_{∥} = \pm \frac{ℏ}{2} \qquad ( 31 )$$

The superposition of the /2, z-axis component of the orbitsphere angular momentum and the /2, z-axis component of S gives corresponding to the observed electron magnetic moment of a Bohr magneton, μ_{B}.

### Electron g Factor

Conservation of angular momentum of the orbitsphere permits a discrete change of its “kinetic angular momentum” (r×mv) by the applied magnetic field of /2, and concomitantly the “potential angular momentum” (r×eA) must change by −/2.

$$\begin{matrix}Δ L = \frac{ℏ}{2} - r \times e A & ( 32 ) \\ = [ \frac{ℏ}{2} - \frac{e φ}{2 π} ] \hat{z} & ( 33 )\end{matrix}$$

In order that the change of angular momentum, ΔL, equals zero, φ must be

$${Φ}_{0} = \frac{h}{2 e} ,$$

the magnetic flux quantum. The magnetic moment of the electron is parallel or antiparallel to the applied field only. During the spin-flip transition, power must be conserved. Power flow is governed by the Poynting power theorem,

$$∇ \cdot ( E \times H ) = - \frac{\partial }{\partial t} [ \frac{1}{2} {μ}_{o} H \cdot H ] - \frac{\partial }{{\partial }_{t}} [ \frac{1}{2} {ɛ}_{o} E \cdot E ] - J \cdot E \qquad ( 34 )$$

Eq. (35) gives the total energy of the flip transition which is the sum of the energy of reorientation of the magnetic moment (1st term), the magnetic energy (2nd term), the electric energy (3rd term), and the dissipated energy of a fluxon treading the orbitsphere (4th term), respectively,

$$\begin{matrix}Δ {E}_{mag}^{spin} = 2 ( 1 + \frac{α}{2 π} + \frac{2}{3} {α}^{2} ( \frac{α}{2 π} ) - \frac{4}{3} {( \frac{α}{2 π} )}^{2} ) {μ}_{B} B & ( 35 ) \\ Δ {E}_{mag}^{spin} = g {μ}_{B} B & ( 36 )\end{matrix}$$

where the stored magnetic energy corresponding to the

$$\frac{\partial }{{\partial }_{t}} [ \frac{1}{2} {μ}_{o} H \cdot H ]$$

term increases, the stored electric energy corresponding to the

$$\frac{\partial }{{\partial }_{t}} [ \frac{1}{2} {ɛ}_{o} E \cdot E ]$$

term increases, and the J·E term is dissipative. The spin-flip transition can be considered as involving a magnetic moment of g times that of a Bohr magneton. The g factor is redesignated the fluxon g factor as opposed to the anomalous g factor. Using α⁻¹=137.03603(82), the calculated value of g/2 is 1.001 159 652 137. The experimental value [23] of g/2 is 1.001 159 652 188(4).

### Spin and Orbital Parameters

The total function that describes the spinning motion of each electron orbitsphere is composed of two functions. One function, the spin function, is spatially uniform over the orbitsphere, spins with a quantized angular velocity, and gives rise to spin angular momentum. The other function, the modulation function, can be spatially uniform—in which case there is no orbital angular momentum and the magnetic moment of the electron orbitsphere is one Bohr magneton—or not spatially uniform—in which case there is orbital angular momentum. The modulation function also rotates with a quantized angular velocity.

The spin function of the electron corresponds to the nonradiative n=1, l=0 state of atomic hydrogen which is well known as an s state or orbital. (See FIG. 1 for the charge function and FIG. 2 for the current function.) In cases of orbitals of heavier elements and excited states of one electron atoms and atoms or ions of heavier elements with the l quantum number not equal to zero and which are not constant as given by Eq. (13), the constant spin function is modulated by a time and spherical harmonic function as given by Eq. (14) and shown in FIG. 3. The modulation or traveling charge density wave corresponds to an orbital angular momentum in addition to a spin angular momentum. These states are typically referred to as p, d, f, etc. orbitals. Application of Haus's [16] condition also predicts nonradiation for a constant spin function modulated by a time and spherically harmonic orbital function. There is acceleration without radiation as also shown in the Nonradiation Based on the Electron Electromagnetic Fields and the Poynting Power Vector section. (Also see Pearle, Abbott and Griffiths, Goedecke, and Daboul and Jensen [14, 19-21]). However, in the case that such a state arises as an excited state by photon absorption, it is radiative due to a radial dipole term in its current density function since it possesses spacetime Fourier Transform components synchronous with waves traveling at the speed of light [16]. (See Instability of Excited States section of Ref. [4].)

### Moment of Inertia and Spin and Rotational Enemies

The moments of inertia and the rotational energies as a function of the l quantum number for the solutions of the time-dependent electron charge density functions (Eqs. (13-14)) given in the Angular Functions section are solved using the rigid rotor equation [24]. The details of the derivations of the results as well as the demonstration that Eqs. (13-14) with the results given infra. are solutions of the wave equation are given in Chp 1, Rotational Parameters of the Electron (Angular Momentum, Rotational Energy, Moment of Inertia) section, of Ref. [4].

$$\begin{matrix}l = 0 & \\ {I}_{z} = {I}_{spin} = \frac{{m}_{e} {r}_{n}^{2}}{2} & ( 37 ) \\ {L}_{z} = I ω {i}_{z} = \pm \frac{ℏ}{2} & ( 38 ) \\ \begin{matrix}{E}_{rotational} = {E}_{rotational , spin} \\ = \frac{1}{2} [ {{I}_{spin} ( \frac{ℏ}{{m}_{e} {r}_{n}^{2}} )}^{2} ] \\ = \frac{1}{2} [ \frac{{m}_{e} {r}_{n}^{2}}{2} {( \frac{ℏ}{{m}_{e} {r}_{n}^{2}} )}^{2} ] \\ = \frac{1}{4} [ \frac{{ℏ}^{2}}{2 {I}_{spin}} ]\end{matrix} & ( 39 ) \\ l ? 0 & \\ {I}_{orbital} = {m}_{e} {{r}_{n}^{2} [ \frac{l ( l + 1 )}{{l}^{2} + l + 1} ]}^{\frac{1}{2}} & ( 40 ) \\ {L}_{z} = m ℏ & ( 41 ) \\ {L}_{z total} = {L}_{z spin} + {L}_{z orbital} & ( 42 ) \\ {E}_{rotational , orbital} = \frac{{ℏ}^{2}}{2 I} [ \frac{l ( l + 1 )}{{l}^{2} + 2 l + 1} ] & ( 43 ) \\ T = \frac{{ℏ}^{2}}{2 {m}_{e} {r}_{n}^{2}} & ( 44 ) \\ 〈 {E}_{rotational , orbital} 〉 = 0 & ( 45 )\end{matrix}$$

From Eq. (45), the time average rotational energy is zero; thus, the principal levels are degenerate except when a magnetic field is applied.

### Force Balance Equation

The radius of the nonradiative (n=1) state is solved using the electromagnetic force equations of Maxwell relating the charge and mass density functions wherein the angular momentum of the electron is given by Planck's constant bar [4]. The reduced mass arises naturally from an electrodynamic interaction between the electron and the proton of mass mₚ.

$$\begin{matrix}\frac{{m}_{e}}{4 π {r}_{1}^{2}} \frac{{v}_{1}^{2}}{{r}_{1}} = \frac{e}{4 π {r}_{1}^{2}} \frac{Z e}{4 {πɛ}_{o} {r}_{1}^{2}} - \frac{1}{4 π {r}_{1}^{2}} \frac{{ℏ}^{2}}{{m}_{p} {r}_{n}^{3}} & ( 46 ) \\ {r}_{1} = \frac{{a}_{H}}{Z} & ( 47 )\end{matrix}$$

where a_{H} is the radius of the hydrogen atom.

### Energy Calculations

From Maxwell's equations, the potential energy V, kinetic energy T, electric energy or binding energy Eₑₗₑ are

$$\begin{matrix}\begin{matrix}V = \frac{- Z {e}^{2}}{4 {πɛ}_{o} {r}_{1}} \\ = \frac{- {Z}^{2} {e}^{2}}{4 {πɛ}_{o} {a}_{H}} \\ = - {Z}^{2} \times 4.3675 \times {10}^{- 18} J \\ = - {Z}^{2} \times 27.2 eV\end{matrix} & ( 48 ) \\ T = \frac{{Z}^{2} {e}^{2}}{8 {πɛ}_{o} {a}_{H}} = {Z}^{2} \times 13.59 eV & ( 49 ) \\ T = {E}_{ele} = - \frac{1}{2} {ɛ}_{o} {\int }_{∞}^{{r}_{1}} {E}^{2} d v where E = - \frac{Z e}{4 {πɛ}_{o} {r}_{1}} & ( 50 ) \\ \begin{matrix}{E}_{ele} = - \frac{{Z}^{2} {e}^{2}}{8 {πɛ}_{o} {a}_{H}} \\ = - {Z}^{2} \times 2.1786 \times {10}^{- 18} J \\ = - {Z}^{2} \times 13.598 eV\end{matrix} & ( 51 )\end{matrix}$$

The calculated Rydberg constant is 10,967,758 m⁻¹; the experimental Rydberg constant is 10,967,758 m⁻¹. For increasing Z, the velocity becomes a significant fraction of the speed of light; thus, special relativistic corrections were included in the calculation of the ionization energies of one-electron atoms that are given in TABLE I.

TABLE I
Relativistically corrected ionization energies for
some one-electron atoms.

| | | | | | Relative |
|---|---|---|---|---|---|
| | | | Theoretical | Experimental | Difference |
| | | | Ionization | Ionization | between |
| One e | | | Energies | Energies | Experimental and |
| Atom | Z | γ*^{a} | (eV)^{b} | (eV)^{c} | Calculated^{d} |
| H | 1 | 1.000007 | 13.59838 | 13.59844 | 0.00000 |
| He⁺ | 2 | 1.000027 | 54.40941 | 54.41778 | 0.00015 |
| Li²⁺ | 3 | 1.000061 | 122.43642 | 122.45429 | 0.00015 |
| Be³⁺ | 4 | 1.000109 | 217.68510 | 217.71865 | 0.00015 |
| B⁴⁺ | 5 | 1.000172 | 340.16367 | 340.2258 | 0.00018 |
| C⁵⁺ | 6 | 1.000251 | 489.88324 | 489.99334 | 0.00022 |
| N⁶⁺ | 7 | 1.000347 | 666.85813 | 667.046 | 0.00028 |
| O⁷⁺ | 8 | 1.000461 | 871.10635 | 871.4101 | 0.00035 |
| F⁸⁺ | 9 | 1.000595 | 1102.65013 | 1103.1176 | 0.00042 |
| Ne⁹⁺ | 10 | 1.000751 | 1361.51654 | 1362.1995 | 0.00050 |
| Na¹⁰⁺ | 11 | 1.000930 | 1647.73821 | 1648.702 | 0.00058 |
| Mg¹¹⁺ | 12 | 1.001135 | 1961.35405 | 1962.665 | 0.00067 |
| Al¹²⁺ | 13 | 1.001368 | 2302.41017 | 2304.141 | 0.00075 |
| Si¹³⁺ | 14 | 1.001631 | 2670.96078 | 2673.182 | 0.00083 |
| P¹⁴⁺ | 15 | 1.001927 | 3067.06918 | 3069.842 | 0.00090 |
| S¹⁵⁺ | 16 | 1.002260 | 3490.80890 | 3494.1892 | 0.00097 |
| Cl¹⁶⁺ | 17 | 1.002631 | 3942.26481 | 3946.296 | 0.00102 |
| Ar¹⁷⁺ | 18 | 1.003045 | 4421.53438 | 4426.2296 | 0.00106 |
| K¹⁸⁺ | 19 | 1.003505 | 4928.72898 | 4934.046 | 0.00108 |
| Ca¹⁹⁺ | 20 | 1.004014 | 5463.97524 | 5469.864 | 0.00108 |
| Sc²⁰⁺ | 21 | 1.004577 | 6027.41657 | 6033.712 | 0.00104 |
| Ti²¹⁺ | 22 | 1.005197 | 6619.21462 | 6625.82 | 0.00100 |
| V²²⁺ | 23 | 1.005879 | 7239.55091 | 7246.12 | 0.00091 |
| Cr²³⁺ | 24 | 1.006626 | 7888.62855 | 7894.81 | 0.00078 |
| Mn²⁴⁺ | 25 | 1.007444 | 8566.67392 | 8571.94 | 0.00061 |
| Fe²⁵⁺ | 26 | 1.008338 | 9273.93857 | 9277.69 | 0.00040 |
| Co²⁶⁺ | 27 | 1.009311 | 10010.70111 | 10012.12 | 0.00014 |
| Ni²⁷⁺ | 28 | 1.010370 | 10777.26918 | 10775.4 | −0.00017 |
| Cu²⁸⁺ | 29 | 1.011520 | 11573.98161 | 11567.617 | −0.00055 |

^{a}Eq. (1.250) (follows Eqs. (5), (15), and (47)).
^{b}Eq. (1.251) (Eq. (51) times γ*).
^{c}From theoretical calculations, interpolation of H isoelectronic and Rydberg series, and experimental data [24-25].
^{d}(Experimental − theoretical)/experimental.

### Two Electron Atoms

Two electron atoms may be solved from a central force balance equation with the nonradiation condition [4]. The force balance equation is

$$\frac{{m}_{e}}{4 π {r}_{2}^{2}} \frac{{v}_{2}^{2}}{{r}_{2}} = \frac{e}{4 π {r}_{2}^{2}} \frac{( Z - 1 ) e}{4 {πɛ}_{0} {r}_{2}^{2}} + \frac{1}{4 π {r}_{2}^{2}} \frac{{ℏ}^{2}}{{Zm}_{e} {r}_{2}^{3}} \sqrt{s ( s + 1 )} \qquad ( 52 )$$

which gives the radius of both electrons as

$${r}_{2} = {r}_{1} = {a}_{0} ( \frac{1}{Z - 1} - \frac{\sqrt{s ( s + 1 )}}{Z ( Z - 1 )} ) ; s = \frac{1}{2} \qquad ( 53 )$$

### Ionization Energies Calculated Using the Poynting Power Theorem

For helium, which has no electric field beyond r₁

$$\begin{matrix}Ionization Energy ( He ) = - E ( electric ) + E ( magnetic ) \\ where , & ( 54 ) \\ E ( electric ) = - \frac{( Z - 1 ) {e}^{2}}{8 {πɛ}_{o} {r}_{1}} & ( 55 ) \\ E ( magnetic ) = \frac{2 {πμ}_{0} {e}^{2} {ℏ}^{2}}{{m}_{e}^{2} {r}_{1}^{3}} \\ For 3 \leq Z & ( 56 ) \\ Ionization Energy = - Electric Energy - \frac{1}{Z} Magnetic Energy & ( 57 )\end{matrix}$$

For increasing Z, the velocity becomes a significant fraction of the speed of light; thus, special relativistic corrections were included in the calculation of the ionization energies of two-electron atoms that are given in TABLE II.

TABLE II
Relativistically corrected ionization energies for some two-electron atoms.

| | | | Electric | Magnetic |
|---|---|---|---|---|
| | | r₁ | Energy^{b} | Energy^{c} |
| 2 e Atom | Z | (a₀)^{a} | (eV) | (eV) |
| He | 2 | 0.566987 | 23.996467 | 0.590536 |
| Li⁺ | 3 | 0.35566 | 76.509 | 2.543 |
| Be²⁺ | 4 | 0.26116 | 156.289 | 6.423 |
| B³⁺ | 5 | 0.20670 | 263.295 | 12.956 |
| C⁴⁺ | 6 | 0.17113 | 397.519 | 22.828 |
| N⁵⁺ | 7 | 0.14605 | 558.958 | 36.728 |
| O⁶⁺ | 8 | 0.12739 | 747.610 | 55.340 |
| F⁷⁺ | 9 | 0.11297 | 963.475 | 79.352 |
| Ne⁸⁺ | 10 | 0.10149 | 1206.551 | 109.451 |
| Na⁹⁺ | 11 | 0.09213 | 1476.840 | 146.322 |
| Mg¹⁰⁺ | 12 | 0.08435 | 1774.341 | 190.652 |
| Al¹¹⁺ | 13 | 0.07778 | 2099.05 | 243.13 |
| Si¹²⁺ | 14 | 0.07216 | 2450.98 | 304.44 |
| P¹³⁺ | 15 | 0.06730 | 2830.11 | 375.26 |
| S¹⁴⁺ | 16 | 0.06306 | 3236.46 | 456.30 |
| Cl¹⁵⁺ | 17 | 0.05932 | 3670.02 | 548.22 |
| Ar¹⁶⁺ | 18 | 0.05599 | 4130.79 | 651.72 |
| K¹⁷⁺ | 19 | 0.05302 | 4618.77 | 767.49 |
| Ca¹⁸⁺ | 20 | 0.05035 | 5133.96 | 896.20 |
| Sc¹⁹⁺ | 21 | 0.04794 | 5676.37 | 1038.56 |
| Ti²⁰⁺ | 22 | 0.04574 | 6245.98 | 1195.24 |
| V²¹⁺ | 23 | 0.04374 | 6842.81 | 1366.92 |
| Cr²²⁺ | 24 | 0.04191 | 7466.85 | 1554.31 |
| Mn²³⁺ | 25 | 0.04022 | 8118.10 | 1758.08 |
| Fe²⁴⁺ | 26 | 0.03867 | 8796.56 | 1978.92 |
| Co²⁵⁺ | 27 | 0.03723 | 9502.23 | 2217.51 |
| Ni²⁶⁺ | 28 | 0.03589 | 10235.12 | 2474.55 |
| Cu²⁷⁺ | 29 | 0.03465 | 10995.21 | 2750.72 |

| | | | | Theoretical | Experimental | |
|---|---|---|---|---|---|---|
| | | | | Ionization | Ionization | |
| | | Velocity | | Energies^{f} | Energies^{g} | Relative |
| 2 e Atom | Z | (m/s)^{d} | γ*^{e} | (eV) | (eV) | Error^{h} |
| He | 2 | 3.85845E+06 | 1.000021 | 24.58750 | 24.58741 | −0.000004 |
| Li⁺ | 3 | 6.15103E+06 | 1.00005 | 75.665 | 75.64018 | −0.0003 |
| Be²⁺ | 4 | 8.37668E+06 | 1.00010 | 154.699 | 153.89661 | −0.0052 |
| B³⁺ | 5 | 1.05840E+07 | 1.00016 | 260.746 | 259.37521 | −0.0053 |
| C⁴⁺ | 6 | 1.27836E+07 | 1.00024 | 393.809 | 392.087 | −0.0044 |
| N⁵⁺ | 7 | 1.49794E+07 | 1.00033 | 553.896 | 552.0718 | −0.0033 |
| O⁶⁺ | 8 | 1.71729E+07 | 1.00044 | 741.023 | 739.29 | −0.0023 |
| F⁷⁺ | 9 | 1.93649E+07 | 1.00057 | 955.211 | 953.9112 | −0.0014 |
| Ne⁸⁺ | 10 | 2.15560E+07 | 1.00073 | 1196.483 | 1195.8286 | −0.0005 |
| Na⁹⁺ | 11 | 2.37465E+07 | 1.00090 | 1464.871 | 1465.121 | 0.0002 |
| Mg¹⁰⁺ | 12 | 2.59364E+07 | 1.00110 | 1760.411 | 1761.805 | 0.0008 |
| Al¹¹⁺ | 13 | 2.81260E+07 | 1.00133 | 2083.15 | 2085.98 | 0.0014 |
| Si¹²⁺ | 14 | 3.03153E+07 | 1.00159 | 2433.13 | 2437.63 | 0.0018 |
| P¹³⁺ | 15 | 3.25043E+07 | 1.00188 | 2810.42 | 2816.91 | 0.0023 |
| S¹⁴⁺ | 16 | 3.46932E+07 | 1.00221 | 3215.09 | 3223.78 | 0.0027 |
| Cl¹⁵⁺ | 17 | 3.68819E+07 | 1.00258 | 3647.22 | 3658.521 | 0.0031 |
| Ar¹⁶⁺ | 18 | 3.90705E+07 | 1.00298 | 4106.91 | 4120.8857 | 0.0034 |
| K¹⁷⁺ | 19 | 4.12590E+07 | 1.00344 | 4594.25 | 4610.8 | 0.0036 |
| Ca¹⁸⁺ | 20 | 4.34475E+07 | 1.00394 | 5109.38 | 5128.8 | 0.0038 |
| Sc¹⁹⁺ | 21 | 4.56358E+07 | 1.00450 | 5652.43 | 5674.8 | 0.0039 |
| Ti²⁰⁺ | 22 | 4.78241E+07 | 1.00511 | 6223.55 | 6249 | 0.0041 |
| V²¹⁺ | 23 | 5.00123E+07 | 1.00578 | 6822.93 | 6851.3 | 0.0041 |
| Cr²²⁺ | 24 | 5.22005E+07 | 1.00652 | 7450.76 | 7481.7 | 0.0041 |
| Mn²³⁺ | 25 | 5.43887E+07 | 1.00733 | 8107.25 | 8140.6 | 0.0041 |
| Fe²⁴⁺ | 26 | 5.65768E+07 | 1.00821 | 8792.66 | 8828 | 0.0040 |
| Co²⁵⁺ | 27 | 5.87649E+07 | 1.00917 | 9507.25 | 9544.1 | 0.0039 |
| Ni²⁶⁺ | 28 | 6.09529E+07 | 1.01022 | 10251.33 | 10288.8 | 0.0036 |
| Cu²⁷⁺ | 29 | 6.31409E+07 | 1.01136 | 11025.21 | 11062.38 | 0.0034 |

^{a}From Eq. (7.19) (Eq. (53)).
^{b}From Eq. (7.29) (Eq. (61)).
^{c}From Eq. (7.30).
^{d}From Eq. (7.31).
^{e}From Eq. (1.250) with the velocity given by Eq. (7.31).
^{f}From Eqs. (7.28) and (7.47) with E(electric) of Eq. (7.29) relativistically corrected by γ* according to Eq.(1.251) except that the electron-nuclear electrodynamic relativistic factor corresponding to the reduced mass of Eqs. (1.213-1.223) was not included.
^{g}From theoretical calculations for ions Ne⁸⁺ to Cu²⁸⁺ [24-25].
^{h}(Experimental − theoretical)/experimental.

### Approach for Three-Through Twenty-Electron Atoms

For each two-electron atom having a central charge of Z times that of the proton, there are two indistinguishable spin-paired electrons in an orbitsphere with radii r₁ and r₂ both given by Eq. (53). For Z≧3, the next electron which binds to form the corresponding three-electron atom is attracted by the central Coulomb field and is repelled by diamagnetic forces due to the spin-paired inner electrons such that it forms and unpaired orbitsphere at radius r₃. Since the charge-density function of each s electron including those of three-electron atoms is spherically symmetrical, the central Coulomb force, Fₑₗₑ, that acts on the outer electron to cause it to bind due to the nucleus and the inner electrons is given by

$${F}_{ele} = \frac{( Z - n ) {e}^{2}}{4 {πɛ}_{o} {r}_{n}^{2}} {i}_{r} \qquad ( 58 )$$

for r>rₙ₋₁ where n corresponds to the number of electrons of the atom and Z is its atomic number. In each case, the magnetic field of the binding outer electron changes the angular velocities of the inner electrons. However, in each case, the magnetic field of the outer electron provides a central Lorentzian force which exactly balances the change in centrifugal force because of the change in angular velocity [4]. The inner electrons remain at their initial radii, but cause a diamagnetic force according to Lenz's law or a paramagnetic force depending on the spin and orbital angular momenta of the inner electrons and that of the outer. The force balance minimizes the energy of the atom.

It was shown previously [4] that the same principles including the central force given by Eq. (58) applies in the case that a nonuniform distribution of charge according to Eq. (14) achieves an energy minimum. In the case that an electron has orbital angular momentum in addition to spin angular momentum, the corresponding charge density wave is a time and spherical-harmonic wherein the traveling charge-density wave modulates the constant charge-density function as given in the Angular Functions section. It was found that electrostatic and magnetostatic s electrons pair in shells until a fifth electron is added. Then, a nonuniform distribution of charge achieves an energy minimum with the formation of a third shell due to the dependence of the magnetic forces on the nuclear charge and orbital energy (Eqs. (10.52), (10.55), and (10.93) of Ref. [4]). Minimum energy configurations are given by solutions to Laplace's equation. The general form of the solution is

$$Φ ( r , θ , φ ) = {\sum }_{l = 0}^{∞} {\sum }_{m = - l}^{l} {B}_{l , m} {r}^{- ( l + 1 )} {Y}_{l}^{m} ( θ , φ ) \qquad ( 59 )$$

As demonstrated previously, this general solution also gives the functions of the resonant photons of excited states [4]. To maintain the symmetry of the central charge and the energy minimum condition given by solutions to Laplace's equation (Eq. (59)), the charge-density waves on electron orbitspheres at r₁ and r₃ complement those of the outer orbitals when the outer p orbitals are not all occupied by at least one electron, and the complementary charge-density waves are provided by electrons at r₃ when this condition is met. Since the angular harmonic charge-density waves are nonradiative as shown in the Nonradiation Based on the Electron Electromagnetic Fields and the Poynting Power Vector section, the time-averaged central field is inverse r-squared even though the central field is modulated by the concentric charge-density waves. The modulated central field maintains the spherical harmonic orbitals that maintain the spherical-harmonic phase according to Eq. (59). Thus, the central Coulomb force, Fₑₗₑ, that acts on the outer electron to cause it to bind due to the nucleus and the inner electrons is given by Eq. (58).

The outer electrons of atoms and ions that are isoelectronic with the series boron through neon half-fill a 2p level with unpaired electrons at nitrogen, then fill the level with paired electrons at neon. In general, electrons of an atom with the same principal and [symbol] quantum numbers align parallel until each of the [symbol] levels are occupied, and then pairing occurs until each of the [symbol] levels contain paired electrons. The electron configuration for one through twenty-electron atoms that achieves an energy minimum is: 1s<2s<2p<3s<3p<4s. In each case, the force balance of the central Coulombic, paramagnetic, and diamagnetic forces was derived for each n-electron atom that was solved for the radius of each electron. The ionization energies were obtained using the calculated radii in the determination of the Coulombic and any magnetic energies. The radii and ionization energies for all cases were given by equations having fundamental constants and each nuclear charge, Z, only. The predicted ionization energies and electron configurations compared with the experimental values [24-26] are given in TABLES I-XXIII.

The predicted electron configurations are in agreement with the experimental configurations known for 400 atoms and ions. The agreement between the experimental and calculated values of the ionization energies given in TABLES I-XX is well within the experimental capability of the spectroscopic determinations including the values at large Z which relies on X-ray spectroscopy. Ionization energies are difficult to determine since the cut-off of the Rydberg series of lines at the ionization energy is often not observed. Thus, each series isoelectronic with the neutral n-electron atom given in TABLES I-XX [24-25] relies on theoretical calculations and interpolation of the isoelectronic and Rydberg series as well as direct experimental data to extend the precision beyond the capability of X-ray spectroscopy. But, no assurances can be given that these techniques are correct, and they may not improve the results. In each case, the error given in the last column of TABLES I-XX is very reasonable given the quality of the data.

TABLE III
Ionization energies for some three-electron atoms.

| | | | | | | | Theoretical | Experimental | |
|---|---|---|---|---|---|---|---|---|---|
| | | | | Electric | | | Ionization | Ionization | |
| 3 e | | r₁ | r₃ | Energy^{c} | Δν^{d} | ΔE_{T}^{e} | Energies^{f} | Energies^{g} | Relative |
| Atom | Z | (a₀)^{a} | (a₀)^{b} | (eV) | (m/s) | (eV) | (eV) | (eV) | Error^{h} |
| Li | 3 | 0.35566 | 2.55606 | 5.3230 | 1.6571E+04 | 1.5613E−03 | 5.40381 | 5.39172 | −0.00224 |
| Be⁺ | 4 | 0.26116 | 1.49849 | 18.1594 | 4.4346E+04 | 1.1181E−02 | 18.1706 | 18.21116 | 0.00223 |
| B²⁺ | 5 | 0.20670 | 1.07873 | 37.8383 | 7.4460E+04 | 3.1523E−02 | 37.8701 | 37.93064 | 0.00160 |
| C³⁺ | 6 | 0.17113 | 0.84603 | 64.3278 | 1.0580E+05 | 6.3646E−02 | 64.3921 | 64.4939 | 0.00158 |
| N⁴⁺ | 7 | 0.14605 | 0.69697 | 97.6067 | 1.3782E+05 | 1.0800E−01 | 97.7160 | 97.8902 | 0.00178 |
| O⁵⁺ | 8 | 0.12739 | 0.59299 | 137.6655 | 1.7026E+05 | 1.6483E−01 | 137.8330 | 138.1197 | 0.00208 |
| F⁶⁺ | 9 | 0.11297 | 0.51621 | 184.5001 | 2.0298E+05 | 2.3425E−01 | 184.7390 | 185.186 | 0.00241 |
| Ne⁷⁺ | 10 | 0.10149 | 0.45713 | 238.1085 | 2.3589E+05 | 3.1636E−01 | 238.4325 | 239.0989 | 0.00279 |
| Na⁸⁺ | 11 | 0.09213 | 0.41024 | 298.4906 | 2.6894E+05 | 4.1123E−01 | 298.9137 | 299.864 | 0.00317 |
| Mg⁹⁺ | 12 | 0.08435 | 0.37210 | 365.6469 | 3.0210E+05 | 5.1890E−01 | 366.1836 | 367.5 | 0.00358 |
| Al¹⁰⁺ | 13 | 0.07778 | 0.34047 | 439.5790 | 3.3535E+05 | 6.3942E−01 | 440.2439 | 442 | 0.00397 |
| Si¹¹⁺ | 14 | 0.07216 | 0.31381 | 520.2888 | 3.6868E+05 | 7.7284E−01 | 521.0973 | 523.42 | 0.00444 |
| P¹²⁺ | 15 | 0.06730 | 0.29102 | 607.7792 | 4.0208E+05 | 9.1919E−01 | 608.7469 | 611.74 | 0.00489 |
| S¹³⁺ | 16 | 0.06306 | 0.27132 | 702.0535 | 4.3554E+05 | 1.0785E+00 | 703.1966 | 707.01 | 0.00539 |
| Cl¹⁴⁺ | 17 | 0.05932 | 0.25412 | 803.1158 | 4.6905E+05 | 1.2509E+00 | 804.4511 | 809.4 | 0.00611 |
| Ar¹⁵⁺ | 18 | 0.05599 | 0.23897 | 910.9708 | 5.0262E+05 | 1.4364E+00 | 912.5157 | 918.03 | 0.00601 |
| K¹⁶⁺ | 19 | 0.05302 | 0.22552 | 1025.6241 | 5.3625E+05 | 1.6350E+00 | 1027.3967 | 1033.4 | 0.00581 |
| Ca¹⁷⁺ | 20 | 0.05035 | 0.21350 | 1147.0819 | 5.6993E+05 | 1.8468E+00 | 1149.1010 | 1157.8 | 0.00751 |
| Sc¹⁸⁺ | 21 | 0.04794 | 0.20270 | 1275.3516 | 6.0367E+05 | 2.0720E+00 | 1277.6367 | 1287.97 | 0.00802 |
| Ti¹⁹⁺ | 22 | 0.04574 | 0.19293 | 1410.4414 | 6.3748E+05 | 2.3106E+00 | 1413.0129 | 1425.4 | 0.00869 |
| V²⁰⁺ | 23 | 0.04374 | 0.18406 | 1552.3606 | 6.7135E+05 | 2.5626E+00 | 1555.2398 | 1569.6 | 0.00915 |
| Cr²¹⁺ | 24 | 0.04191 | 0.17596 | 1701.1197 | 7.0530E+05 | 2.8283E+00 | 1704.3288 | 1721.4 | 0.00992 |
| Mn²²⁺ | 25 | 0.04022 | 0.16854 | 1856.7301 | 7.3932E+05 | 3.1077E+00 | 1860.2926 | 1879.9 | 0.01043 |
| Fe²³⁺ | 26 | 0.03867 | 0.16172 | 2019.2050 | 7.7342E+05 | 3.4011E+00 | 2023.1451 | 2023 | −0.00007 |
| Co²⁴⁺ | 27 | 0.03723 | 0.15542 | 2188.5585 | 8.0762E+05 | 3.7084E+00 | 2192.9020 | 2219 | 0.01176 |
| Ni²⁵⁺ | 28 | 0.03589 | 0.14959 | 2364.8065 | 8.4191E+05 | 4.0300E+00 | 2369.5803 | 2399.2 | 0.01235 |
| Cu²⁶⁺ | 29 | 0.03465 | 0.14418 | 2547.9664 | 8.7630E+05 | 4.3661E+00 | 2553.1987 | 2587.5 | 0.01326 |

^{a}Radius of the paired inner electrons of three-electron atoms from Eq. (10.49) (Eq. (60)).
^{b}Radius of the unpaired outer electron of three-electron atoms from Eq. (10.50) (Eq. (60)).
^{c}Electric energy of the outer electron of three-electron atoms from Eq. (10.43) (Eq. (61)).
^{d}Change in the velocity of the paired inner electrons due to the unpaired outer electron of three-electron atoms from Eq. (10.46).
^{e}Change in the kinetic energy of the paired inner electrons due to the unpaired outer electron of three-electron atoms from Eq. (10.47).
^{f}Calculated ionization energies of three-electron atoms from Eq. (10.48) for Z > 3 and Eq. (10.25) for Li.
^{g}From theoretical calculations, interpolation of isoelectronic and spectral series, and experimental data [24-25].
^{h}(Experimental − theoretical)/experimental.

TABLE IV
Ionization energies for some four-electron atoms.

| | | | | | | | | Theoretical | Experimental | |
|---|---|---|---|---|---|---|---|---|---|---|
| | | | | Electric | Magnetic | Δν^{e} | | Ionization | Ionization | |
| 4 e | | r₁ | r₃ | Energy^{c} | Energy^{d} | (m/s × | ΔE_{T}^{f} | Energies^{g} | Energies^{h} | Relative |
| Atom | Z | (a₀)^{a} | (a₀)^{b} | (eV) | (eV) | 10⁻⁵) | (eV) | (eV) | (eV) | Errorⁱ |
| Be | 4 | 0.26116 | 1.52503 | 8.9178 | 0.03226 | 0.4207 | 0.0101 | 9.28430 | 9.32263 | 0.0041 |
| B⁺ | 5 | 0.20670 | 1.07930 | 25.2016 | 0.0910 | 0.7434 | 0.0314 | 25.1627 | 25.15484 | −0.0003 |
| C²⁺ | 6 | 0.17113 | 0.84317 | 48.3886 | 0.1909 | 1.0688 | 0.0650 | 48.3125 | 47.8878 | −0.0089 |
| N³⁺ | 7 | 0.14605 | 0.69385 | 78.4029 | 0.3425 | 1.3969 | 0.1109 | 78.2765 | 77.4735 | −0.0104 |
| O⁴⁺ | 8 | 0.12739 | 0.59020 | 115.2148 | 0.5565 | 1.7269 | 0.1696 | 115.0249 | 113.899 | −0.0099 |
| F⁵⁺ | 9 | 0.11297 | 0.51382 | 158.8102 | 0.8434 | 2.0582 | 0.2409 | 158.5434 | 157.1651 | −0.0088 |
| Ne⁶⁺ | 10 | 0.10149 | 0.45511 | 209.1813 | 1.2138 | 2.3904 | 0.3249 | 208.8243 | 207.2759 | −0.0075 |
| Na⁷⁺ | 11 | 0.09213 | 0.40853 | 266.3233 | 1.6781 | 2.7233 | 0.4217 | 265.8628 | 264.25 | −0.0061 |
| Mg⁸⁺ | 12 | 0.08435 | 0.37065 | 330.2335 | 2.2469 | 3.0567 | 0.5312 | 329.6559 | 328.06 | −0.0049 |
| Al⁹⁺ | 13 | 0.07778 | 0.33923 | 400.9097 | 2.9309 | 3.3905 | 0.6536 | 400.2017 | 398.75 | −0.0036 |
| Si¹⁰⁺ | 14 | 0.07216 | 0.31274 | 478.3507 | 3.7404 | 3.7246 | 0.7888 | 477.4989 | 476.36 | −0.0024 |
| P¹¹⁺ | 15 | 0.06730 | 0.29010 | 562.5555 | 4.6861 | 4.0589 | 0.9367 | 561.5464 | 560.8 | −0.0013 |
| S¹²⁺ | 16 | 0.06306 | 0.27053 | 653.5233 | 5.7784 | 4.3935 | 1.0975 | 652.3436 | 652.2 | −0.0002 |
| Cl¹³⁺ | 17 | 0.05932 | 0.25344 | 751.2537 | 7.0280 | 4.7281 | 1.2710 | 749.8899 | 749.76 | −0.0002 |
| Ar¹⁴⁺ | 18 | 0.05599 | 0.23839 | 855.7463 | 8.4454 | 5.0630 | 1.4574 | 854.1849 | 854.77 | 0.0007 |
| K¹⁵⁺ | 19 | 0.05302 | 0.22503 | 967.0007 | 10.0410 | 5.3979 | 1.6566 | 965.2283 | 968 | 0.0029 |
| Ca¹⁶⁺ | 20 | 0.05035 | 0.21308 | 1085.0167 | 11.8255 | 5.7329 | 1.8687 | 1083.0198 | 1087 | 0.0037 |
| Sc¹⁷⁺ | 21 | 0.04794 | 0.20235 | 1209.7940 | 13.8094 | 6.0680 | 2.0935 | 1207.5592 | 1213 | 0.0045 |
| Ti¹⁸⁺ | 22 | 0.04574 | 0.19264 | 1341.3326 | 16.0032 | 6.4032 | 2.3312 | 1338.8465 | 1346 | 0.0053 |
| V¹⁹⁺ | 23 | 0.04374 | 0.18383 | 1479.6323 | 18.4174 | 6.7384 | 2.5817 | 1476.8813 | 1486 | 0.0061 |
| Cr²⁰⁺ | 24 | 0.04191 | 0.17579 | 1624.6929 | 21.0627 | 7.0737 | 2.8450 | 1621.6637 | 1634 | 0.0075 |
| Mn²¹⁺ | 25 | 0.04022 | 0.16842 | 1776.5144 | 23.9495 | 7.4091 | 3.1211 | 1773.1935 | 1788 | 0.0083 |
| Fe²²⁺ | 26 | 0.03867 | 0.16165 | 1935.0968 | 27.0883 | 7.7444 | 3.4101 | 1931.4707 | 1950 | 0.0095 |
| Co²³⁺ | 27 | 0.03723 | 0.15540 | 2100.4398 | 30.4898 | 8.0798 | 3.7118 | 2096.4952 | 2119 | 0.0106 |
| Ni²⁴⁺ | 28 | 0.03589 | 0.14961 | 2272.5436 | 34.1644 | 8.4153 | 4.0264 | 2268.2669 | 2295 | 0.0116 |
| Cu²⁵⁺ | 29 | 0.03465 | 0.14424 | 2451.4080 | 38.1228 | 8.7508 | 4.3539 | 2446.7858 | 2478 | 0.0126 |

^{a}Radius of the paired inner electrons of four-electron atoms from Eq. (10.51) (Eq. (60)).
^{b}Radius of the paired outer electrons of four-electron atoms from Eq. (10.62) (Eq. (60)).
^{c}Electric energy of the outer electrons of four-electron atoms from Eq. (10.63) (Eq. (61)).
^{d}Magnetic energy of the outer electrons of four-electron atoms upon unpairing from Eq. (7.30) and Eq. (10.64).
^{e}Change in the velocity of the paired inner electrons due to the unpaired outer electron of four-electron atoms during ionization from Eq. (10.46).
^{f}Change in the kinetic energy of the paired inner electrons due to the unpaired outer electron of four-electron atoms during ionization from Eq. (10.47).
^{g}Calculated ionization energies of four-electron atoms from Eq. (10.68) for Z > 4 and Eq. (10.66) for Be.
^{h}From theoretical calculations, interpolation of isoelectronic and spectral series, and experimental data [24-25].
ⁱ(Experimental − theoretical)/experimental.

TABLE V
Ionization energies for some five-electron atoms.

| | | | | | Theoretical | Experimental | |
|---|---|---|---|---|---|---|---|
| | | | | | Ionization | Ionization | |
| 5 e | | r₁ | r₃ | r₅ | Energies^{d} | Energies^{e} | |
| Atom | Z | (a₀)^{a} | (a₀)^{b} | (a₀)^{c} | (eV) | (eV) | Relative Error^{f} |
| B | 5 | 0.20670 | 1.07930 | 1.67000 | 8.30266 | 8.29803 | −0.00056 |
| C⁺ | 6 | 0.17113 | 0.84317 | 1.12092 | 24.2762 | 24.38332 | 0.0044 |
| N²⁺ | 7 | 0.14605 | 0.69385 | 0.87858 | 46.4585 | 47.44924 | 0.0209 |
| O³⁺ | 8 | 0.12739 | 0.59020 | 0.71784 | 75.8154 | 77.41353 | 0.0206 |
| F⁴⁺ | 9 | 0.11297 | 0.51382 | 0.60636 | 112.1922 | 114.2428 | 0.0179 |
| Ne⁵⁺ | 10 | 0.10149 | 0.45511 | 0.52486 | 155.5373 | 157.93 | 0.0152 |
| Na⁶⁺ | 11 | 0.09213 | 0.40853 | 0.46272 | 205.8266 | 208.5 | 0.0128 |
| Mg⁷⁺ | 12 | 0.08435 | 0.37065 | 0.41379 | 263.0469 | 265.96 | 0.0110 |
| Al⁸⁺ | 13 | 0.07778 | 0.33923 | 0.37425 | 327.1901 | 330.13 | 0.0089 |
| Si⁹⁺ | 14 | 0.07216 | 0.31274 | 0.34164 | 398.2509 | 401.37 | 0.0078 |
| P¹⁰⁺ | 15 | 0.06730 | 0.29010 | 0.31427 | 476.2258 | 479.46 | 0.0067 |
| S¹¹⁺ | 16 | 0.06306 | 0.27053 | 0.29097 | 561.1123 | 564.44 | 0.0059 |
| Cl¹²⁺ | 17 | 0.05932 | 0.25344 | 0.27090 | 652.9086 | 656.71 | 0.0058 |
| Ar¹³⁺ | 18 | 0.05599 | 0.23839 | 0.25343 | 751.6132 | 755.74 | 0.0055 |
| K¹⁴⁺ | 19 | 0.05302 | 0.22503 | 0.23808 | 857.2251 | 861.1 | 0.0045 |
| Ca¹⁵⁺ | 20 | 0.05035 | 0.21308 | 0.22448 | 969.7435 | 974 | 0.0044 |
| Sc¹⁶⁺ | 21 | 0.04794 | 0.20235 | 0.21236 | 1089.1678 | 1094 | 0.0044 |
| Ti¹⁷⁺ | 22 | 0.04574 | 0.19264 | 0.20148 | 1215.4975 | 1221 | 0.0045 |
| V¹⁸⁺ | 23 | 0.04374 | 0.18383 | 0.19167 | 1348.7321 | 1355 | 0.0046 |
| Cr¹⁹⁺ | 24 | 0.04191 | 0.17579 | 0.18277 | 1488.8713 | 1496 | 0.0048 |
| Mn²⁰⁺ | 25 | 0.04022 | 0.16842 | 0.17466 | 1635.9148 | 1644 | 0.0049 |
| Fe²¹⁺ | 26 | 0.03867 | 0.16165 | 0.16724 | 1789.8624 | 1799 | 0.0051 |
| Co²²⁺ | 27 | 0.03723 | 0.15540 | 0.16042 | 1950.7139 | 1962 | 0.0058 |
| Ni²³⁺ | 28 | 0.03589 | 0.14961 | 0.15414 | 2118.4690 | 2131 | 0.0059 |
| Cu²⁴⁺ | 29 | 0.03465 | 0.14424 | 0.14833 | 2293.1278 | 2308 | 0.0064 |

^{a}Radius of the first set of paired inner electrons of five-electron atoms from Eq. (10.51) (Eq. (60)).
^{b}Radius of the second set of paired inner electrons of five-electron atoms from Eq. (10.62) (Eq. (60)).
^{c}Radius of the outer electron of five-electron atoms from Eq. (10.113) (Eq. (64)) for Z > 5 and Eq. (10.101) for B.
^{d}Calculated ionization energies of five-electron atoms given by the electric energy (Eq. (10.114)) (Eq. (61)) for Z > 5 and Eq. (10.104) for B.
^{e}From theoretical calculations, interpolation of isoelectronic and spectral series, and experimental data [24-25].
^{f}(Experimental − theoretical)/experimental.

TABLE VI
Ionization energies for some six-electron atoms.

| | | | | | Theoretical | Experimental | |
|---|---|---|---|---|---|---|---|
| | | | | | Ionization | Ionization | |
| | | r₁ | r₃ | r₆ | Energies^{d} | Energies^{e} | |
| 6 e Atom | Z | (a₀)^{a} | (a₀)^{b} | (a₀)^{c} | (eV) | (eV) | Relative Error^{f} |
| C | 6 | 0.17113 | 0.84317 | 1.20654 | 11.27671 | 11.2603 | −0.0015 |
| N⁺ | 7 | 0.14605 | 0.69385 | 0.90119 | 30.1950 | 29.6013 | −0.0201 |
| O²⁺ | 8 | 0.12739 | 0.59020 | 0.74776 | 54.5863 | 54.9355 | 0.0064 |
| F³⁺ | 9 | 0.11297 | 0.51382 | 0.63032 | 86.3423 | 87.1398 | 0.0092 |
| Ne⁴⁺ | 10 | 0.10149 | 0.45511 | 0.54337 | 125.1986 | 126.21 | 0.0080 |
| Na⁵⁺ | 11 | 0.09213 | 0.40853 | 0.47720 | 171.0695 | 172.18 | 0.0064 |
| Mg⁶⁺ | 12 | 0.08435 | 0.37065 | 0.42534 | 223.9147 | 225.02 | 0.0049 |
| Al⁷⁺ | 13 | 0.07778 | 0.33923 | 0.38365 | 283.7121 | 284.66 | 0.0033 |
| Si⁸⁺ | 14 | 0.07216 | 0.31274 | 0.34942 | 350.4480 | 351.12 | 0.0019 |
| P⁹⁺ | 15 | 0.06730 | 0.29010 | 0.32081 | 424.1135 | 424.4 | 0.0007 |
| S¹⁰⁺ | 16 | 0.06306 | 0.27053 | 0.29654 | 504.7024 | 504.8 | 0.0002 |
| Cl¹¹⁺ | 17 | 0.05932 | 0.25344 | 0.27570 | 592.2103 | 591.99 | −0.0004 |
| Ar¹²⁺ | 18 | 0.05599 | 0.23839 | 0.25760 | 686.6340 | 686.1 | −0.0008 |
| K¹³⁺ | 19 | 0.05302 | 0.22503 | 0.24174 | 787.9710 | 786.6 | −0.0017 |
| Ca¹⁴⁺ | 20 | 0.05035 | 0.21308 | 0.22772 | 896.2196 | 894.5 | −0.0019 |
| Sc¹⁵⁺ | 21 | 0.04794 | 0.20235 | 0.21524 | 1011.3782 | 1009 | −0.0024 |
| Ti¹⁶⁺ | 22 | 0.04574 | 0.19264 | 0.20407 | 1133.4456 | 1131 | −0.0022 |
| V¹⁷⁺ | 23 | 0.04374 | 0.18383 | 0.19400 | 1262.4210 | 1260 | −0.0019 |
| Cr¹⁸⁺ | 24 | 0.04191 | 0.17579 | 0.18487 | 1398.3036 | 1396 | −0.0017 |
| Mn¹⁹⁺ | 25 | 0.04022 | 0.16842 | 0.17657 | 1541.0927 | 1539 | −0.0014 |
| Fe²⁰⁺ | 26 | 0.03867 | 0.16165 | 0.16899 | 1690.7878 | 1689 | −0.0011 |
| Co²¹⁺ | 27 | 0.03723 | 0.15540 | 0.16203 | 1847.3885 | 1846 | −0.0008 |
| Ni²²⁺ | 28 | 0.03589 | 0.14961 | 0.15562 | 2010.8944 | 2011 | 0.0001 |
| Cu²³⁺ | 29 | 0.03465 | 0.14424 | 0.14970 | 2181.3053 | 2182 | 0.0003 |

^{a}Radius of the first set of paired inner electrons of six-electron atoms from Eq. (10.51) (Eq. (60)).
^{b}Radius of the second set of paired inner electrons of six-electron atoms from Eq. (10.62) (Eq. (60)).
^{c}Radius of the two unpaired outer electrons of six-electron atoms from Eq. (10.132) (Eq. (64)) for Z > 6 and Eq. (10.122) for C.
^{d}Calculated ionization energies of six-electron atoms given by the electric energy (Eq. (10.133)) (Eq. (61)).
^{e}From theoretical calculations, interpolation of isoelectronic and spectral series, and experimental data [24-25].
^{f}(Experimental − theoretical)/experimental.

TABLE VII
Ionization energies for some seven-electron atoms.

| | | | | | Theoretical | Experimental | |
|---|---|---|---|---|---|---|---|
| | | | | | Ionization | Ionization | |
| 7 e | | r₁ | r₃ | r₇ | Energies^{d} | Energies^{e} | |
| Atom | Z | (a₀)^{a} | (a₀)^{b} | (a₀)^{c} | (eV) | (eV) | Relative Error^{f} |
| N | 7 | 0.14605 | 0.69385 | 0.93084 | 14.61664 | 14.53414 | −0.0057 |
| O⁺ | 8 | 0.12739 | 0.59020 | 0.78489 | 34.6694 | 35.1173 | 0.0128 |
| F²⁺ | 9 | 0.11297 | 0.51382 | 0.67084 | 60.8448 | 62.7084 | 0.0297 |
| Ne³⁺ | 10 | 0.10149 | 0.45511 | 0.57574 | 94.5279 | 97.12 | 0.0267 |
| Na⁴⁺ | 11 | 0.09213 | 0.40853 | 0.50250 | 135.3798 | 138.4 | 0.0218 |
| Mg⁵⁺ | 12 | 0.08435 | 0.37065 | 0.44539 | 183.2888 | 186.76 | 0.0186 |
| Al⁶⁺ | 13 | 0.07778 | 0.33923 | 0.39983 | 238.2017 | 241.76 | 0.0147 |
| Si⁷⁺ | 14 | 0.07216 | 0.31274 | 0.36271 | 300.0883 | 303.54 | 0.0114 |
| P⁸⁺ | 15 | 0.06730 | 0.29010 | 0.33191 | 368.9298 | 372.13 | 0.0086 |
| S⁹⁺ | 16 | 0.06306 | 0.27053 | 0.30595 | 444.7137 | 447.5 | 0.0062 |
| Cl¹⁰⁺ | 17 | 0.05932 | 0.25344 | 0.28376 | 527.4312 | 529.28 | 0.0035 |
| Ar¹¹⁺ | 18 | 0.05599 | 0.23839 | 0.26459 | 617.0761 | 618.26 | 0.0019 |
| K¹²⁺ | 19 | 0.05302 | 0.22503 | 0.24785 | 713.6436 | 714.6 | 0.0013 |
| Ca¹³⁺ | 20 | 0.05035 | 0.21308 | 0.23311 | 817.1303 | 817.6 | 0.0006 |
| Sc¹⁴⁺ | 21 | 0.04794 | 0.20235 | 0.22003 | 927.5333 | 927.5 | 0.0000 |
| Ti¹⁵⁺ | 22 | 0.04574 | 0.19264 | 0.20835 | 1044.8504 | 1044 | −0.0008 |
| V¹⁶⁺ | 23 | 0.04374 | 0.18383 | 0.19785 | 1169.0800 | 1168 | −0.0009 |
| Cr¹⁷⁺ | 24 | 0.04191 | 0.17579 | 0.18836 | 1300.2206 | 1299 | −0.0009 |
| Mn¹⁸⁺ | 25 | 0.04022 | 0.16842 | 0.17974 | 1438.2710 | 1437 | −0.0009 |
| Fe¹⁹⁺ | 26 | 0.03867 | 0.16165 | 0.17187 | 1583.2303 | 1582 | −0.0008 |
| Co²⁰⁺ | 27 | 0.03723 | 0.15540 | 0.16467 | 1735.0978 | 1735 | −0.0001 |
| Ni²¹⁺ | 28 | 0.03589 | 0.14961 | 0.15805 | 1893.8726 | 1894 | 0.0001 |
| Cu²²⁺ | 29 | 0.03465 | 0.14424 | 0.15194 | 2059.5543 | 2060 | 0.0002 |

^{a}Radius of the first set of paired inner electrons of seven-electron atoms from Eq. (10.51) (Eq. (60)).
^{b}Radius of the second set of paired inner electrons of seven-electron atoms from Eq. (10.62) (Eq. (60)).
^{c}Radius of the three unpaired paired outer electrons of seven-electron atoms from Eq. (10.152) (Eq. (64)) for Z > 7 and Eq. (10.142) for N.
^{d}Calculated ionization energies of seven-electron atoms given by the electric energy (Eq. (10.153)) (Eq. (61)).
^{e}From theoretical calculations, interpolation of isoelectronic and spectral series, and experimental data [24-25].
^{f}(Experimental − theoretical)/experimental.

TABLE VIII
Ionization energies for some eight-electron atoms.

| | | | | | Theoretical | Experimental | |
|---|---|---|---|---|---|---|---|
| | | | | | Ionization | Ionization | |
| 8 e | | r₁ | r₃ | r₈ | Energies^{d} | Energies^{e} | |
| Atom | Z | (a₀)^{a} | (a₀)^{b} | (a₀)^{c} | (eV) | (eV) | Relative Error^{f} |
| O | 8 | 0.12739 | 0.59020 | 1.00000 | 13.60580 | 13.6181 | 0.0009 |
| F⁺ | 9 | 0.11297 | 0.51382 | 0.7649 | 35.5773 | 34.9708 | −0.0173 |
| Ne²⁺ | 10 | 0.10149 | 0.45511 | 0.6514 | 62.6611 | 63.45 | 0.0124 |
| Na³⁺ | 11 | 0.09213 | 0.40853 | 0.5592 | 97.3147 | 98.91 | 0.0161 |
| Mg⁴⁺ | 12 | 0.08435 | 0.37065 | 0.4887 | 139.1911 | 141.27 | 0.0147 |
| Al⁵⁺ | 13 | 0.07778 | 0.33923 | 0.4338 | 188.1652 | 190.49 | 0.0122 |
| Si⁶⁺ | 14 | 0.07216 | 0.31274 | 0.3901 | 244.1735 | 246.5 | 0.0094 |
| P⁷⁺ | 15 | 0.06730 | 0.29010 | 0.3543 | 307.1791 | 309.6 | 0.0078 |
| S⁸⁺ | 16 | 0.06306 | 0.27053 | 0.3247 | 377.1579 | 379.55 | 0.0063 |
| Cl⁹⁺ | 17 | 0.05932 | 0.25344 | 0.2996 | 454.0940 | 455.63 | 0.0034 |
| Ar¹⁰⁺ | 18 | 0.05599 | 0.23839 | 0.2782 | 537.9756 | 538.96 | 0.0018 |
| K¹¹⁺ | 19 | 0.05302 | 0.22503 | 0.2597 | 628.7944 | 629.4 | 0.0010 |
| Ca¹²⁺ | 20 | 0.05035 | 0.21308 | 0.2434 | 726.5442 | 726.6 | 0.0001 |
| Sc¹³⁺ | 21 | 0.04794 | 0.20235 | 0.2292 | 831.2199 | 830.8 | −0.0005 |
| Ti¹⁴⁺ | 22 | 0.04574 | 0.19264 | 0.2165 | 942.8179 | 941.9 | −0.0010 |
| V¹⁵⁺ | 23 | 0.04374 | 0.18383 | 0.2051 | 1061.3351 | 1060 | −0.0013 |
| Cr¹⁶⁺ | 24 | 0.04191 | 0.17579 | 0.1949 | 1186.7691 | 1185 | −0.0015 |
| Mn¹⁷⁺ | 25 | 0.04022 | 0.16842 | 0.1857 | 1319.1179 | 1317 | −0.0016 |
| Fe¹⁸⁺ | 26 | 0.03867 | 0.16165 | 0.1773 | 1458.3799 | 1456 | −0.0016 |
| Co¹⁹⁺ | 27 | 0.03723 | 0.15540 | 0.1696 | 1604.5538 | 1603 | −0.0010 |
| Ni²⁰⁺ | 28 | 0.03589 | 0.14961 | 0.1626 | 1757.6383 | 1756 | −0.0009 |
| Cu²¹⁺ | 29 | 0.03465 | 0.14424 | 0.1561 | 1917.6326 | 1916 | −0.0009 |

^{a}Radius of the first set of paired inner electrons of eight-electron atoms from Eq. (10.51) (Eq. (60)).
^{b}Radius of the second set of paired inner electrons of eight-electron atoms from Eq. (10.62) (Eq. (60)).
^{c}Radius of the two paired and two unpaired outer electrons of eight-electron atoms from Eq. (10.172) (Eq. (64)) for Z > 8 and Eq. (10.162) for O.
^{d}Calculated ionization energies of eight-electron atoms given by the electric energy (Eq. (10.173)) (Eq. (61)).
^{e}From theoretical calculations, interpolation of isoelectronic and spectral series, and experimental data [24-25].
^{f}(Experimental − theoretical)/experimental.

TABLE IX
Ionization energies for some nine-electron atoms.

| | | | | | Theoretical | Experimental | |
|---|---|---|---|---|---|---|---|
| | | | | | Ionization | Ionization | |
| 9 e | | r₁ | r₃ | r₉ | Energies^{d} | Energies^{e} | |
| Atom | Z | (a₀)^{a} | (a₀)^{b} | (a₀)^{c} | (eV) | (eV) | Relative Error^{f} |
| F | 9 | 0.11297 | 0.51382 | 0.78069 | 17.42782 | 17.42282 | −0.0003 |
| Ne⁺ | 10 | 0.10149 | 0.45511 | 0.64771 | 42.0121 | 40.96328 | −0.0256 |
| Na²⁺ | 11 | 0.09213 | 0.40853 | 0.57282 | 71.2573 | 71.62 | 0.0051 |
| Mg³⁺ | 12 | 0.08435 | 0.37065 | 0.50274 | 108.2522 | 109.2655 | 0.0093 |
| Al⁴⁺ | 13 | 0.07778 | 0.33923 | 0.44595 | 152.5469 | 153.825 | 0.0083 |
| Si⁵⁺ | 14 | 0.07216 | 0.31274 | 0.40020 | 203.9865 | 205.27 | 0.0063 |
| P⁶⁺ | 15 | 0.06730 | 0.29010 | 0.36283 | 262.4940 | 263.57 | 0.0041 |
| S⁷⁺ | 16 | 0.06306 | 0.27053 | 0.33182 | 328.0238 | 328.75 | 0.0022 |
| Cl⁸⁺ | 17 | 0.05932 | 0.25344 | 0.30571 | 400.5466 | 400.06 | −0.0012 |
| Ar⁹⁺ | 18 | 0.05599 | 0.23839 | 0.28343 | 480.0424 | 478.69 | −0.0028 |
| K¹⁰⁺ | 19 | 0.05302 | 0.22503 | 0.26419 | 566.4968 | 564.7 | −0.0032 |
| Ca¹¹⁺ | 20 | 0.05035 | 0.21308 | 0.24742 | 659.8992 | 657.2 | −0.0041 |
| Sc¹²⁺ | 21 | 0.04794 | 0.20235 | 0.23266 | 760.2415 | 756.7 | −0.0047 |
| Ti¹³⁺ | 22 | 0.04574 | 0.19264 | 0.21957 | 867.5176 | 863.1 | −0.0051 |
| V¹⁴⁺ | 23 | 0.04374 | 0.18383 | 0.20789 | 981.7224 | 976 | −0.0059 |
| Cr¹⁵⁺ | 24 | 0.04191 | 0.17579 | 0.19739 | 1102.8523 | 1097 | −0.0053 |
| Mn¹⁶⁺ | 25 | 0.04022 | 0.16842 | 0.18791 | 1230.9038 | 1224 | −0.0056 |
| Fe¹⁷⁺ | 26 | 0.03867 | 0.16165 | 0.17930 | 1365.8746 | 1358 | −0.0058 |
| Co¹⁸⁺ | 27 | 0.03723 | 0.15540 | 0.17145 | 1507.7624 | 1504.6 | −0.0021 |
| Ni¹⁹⁺ | 28 | 0.03589 | 0.14961 | 0.16427 | 1656.5654 | 1648 | −0.0052 |
| Cu²⁰⁺ | 29 | 0.03465 | 0.14424 | 0.15766 | 1812.2821 | 1804 | −0.0046 |

^{a}Radius of the first set of paired inner electrons of nine-electron atoms from Eq. (10.51) (Eq. (60)).
^{b}Radius of the second set of paired inner electrons of nine-electron atoms from Eq. (10.62) (Eq. (60)).
^{c}Radius of the one unpaired and two sets of paired outer electrons of nine-electron atoms from Eq. (10.192) (Eq. (64)) for Z > 9 and Eq. (10.182) for F.
^{d}Calculated ionization energies of nine-electron atoms given by the electric energy (Eq. (10.193)) (Eq. (61)).
^{e}From theoretical calculations, interpolation of isoelectronic and spectral series, and experimental data [24-25].
^{f}(Experimental − theoretical)/experimental.

TABLE X
Ionization energies for some ten-electron atoms.

| | | | | | Theoretical | Experimental | |
|---|---|---|---|---|---|---|---|
| | | | | | Ionization | Ionization | |
| 10 e | | r₁ | r₃ | r₁₀ | Energies^{d} | Energies^{e} | |
| Atom | Z | (a₀)^{a} | (a₀)^{b} | (a₀)^{c} | (eV) | (eV) | Relative Error^{f} |
| Ne | 10 | 0.10149 | 0.45511 | 0.63659 | 21.37296 | 21.56454 | 0.00888 |
| Na⁺ | 11 | 0.09213 | 0.40853 | 0.560945 | 48.5103 | 47.2864 | −0.0259 |
| Mg²⁺ | 12 | 0.08435 | 0.37065 | 0.510568 | 79.9451 | 80.1437 | 0.0025 |
| Al³⁺ | 13 | 0.07778 | 0.33923 | 0.456203 | 119.2960 | 119.992 | 0.0058 |
| Si⁴⁺ | 14 | 0.07216 | 0.31274 | 0.409776 | 166.0150 | 166.767 | 0.0045 |
| P⁵⁺ | 15 | 0.06730 | 0.29010 | 0.371201 | 219.9211 | 220.421 | 0.0023 |
| S⁶⁺ | 16 | 0.06306 | 0.27053 | 0.339025 | 280.9252 | 280.948 | 0.0001 |
| Cl⁷⁺ | 17 | 0.05932 | 0.25344 | 0.311903 | 348.9750 | 348.28 | −0.0020 |
| Ar⁸⁺ | 18 | 0.05599 | 0.23839 | 0.288778 | 424.0365 | 422.45 | −0.0038 |
| K⁹⁺ | 19 | 0.05302 | 0.22503 | 0.268844 | 506.0861 | 503.8 | −0.0045 |
| Ca¹⁰⁺ | 20 | 0.05035 | 0.21308 | 0.251491 | 595.1070 | 591.9 | −0.0054 |
| Sc¹¹⁺ | 21 | 0.04794 | 0.20235 | 0.236251 | 691.0866 | 687.36 | −0.0054 |
| Ti¹²⁺ | 22 | 0.04574 | 0.19264 | 0.222761 | 794.0151 | 787.84 | −0.0078 |
| V¹³⁺ | 23 | 0.04374 | 0.18383 | 0.210736 | 903.8853 | 896 | −0.0088 |
| Cr¹⁴⁺ | 24 | 0.04191 | 0.17579 | 0.19995 | 1020.6910 | 1010.6 | −0.0100 |
| Mn¹⁵⁺ | 25 | 0.04022 | 0.16842 | 0.19022 | 1144.4276 | 1134.7 | −0.0086 |
| Fe¹⁶⁺ | 26 | 0.03867 | 0.16165 | 0.181398 | 1275.0911 | 1266 | −0.0072 |
| Co¹⁷⁺ | 27 | 0.03723 | 0.15540 | 0.173362 | 1412.6783 | 1397.2 | −0.0111 |
| Ni¹⁸⁺ | 28 | 0.03589 | 0.14961 | 0.166011 | 1557.1867 | 1541 | −0.0105 |
| Cu¹⁹⁺ | 29 | 0.03465 | 0.14424 | 0.159261 | 1708.6139 | 1697 | −0.0068 |
| Zn²⁰⁺ | 30 | 0.03349 | 0.13925 | 0.153041 | 1866.9581 | 1856 | −0.0059 |

^{a}Radius of the first set of paired inner electrons of ten-electron atoms from Eq. (10.51) (Eq. (60)).
^{b}Radius of the second set of paired inner electrons of ten-electron atoms from Eq. (10.62) (Eq. (60)).
^{c}Radius of three sets of paired outer electrons of ten-electron atoms from Eq. (10.212)) (Eq. (64)) for Z > 10 and Eq. (10.202) for Ne.
^{d}Calculated ionization energies of ten-electron atoms given by the electric energy (Eq. (10.213)) (Eq. (61)).
^{e}From theoretical calculations, interpolation of isoelectronic and spectral series, and experimental data [24-25].
^{f}(Experimental − theoretical)/experimental.

TABLE XI
Ionization energies for some eleven-electron atoms.

| | | | | | | Theoretical | Experimental | |
|---|---|---|---|---|---|---|---|---|
| | | | | | | Ionization | Ionization | |
| 11 e | | r₁ | r₃ | r₁₀ | r₁₁ | Energies^{e} | Energies^{f} | |
| Atom | Z | (a₀)^{a} | (a₀)^{b} | (a₀)^{c} | (a₀)^{d} | (eV) | (eV) | Relative Error^{g} |
| Na | 11 | 0.09213 | 0.40853 | 0.560945 | 2.65432 | 5.12592 | 5.13908 | 0.0026 |
| Mg⁺ | 12 | 0.08435 | 0.37065 | 0.510568 | 1.74604 | 15.5848 | 15.03528 | −0.0365 |
| Al²⁺ | 13 | 0.07778 | 0.33923 | 0.456203 | 1.47399 | 27.6918 | 28.44765 | 0.0266 |
| Si³⁺ | 14 | 0.07216 | 0.31274 | 0.409776 | 1.25508 | 43.3624 | 45.14181 | 0.0394 |
| P⁴⁺ | 15 | 0.06730 | 0.29010 | 0.371201 | 1.08969 | 62.4299 | 65.0251 | 0.0399 |
| S⁵⁺ | 16 | 0.06306 | 0.27053 | 0.339025 | 0.96226 | 84.8362 | 88.0530 | 0.0365 |
| Cl⁶⁺ | 17 | 0.05932 | 0.25344 | 0.311903 | 0.86151 | 110.5514 | 114.1958 | 0.0319 |
| Ar⁷⁺ | 18 | 0.05599 | 0.23839 | 0.288778 | 0.77994 | 139.5577 | 143.460 | 0.0272 |
| K⁸⁺ | 19 | 0.05302 | 0.22503 | 0.268844 | 0.71258 | 171.8433 | 175.8174 | 0.0226 |
| Ca⁹⁺ | 20 | 0.05035 | 0.21308 | 0.251491 | 0.65602 | 207.3998 | 211.275 | 0.0183 |
| Sc¹⁰⁺ | 21 | 0.04794 | 0.20235 | 0.236251 | 0.60784 | 246.2213 | 249.798 | 0.0143 |
| Ti¹¹⁺ | 22 | 0.04574 | 0.19264 | 0.222761 | 0.56631 | 288.3032 | 291.500 | 0.0110 |
| V¹²⁺ | 23 | 0.04374 | 0.18383 | 0.210736 | 0.53014 | 333.6420 | 336.277 | 0.0078 |
| Cr¹³⁺ | 24 | 0.04191 | 0.17579 | 0.19995 | 0.49834 | 382.2350 | 384.168 | 0.0050 |
| Mn¹⁴⁺ | 25 | 0.04022 | 0.16842 | 0.19022 | 0.47016 | 434.0801 | 435.163 | 0.0025 |
| Fe¹⁵⁺ | 26 | 0.03867 | 0.16165 | 0.181398 | 0.44502 | 489.1753 | 489.256 | 0.0002 |
| Co¹⁶⁺ | 27 | 0.03723 | 0.15540 | 0.173362 | 0.42245 | 547.5194 | 546.58 | −0.0017 |
| Ni¹⁷⁺ | 28 | 0.03589 | 0.14961 | 0.166011 | 0.40207 | 609.1111 | 607.06 | −0.0034 |
| Cu¹⁸⁺ | 29 | 0.03465 | 0.14424 | 0.159261 | 0.38358 | 673.9495 | 670.588 | −0.0050 |
| Zn¹⁹⁺ | 30 | 0.03349 | 0.13925 | 0.153041 | 0.36672 | 742.0336 | 738 | −0.0055 |

^{a}Radius of the first set of paired inner electrons of eleven-electron atoms from Eq. (10.51) (Eq. (60)).
^{b}Radius of the second set of paired inner electrons of eleven-electron atoms from Eq. (10.62) (Eq. (60)).
^{c}Radius of three sets of paired inner electrons of eleven-electron atoms from Eq. (10.212)) (Eq. (64)).
^{d}Radius of unpaired outer electron of eleven-electron atoms from Eq. (10.235)) (Eq. (60)) for Z > 11 and Eq. (10.226) for Na.
^{e}Calculated ionization energies of eleven-electron atoms given by the electric energy (Eq. (10.236)) (Eq. (61)).
^{f}From theoretical calculations, interpolation of isoelectronic and spectral series, and experimental data [24-25].
^{g}(Experimental − theoretical)/experimental.

TABLE XII
Ionization energies for some twelve-electron atoms.

| | | | | | | Theoretical | Experimental | |
|---|---|---|---|---|---|---|---|---|
| | | | | | | Ionization | Ionization | |
| 12 e | | r₁ | r₃ | r₁₀ | r₁₂ | Energies^{e} | Energies^{f} | |
| Atom | Z | (a₀)^{a} | (a₀)^{b} | (a₀)^{c} | (a₀)^{d} | (eV) | (eV) | Relative Error^{g} |
| Mg | 12 | 0.08435 | 0.37065 | 0.51057 | 1.79386 | 7.58467 | 7.64624 | 0.0081 |
| Al⁺ | 13 | 0.07778 | 0.33923 | 0.45620 | 1.41133 | 19.2808 | 18.82856 | −0.0240 |
| Si²⁺ | 14 | 0.07216 | 0.31274 | 0.40978 | 1.25155 | 32.6134 | 33.49302 | 0.0263 |
| P³⁺ | 15 | 0.06730 | 0.29010 | 0.37120 | 1.09443 | 49.7274 | 51.4439 | 0.0334 |
| S⁴⁺ | 16 | 0.06306 | 0.27053 | 0.33902 | 0.96729 | 70.3296 | 72.5945 | 0.0312 |
| Cl⁵⁺ | 17 | 0.05932 | 0.25344 | 0.31190 | 0.86545 | 94.3266 | 97.03 | 0.0279 |
| Ar⁶⁺ | 18 | 0.05599 | 0.23839 | 0.28878 | 0.78276 | 121.6724 | 124.323 | 0.0213 |
| K⁷⁺ | 19 | 0.05302 | 0.22503 | 0.26884 | 0.71450 | 152.3396 | 154.88 | 0.0164 |
| Ca⁸⁺ | 20 | 0.05035 | 0.21308 | 0.25149 | 0.65725 | 186.3102 | 188.54 | 0.0118 |
| Sc⁹⁺ | 21 | 0.04794 | 0.20235 | 0.23625 | 0.60857 | 223.5713 | 225.18 | 0.0071 |
| Ti¹⁰⁺ | 22 | 0.04574 | 0.19264 | 0.22276 | 0.56666 | 264.1138 | 265.07 | 0.0036 |
| V¹¹⁺ | 23 | 0.04374 | 0.18383 | 0.21074 | 0.53022 | 307.9304 | 308.1 | 0.0006 |
| Cr¹²⁺ | 24 | 0.04191 | 0.17579 | 0.19995 | 0.49822 | 355.0157 | 354.8 | −0.0006 |
| Mn¹³⁺ | 25 | 0.04022 | 0.16842 | 0.19022 | 0.46990 | 405.3653 | 403.0 | −0.0059 |
| Fe¹⁴⁺ | 26 | 0.03867 | 0.16165 | 0.18140 | 0.44466 | 458.9758 | 457 | −0.0043 |
| Co¹⁵⁺ | 27 | 0.03723 | 0.15540 | 0.17336 | 0.42201 | 515.8442 | 511.96 | −0.0076 |
| Ni¹⁶⁺ | 28 | 0.03589 | 0.14961 | 0.16601 | 0.40158 | 575.9683 | 571.08 | −0.0086 |
| Cu¹⁷⁺ | 29 | 0.03465 | 0.14424 | 0.15926 | 0.38305 | 639.3460 | 633 | −0.0100 |
| Zn¹⁸⁺ | 30 | 0.03349 | 0.13925 | 0.15304 | 0.36617 | 705.9758 | 698 | −0.0114 |

^{a}Radius of the first set of paired inner electrons of twelve-electron atoms from Eq. (10.51) (Eq. (60)).
^{b}Radius of the second set of paired inner electrons of twelve-electron atoms from Eq. (10.62) (Eq. (60)).
^{c}Radius of three sets of paired inner electrons of twelve-electron atoms from Eq. (10.212)) (Eq. (64)).
^{d}Radius of paired outer electrons of twelve-electron atoms from Eq. (10.255)) (Eq. (60)) for Z > 12 and Eq. (10.246) for Mg.
^{e}Calculated ionization energies of twelve-electron atoms given by the electric energy (Eq. (10.256)) (Eq. (61)).
^{f}From theoretical calculations, interpolation of isoelectronic and spectral series, and experimental data [24-25].
^{g}(Experimental − theoretical)/experimental.

TABLE XIII
Ionization energies for some thirteen-electron atoms.

| | | | | | | | Theoretical | Experimental | |
|---|---|---|---|---|---|---|---|---|---|
| | | | | | | | Ionization | Ionization | |
| 13 e | | r₁ | r₃ | r₁₀ | r₁₂ | r₁₃ | Energies^{f} | Energies^{g} | Relative |
| Atom | Z | (a₀)^{a} | (a₀)^{b} | (a₀)^{c} | (a₀)^{d} | (a₀)^{e} | (eV) | (eV) | Error^{h} |
| Al | 13 | 0.07778 | 0.33923 | 0.45620 | 1.41133 | 2.28565 | 5.98402 | 5.98577 | 0.0003 |
| Si⁺ | 14 | 0.07216 | 0.31274 | 0.40978 | 1.25155 | 1.5995 | 17.0127 | 16.34585 | −0.0408 |
| P²⁺ | 15 | 0.06730 | 0.29010 | 0.37120 | 1.09443 | 1.3922 | 29.3195 | 30.2027 | 0.0292 |
| S³⁺ | 16 | 0.06306 | 0.27053 | 0.33902 | 0.96729 | 1.1991 | 45.3861 | 47.222 | 0.0389 |
| Cl⁴⁺ | 17 | 0.05932 | 0.25344 | 0.31190 | 0.86545 | 1.0473 | 64.9574 | 67.8 | 0.0419 |
| Ar⁵⁺ | 18 | 0.05599 | 0.23839 | 0.28878 | 0.78276 | 0.9282 | 87.9522 | 91.009 | 0.0336 |
| K⁶⁺ | 19 | 0.05302 | 0.22503 | 0.26884 | 0.71450 | 0.8330 | 114.3301 | 117.56 | 0.0275 |
| Ca⁷⁺ | 20 | 0.05035 | 0.21308 | 0.25149 | 0.65725 | 0.7555 | 144.0664 | 147.24 | 0.0216 |
| Sc⁸⁺ | 21 | 0.04794 | 0.20235 | 0.23625 | 0.60857 | 0.6913 | 177.1443 | 180.03 | 0.0160 |
| Ti⁹⁺ | 22 | 0.04574 | 0.19264 | 0.22276 | 0.56666 | 0.6371 | 213.5521 | 215.92 | 0.0110 |
| V¹⁰⁺ | 23 | 0.04374 | 0.18383 | 0.21074 | 0.53022 | 0.5909 | 253.2806 | 255.7 | 0.0095 |
| Cr¹¹⁺ | 24 | 0.04191 | 0.17579 | 0.19995 | 0.49822 | 0.5510 | 296.3231 | 298.0 | 0.0056 |
| Mn¹²⁺ | 25 | 0.04022 | 0.16842 | 0.19022 | 0.46990 | 0.5162 | 342.6741 | 343.6 | 0.0027 |
| Fe¹³⁺ | 26 | 0.03867 | 0.16165 | 0.18140 | 0.44466 | 0.4855 | 392.3293 | 392.2 | −0.0003 |
| Co¹⁴⁺ | 27 | 0.03723 | 0.15540 | 0.17336 | 0.42201 | 0.4583 | 445.2849 | 444 | −0.0029 |
| Ni¹⁵⁺ | 28 | 0.03589 | 0.14961 | 0.16601 | 0.40158 | 0.4341 | 501.5382 | 499 | −0.0051 |
| Cu¹⁶⁺ | 29 | 0.03465 | 0.14424 | 0.15926 | 0.38305 | 0.4122 | 561.0867 | 557 | −0.0073 |
| Zn¹⁷⁺ | 30 | 0.03349 | 0.13925 | 0.15304 | 0.36617 | 0.3925 | 623.9282 | 619 | −0.0080 |

^{a}Radius of the paired 1s inner electrons of thirteen-electron atoms from Eq. (10.51) (Eq. (60)).
^{b}Radius of the paired 2s inner electrons of thirteen-electron atoms from Eq. (10.62) (Eq. (60)).
^{c}Radius of the three sets of paired 2p inner electrons of thirteen-electron atoms from Eq. (10.212)) (Eq. (64)).
^{d}Radius of the paired 3s inner electrons of thirteen-electron atoms from Eq. (10.255)) (Eq. (60)).
^{e}Radius of the unpaired 3p outer electron of thirteen-electron atoms from Eq. (10.288) (Eq. (67)) for Z > 13 and Eq. (10.276) for Al.
^{f}Calculated ionization energies of thirteen-electron atoms given by the electric energy (Eq. (10.289)) (Eq. (61)) for Z > 13 and Eq. (10.279) for Al.
^{g}From theoretical calculations, interpolation of isoelectronic and spectral series, and experimental data [24-25].
^{h}(Experimental − theoretical)/experimental.

TABLE XIV
Ionization energies for some fourteen-electron atoms.

| | | | | | | | Theoretical | Experimental | |
|---|---|---|---|---|---|---|---|---|---|
| | | | | | | | Ionization | Ionization | |
| 14 e | | r₁ | r₃ | r₁₀ | r₁₂ | r₁₄ | Energies^{f} | Energies^{g} | Relative |
| Atom | Z | (a₀)^{a} | (a₀)^{b} | (a₀)^{c} | (a₀)^{d} | (a₀)^{e} | (eV) | (eV) | Error^{h} |
| Si | 14 | 0.07216 | 0.31274 | 0.40978 | 1.25155 | 1.67685 | 8.11391 | 8.15169 | 0.0046 |
| P⁺ | 15 | 0.06730 | 0.29010 | 0.37120 | 1.09443 | 1.35682 | 20.0555 | 19.7694 | −0.0145 |
| S²⁺ | 16 | 0.06306 | 0.27053 | 0.33902 | 0.96729 | 1.21534 | 33.5852 | 34.790 | 0.0346 |
| Cl³⁺ | 17 | 0.05932 | 0.25344 | 0.31190 | 0.86545 | 1.06623 | 51.0426 | 53.4652 | 0.0453 |
| Ar⁴⁺ | 18 | 0.05599 | 0.23839 | 0.28878 | 0.78276 | 0.94341 | 72.1094 | 75.020 | 0.0388 |
| K⁵⁺ | 19 | 0.05302 | 0.22503 | 0.26884 | 0.71450 | 0.84432 | 96.6876 | 99.4 | 0.0273 |
| Ca⁶⁺ | 20 | 0.05035 | 0.21308 | 0.25149 | 0.65725 | 0.76358 | 124.7293 | 127.2 | 0.0194 |
| Sc⁷⁺ | 21 | 0.04794 | 0.20235 | 0.23625 | 0.60857 | 0.69682 | 156.2056 | 158.1 | 0.0120 |
| Ti⁸⁺ | 22 | 0.04574 | 0.19264 | 0.22276 | 0.56666 | 0.64078 | 191.0973 | 192.10 | 0.0052 |
| V⁹⁺ | 23 | 0.04374 | 0.18383 | 0.21074 | 0.53022 | 0.59313 | 229.3905 | 230.5 | 0.0048 |
| Cr¹⁰⁺ | 24 | 0.04191 | 0.17579 | 0.19995 | 0.49822 | 0.55211 | 271.0748 | 270.8 | −0.0010 |
| Mn¹¹⁺ | 25 | 0.04022 | 0.16842 | 0.19022 | 0.46990 | 0.51644 | 316.1422 | 314.4 | −0.0055 |
| Fe¹²⁺ | 26 | 0.03867 | 0.16165 | 0.18140 | 0.44466 | 0.48514 | 364.5863 | 361 | −0.0099 |
| Co¹³⁺ | 27 | 0.03723 | 0.15540 | 0.17336 | 0.42201 | 0.45745 | 416.4021 | 411 | −0.0131 |
| Ni¹⁴⁺ | 28 | 0.03589 | 0.14961 | 0.16601 | 0.40158 | 0.43277 | 471.5854 | 464 | −0.0163 |
| Cu¹⁵⁺ | 29 | 0.03465 | 0.14424 | 0.15926 | 0.38305 | 0.41064 | 530.1326 | 520 | −0.0195 |
| Zn¹⁶⁺ | 30 | 0.03349 | 0.13925 | 0.15304 | 0.36617 | 0.39068 | 592.0410 | 579 | −0.0225 |

^{a}Radius of the paired 1s inner electrons of fourteen-electron atoms from Eq. (10.51) (Eq. (60)).
^{b}Radius of the paired 2s inner electrons of fourteen-electron atoms from Eq. (10.62) (Eq. (60)).
^{c}Radius of the three sets of paired 2p inner electrons of fourteen-electron atoms from Eq. (10.212)) (Eq. (64)).
^{d}Radius of the paired 3s inner electrons of fourteen-electron atoms from Eq. (10.255)) (Eq. (60)).
^{e}Radius of the two unpaired 3p outer electrons of fourteen-electron atoms from Eq. (10.309) (Eq. (67)) for Z > 14 and Eq. (10.297) for Si.
^{f}Calculated ionization energies of fourteen-electron atoms given by the electric energy (Eq. (10.310)) (Eq. (61)).
^{g}From theoretical calculations, interpolation of isoelectronic and spectral series, and experimental data [24-25].
^{h}(Experimental − theoretical)/experimental.

TABLE XV
Ionization energies for some fifteen-electron atoms.

| | | | | | | | Theoretical | Experimental | |
|---|---|---|---|---|---|---|---|---|---|
| | | | | | | | Ionization | Ionization | |
| 15 e | | r₁ | r₃ | r₁₀ | r₁₂ | r₁₅ | Energies^{f} | Energies^{g} | Relative |
| Atom | Z | (a₀)^{a} | (a₀)^{b} | (a₀)^{c} | (a₀)^{d} | (a₀)^{e} | (eV) | (eV) | Error^{h} |
| P | 15 | 0.06730 | 0.29010 | 0.37120 | 1.09443 | 1.28900 | 10.55536 | 10.48669 | −0.0065 |
| S⁺ | 16 | 0.06306 | 0.27053 | 0.33902 | 0.96729 | 1.15744 | 23.5102 | 23.3379 | −0.0074 |
| Cl²⁺ | 17 | 0.05932 | 0.25344 | 0.31190 | 0.86545 | 1.06759 | 38.2331 | 39.61 | 0.0348 |
| Ar³⁺ | 18 | 0.05599 | 0.23839 | 0.28878 | 0.78276 | 0.95423 | 57.0335 | 59.81 | 0.0464 |
| K⁴⁺ | 19 | 0.05302 | 0.22503 | 0.26884 | 0.71450 | 0.85555 | 79.5147 | 82.66 | 0.0381 |
| Ca⁵⁺ | 20 | 0.05035 | 0.21308 | 0.25149 | 0.65725 | 0.77337 | 105.5576 | 108.78 | 0.0296 |
| Sc⁶⁺ | 21 | 0.04794 | 0.20235 | 0.23625 | 0.60857 | 0.70494 | 135.1046 | 138.0 | 0.0210 |
| Ti⁷⁺ | 22 | 0.04574 | 0.19264 | 0.22276 | 0.56666 | 0.64743 | 168.1215 | 170.4 | 0.0134 |
| V⁸⁺ | 23 | 0.04374 | 0.18383 | 0.21074 | 0.53022 | 0.59854 | 204.5855 | 205.8 | 0.0059 |
| Cr⁹⁺ | 24 | 0.04191 | 0.17579 | 0.19995 | 0.49822 | 0.55652 | 244.4799 | 244.4 | −0.0003 |
| Mn¹⁰⁺ | 25 | 0.04022 | 0.16842 | 0.19022 | 0.46990 | 0.52004 | 287.7926 | 286.0 | −0.0063 |
| Fe¹¹⁺ | 26 | 0.03867 | 0.16165 | 0.18140 | 0.44466 | 0.48808 | 334.5138 | 330.8 | −0.0112 |
| Co¹²⁺ | 27 | 0.03723 | 0.15540 | 0.17336 | 0.42201 | 0.45985 | 384.6359 | 379 | −0.0149 |
| Ni¹³⁺ | 28 | 0.03589 | 0.14961 | 0.16601 | 0.40158 | 0.43474 | 438.1529 | 430 | −0.0190 |
| Cu¹⁴⁺ | 29 | 0.03465 | 0.14424 | 0.15926 | 0.38305 | 0.41225 | 495.0596 | 484 | −0.0229 |
| Zn¹⁵⁺ | 30 | 0.03349 | 0.13925 | 0.15304 | 0.36617 | 0.39199 | 555.3519 | 542 | −0.0246 |

^{a}Radius of the paired 1s inner electrons of fifteen-electron atoms from Eq. (10.51) (Eq. (60)).
^{b}Radius of the paired 2s inner electrons of fifteen-electron atoms from Eq. (10.62) (Eq. (60)).
^{c}Radius of the three sets of paired 2p inner electrons of fifteen-electron atoms from Eq. (10.212)) (Eq. (64)).
^{d}Radius of the paired 3s inner electrons of fifteen-electron atoms from Eq. (10.255)) (Eq. (60)).
^{e}Radius of the three unpaired 3p outer electrons of fifteen-electron atoms from Eq. (10.331) (Eq. (67)) for Z > 15 and Eq. (10.319) for P.
^{f}Calculated ionization energies of fifteen-electron atoms given by the electric energy (Eq. (10.332)) (Eq. (61)).
^{g}From theoretical calculations, interpolation of isoelectronic and spectral series, and experimental data [24-25].
^{h}(Experimental − theoretical)/experimental.

TABLE XVI
Ionization energies for some sixteen-electron atoms.

| | | | | | | | Theoretical | Experimental | |
|---|---|---|---|---|---|---|---|---|---|
| | | | | | | | Ionization | Ionization | |
| 16 e | | r₁ | r₃ | r₁₀ | r₁₂ | r₁₆ | Energies^{f} | Energies^{g} | Relative |
| Atom | Z | (a₀)^{a} | (a₀)^{b} | (a₀)^{c} | (a₀)^{d} | (a₀)^{e} | (eV) | (eV) | Error^{h} |
| S | 16 | 0.06306 | 0.27053 | 0.33902 | 0.96729 | 1.32010 | 10.30666 | 10.36001 | 0.0051 |
| Cl⁺ | 17 | 0.05932 | 0.25344 | 0.31190 | 0.86545 | 1.10676 | 24.5868 | 23.814 | −0.0324 |
| Ar²⁺ | 18 | 0.05599 | 0.23839 | 0.28878 | 0.78276 | 1.02543 | 39.8051 | 40.74 | 0.0229 |
| K³⁺ | 19 | 0.05302 | 0.22503 | 0.26884 | 0.71450 | 0.92041 | 59.1294 | 60.91 | 0.0292 |
| Ca⁴⁺ | 20 | 0.05035 | 0.21308 | 0.25149 | 0.65725 | 0.82819 | 82.1422 | 84.50 | 0.0279 |
| Sc⁵⁺ | 21 | 0.04794 | 0.20235 | 0.23625 | 0.60857 | 0.75090 | 108.7161 | 110.68 | 0.0177 |
| Ti⁶⁺ | 22 | 0.04574 | 0.19264 | 0.22276 | 0.56666 | 0.68622 | 138.7896 | 140.8 | 0.0143 |
| V⁷⁺ | 23 | 0.04374 | 0.18383 | 0.21074 | 0.53022 | 0.63163 | 172.3256 | 173.4 | 0.0062 |
| Cr⁸⁺ | 24 | 0.04191 | 0.17579 | 0.19995 | 0.49822 | 0.58506 | 209.2996 | 209.3 | 0.0000 |
| Mn⁹⁺ | 25 | 0.04022 | 0.16842 | 0.19022 | 0.46990 | 0.54490 | 249.6938 | 248.3 | −0.0056 |
| Fe¹⁰⁺ | 26 | 0.03867 | 0.16165 | 0.18140 | 0.44466 | 0.50994 | 293.4952 | 290.2 | −0.0114 |
| Co¹¹⁺ | 27 | 0.03723 | 0.15540 | 0.17336 | 0.42201 | 0.47923 | 340.6933 | 336 | −0.0140 |
| Ni¹²⁺ | 28 | 0.03589 | 0.14961 | 0.16601 | 0.40158 | 0.45204 | 391.2802 | 384 | −0.0190 |
| Cu¹³⁺ | 29 | 0.03465 | 0.14424 | 0.15926 | 0.38305 | 0.42781 | 445.2492 | 435 | −0.0236 |
| Zn¹⁴⁺ | 30 | 0.03349 | 0.13925 | 0.15304 | 0.36617 | 0.40607 | 502.5950 | 490 | −0.0257 |

^{a}Radius of the paired 1s inner electrons of sixteen-electron atoms from Eq. (10.51) (Eq. (60)).
^{b}Radius of the paired 2s inner electrons of sixteen-electron atoms from Eq. (10.62) (Eq. (60)).
^{c}Radius of the three sets of paired 2p inner electrons of sixteen-electron atoms from Eq. (10.212)) (Eq. (64)).
^{d}Radius of the paired 3s inner electrons of sixteen-electron atoms from Eq. (10.255)) (Eq. (60)).
^{e}Radius of the two paired and two unpaired 3p outer electrons of sixteen-electron atoms from Eq. (10.353) (Eq. (67)) for Z > 16 and Eq. (10.341) for S.
^{f}Calculated ionization energies of sixteen-electron atoms given by the electric energy (Eq. (10.354)) (Eq. (61)).
^{g}From theoretical calculations, interpolation of isoelectronic and spectral series, and experimental data [24-25].
^{h}(Experimental − theoretical)/experimental.

TABLE XVII
Ionization energies for some seventeen-electron atoms.

| | | | | | | | Theoretical | Experimental | |
|---|---|---|---|---|---|---|---|---|---|
| | | | | | | | Ionization | Ionization | |
| 17 e | | r₁ | r₃ | r₁₀ | r₁₂ | r₁₇ | Energies^{f} | Energies^{g} | Relative |
| Atom | Z | (a₀)^{a} | (a₀)^{b} | (a₀)^{c} | (a₀)^{d} | (a₀)^{e} | (eV) | (eV) | Error^{h} |
| Cl | 17 | 0.05932 | 0.25344 | 0.31190 | 0.86545 | 1.05158 | 12.93841 | 12.96764 | 0.0023 |
| Ar⁺ | 18 | 0.05599 | 0.23839 | 0.28878 | 0.78276 | 0.98541 | 27.6146 | 27.62967 | 0.0005 |
| K²⁺ | 19 | 0.05302 | 0.22503 | 0.26884 | 0.71450 | 0.93190 | 43.8001 | 45.806 | 0.0438 |
| Ca³⁺ | 20 | 0.05035 | 0.21308 | 0.25149 | 0.65725 | 0.84781 | 64.1927 | 67.27 | 0.0457 |
| Sc⁴⁺ | 21 | 0.04794 | 0.20235 | 0.23625 | 0.60857 | 0.77036 | 88.3080 | 91.65 | 0.0365 |
| Ti⁵⁺ | 22 | 0.04574 | 0.19264 | 0.22276 | 0.56666 | 0.70374 | 116.0008 | 119.53 | 0.0295 |
| V⁶⁺ | 23 | 0.04374 | 0.18383 | 0.21074 | 0.53022 | 0.64701 | 147.2011 | 150.6 | 0.0226 |
| Cr⁷⁺ | 24 | 0.04191 | 0.17579 | 0.19995 | 0.49822 | 0.59849 | 181.8674 | 184.7 | 0.0153 |
| Mn⁸⁺ | 25 | 0.04022 | 0.16842 | 0.19022 | 0.46990 | 0.55667 | 219.9718 | 221.8 | 0.0082 |
| Fe⁹⁺ | 26 | 0.03867 | 0.16165 | 0.18140 | 0.44466 | 0.52031 | 261.4942 | 262.1 | 0.0023 |
| Co¹⁰⁺ | 27 | 0.03723 | 0.15540 | 0.17336 | 0.42201 | 0.48843 | 306.4195 | 305 | −0.0047 |
| Ni¹¹⁺ | 28 | 0.03589 | 0.14961 | 0.16601 | 0.40158 | 0.46026 | 354.7360 | 352 | −0.0078 |
| Cu¹²⁺ | 29 | 0.03465 | 0.14424 | 0.15926 | 0.38305 | 0.43519 | 406.4345 | 401 | −0.0136 |
| Zn¹³⁺ | 30 | 0.03349 | 0.13925 | 0.15304 | 0.36617 | 0.41274 | 461.5074 | 454 | −0.0165 |

^{a}Radius of the paired 1s inner electrons of seventeen-electron atoms from Eq. (10.51) (Eq. (60)).
^{b}Radius of the paired 2s inner electrons of seventeen-electron atoms from Eq. (10.62) (Eq. (60)).
^{c}Radius of the three sets of paired 2p inner electrons of seventeen-electron atoms from Eq. (10.212)) (Eq. (64)).
^{d}Radius of the paired 3s inner electrons of seventeen-electron atoms from Eq. (10.255)) (Eq. (60)).
^{e}Radius of the two sets of paired and an unpaired 3p outer electron of seventeen-electron atoms from Eq. (10.376) (Eq. (67)) for Z > 17 and Eq. (10.363) for Cl.
^{f}Calculated ionization energies of seventeen-electron atoms given by the electric energy (Eq. (10.377)) (Eq. (61)).
^{g}From theoretical calculations, interpolation of isoelectronic and spectral series, and experimental data [24-25].
^{h}(Experimental − theoretical)/experimental.

TABLE XVIII
Ionization energies for some eighteen-electron atoms.

| | | | | | | | Theoretical | Experimental | |
|---|---|---|---|---|---|---|---|---|---|
| | | | | | | | Ionization | Ionization | |
| 18 e | | r₁ | r₃ | r₁₀ | r₁₂ | r₁₈ | Energies^{f} | Energies^{g} | Relative |
| Atom | Z | (a₀)^{a} | (a₀)^{b} | (a₀)^{c} | (a₀)^{d} | (a₀)^{e} | (eV) | (eV) | Error^{h} |
| Ar | 18 | 0.05599 | 0.23839 | 0.28878 | 0.78276 | 0.86680 | 15.69651 | 15.75962 | 0.0040 |
| K⁺ | 19 | 0.05302 | 0.22503 | 0.26884 | 0.71450 | 0.85215 | 31.9330 | 31.63 | −0.0096 |
| Ca²⁺ | 20 | 0.05035 | 0.21308 | 0.25149 | 0.65725 | 0.82478 | 49.4886 | 50.9131 | 0.0280 |
| Sc³⁺ | 21 | 0.04794 | 0.20235 | 0.23625 | 0.60857 | 0.76196 | 71.4251 | 73.4894 | 0.0281 |
| Ti⁴⁺ | 22 | 0.04574 | 0.19264 | 0.22276 | 0.56666 | 0.70013 | 97.1660 | 99.30 | 0.0215 |
| V⁵⁺ | 23 | 0.04374 | 0.18383 | 0.21074 | 0.53022 | 0.64511 | 126.5449 | 128.13 | 0.0124 |
| Cr⁶⁺ | 24 | 0.04191 | 0.17579 | 0.19995 | 0.49822 | 0.59718 | 159.4836 | 160.18 | 0.0043 |
| Mn⁷⁺ | 25 | 0.04022 | 0.16842 | 0.19022 | 0.46990 | 0.55552 | 195.9359 | 194.5 | −0.0074 |
| Fe⁸⁺ | 26 | 0.03867 | 0.16165 | 0.18140 | 0.44466 | 0.51915 | 235.8711 | 233.6 | −0.0097 |
| Co⁹⁺ | 27 | 0.03723 | 0.15540 | 0.17336 | 0.42201 | 0.48720 | 279.2670 | 275.4 | −0.0140 |
| Ni¹⁰⁺ | 28 | 0.03589 | 0.14961 | 0.16601 | 0.40158 | 0.45894 | 326.1070 | 321.0 | −0.0159 |
| Cu¹¹⁺ | 29 | 0.03465 | 0.14424 | 0.15926 | 0.38305 | 0.43379 | 376.3783 | 369 | −0.0200 |
| Zn¹²⁺ | 30 | 0.03349 | 0.13925 | 0.15304 | 0.36617 | 0.41127 | 430.0704 | 419.7 | −0.0247 |

^{a}Radius of the paired 1s inner electrons of eighteen-electron atoms from Eq. (10.51) (Eq. (60)).
^{b}Radius of the paired 2s inner electrons of eighteen-electron atoms from Eq. (10.62) (Eq. (60)).
^{c}Radius of the three sets of paired 2p inner electrons of eighteen-electron atoms from Eq. (10.212)) (Eq. (64)).
^{d}Radius of the paired 3s inner electrons of eighteen-electron atoms from Eq. (10.255)) (Eq. (60)).
^{e}Radius of the three sets of paired 3p outer electrons of eighteen-electron atoms from Eq. (10.399) (Eq. (67)) for Z > 18 and Eq. (10.386) for Ar.
^{f}Calculated ionization energies of eighteen-electron atoms given by the electric energy (Eq. (10.400)) (Eq. (61)).
^{g}From theoretical calculations, interpolation of isoelectronic and spectral series, and experimental data [24-25].
^{h}(Experimental − theoretical)/experimental.

TABLE XIX
Ionization energies for some nineteen-electron atoms.

| | | | | | | | | Theoretical | Experimental | |
|---|---|---|---|---|---|---|---|---|---|---|
| | | | | | | | | Ionization | Ionization | |
| 19 e | | r₁ | r₃ | r₁₀ | r₁₂ | r₁₈ | r₁₉ | Energies^{g} | Energies^{h} | Relative |
| Atom | Z | (a₀)^{a} | (a₀)^{b} | (a₀)^{c} | (a₀)^{d} | (a₀)^{e} | (a₀)^{f} | (eV) | (eV) | Errorⁱ |
| K | 19 | 0.05302 | 0.22503 | 0.26884 | 0.71450 | 0.85215 | 3.14515 | 4.32596 | 4.34066 | 0.0034 |
| Ca⁺ | 20 | 0.05035 | 0.21308 | 0.25149 | 0.65725 | 0.82478 | 2.40060 | 11.3354 | 11.87172 | 0.0452 |
| Sc²⁺ | 21 | 0.04794 | 0.20235 | 0.23625 | 0.60857 | 0.76196 | 1.65261 | 24.6988 | 24.75666 | 0.0023 |
| Ti³⁺ | 22 | 0.04574 | 0.19264 | 0.22276 | 0.56666 | 0.70013 | 1.29998 | 41.8647 | 43.2672 | 0.0324 |
| V⁴⁺ | 23 | 0.04374 | 0.18383 | 0.21074 | 0.53022 | 0.64511 | 1.08245 | 62.8474 | 65.2817 | 0.0373 |
| Cr⁵⁺ | 24 | 0.04191 | 0.17579 | 0.19995 | 0.49822 | 0.59718 | 0.93156 | 87.6329 | 90.6349 | 0.0331 |
| Mn⁶⁺ | 25 | 0.04022 | 0.16842 | 0.19022 | 0.46990 | 0.55552 | 0.81957 | 116.2076 | 119.203 | 0.0251 |
| Fe⁷⁺ | 26 | 0.03867 | 0.16165 | 0.18140 | 0.44466 | 0.51915 | 0.73267 | 148.5612 | 151.06 | 0.0165 |
| Co⁸⁺ | 27 | 0.03723 | 0.15540 | 0.17336 | 0.42201 | 0.48720 | 0.66303 | 184.6863 | 186.13 | 0.0078 |
| Ni⁹⁺ | 28 | 0.03589 | 0.14961 | 0.16601 | 0.40158 | 0.45894 | 0.60584 | 224.5772 | 224.6 | 0.0001 |
| Cu¹⁰⁺ | 29 | 0.03465 | 0.14424 | 0.15926 | 0.38305 | 0.43379 | 0.55797 | 268.2300 | 265.3 | −0.0110 |
| Zn¹¹⁺ | 30 | 0.03349 | 0.13925 | 0.15304 | 0.36617 | 0.41127 | 0.51726 | 315.6418 | 310.8 | −0.0156 |

^{a}Radius of the paired 1s inner electrons of nineteen-electron atoms from Eq. (10.51) (Eq. (60)).
^{b}Radius of the paired 2s inner electrons of nineteen-electron atoms from Eq. (10.62) (Eq. (60)).
^{c}Radius of the three sets of paired 2p inner electrons of nineteen-electron atoms from Eq. (10.212)) (Eq. (64)).
^{d}Radius of the paired 3s inner electrons of nineteen-electron atoms from Eq. (10.255)) (Eq. (60)).
^{e}Radius of the three sets of paired 3p inner electrons of nineteen-electron atoms from Eq. (10.399) (Eq. (67)).
^{f}Radius of the unpaired 4s outer electron of nineteen-electron atoms from Eq. (10.425) (Eq. (60)) for Z > 19 and Eq. (10.414) for K.
^{g}Calculated ionization energies of nineteen-electron atoms given by the electric energy (Eq. (10.426)) (Eq. (61)).
^{h}From theoretical calculations, interpolation of isoelectronic and spectral series, and experimental data [24-25].
ⁱ(Experimental − theoretical)/experimental.

TABLE XX
Ionization energies for some twenty-electron atoms.

| | | | | | | | | Theoretical | Experimental | |
|---|---|---|---|---|---|---|---|---|---|---|
| | | | | | | | | Ionization | Ionization | |
| 20 e | | r₁ | r₃ | r₁₀ | r₁₂ | r₁₈ | r₂₀ | Energies^{g} | Energies^{h} | Relative |
| Atom | Z | (a₀)^{a} | (a₀)^{b} | (a₀)^{c} | (a₀)^{d} | (a₀)^{e} | (a₀)^{f} | (eV) | (eV) | Errorⁱ |
| Ca | 20 | 0.05035 | 0.21308 | 0.25149 | 0.65725 | 0.82478 | 2.23009 | 6.10101 | 6.11316 | 0.0020 |
| Sc⁺ | 21 | 0.04794 | 0.20235 | 0.23625 | 0.60857 | 0.76196 | 2.04869 | 13.2824 | 12.79967 | −0.0377 |
| Ti²⁺ | 22 | 0.04574 | 0.19264 | 0.22276 | 0.56666 | 0.70013 | 1.48579 | 27.4719 | 27.4917 | 0.0007 |
| V³⁺ | 23 | 0.04374 | 0.18383 | 0.21074 | 0.53022 | 0.64511 | 1.19100 | 45.6956 | 46.709 | 0.0217 |
| Cr⁴⁺ | 24 | 0.04191 | 0.17579 | 0.19995 | 0.49822 | 0.59718 | 1.00220 | 67.8794 | 69.46 | 0.0228 |
| Mn⁵⁺ | 25 | 0.04022 | 0.16842 | 0.19022 | 0.46990 | 0.55552 | 0.86867 | 93.9766 | 95.6 | 0.0170 |
| Fe⁶⁺ | 26 | 0.03867 | 0.16165 | 0.18140 | 0.44466 | 0.51915 | 0.76834 | 123.9571 | 124.98 | 0.0082 |
| Co⁷⁺ | 27 | 0.03723 | 0.15540 | 0.17336 | 0.42201 | 0.48720 | 0.68977 | 157.8012 | 157.8 | 0.0000 |
| Ni⁸⁺ | 28 | 0.03589 | 0.14961 | 0.16601 | 0.40158 | 0.45894 | 0.62637 | 195.4954 | 193 | −0.0129 |
| Cu⁹⁺ | 29 | 0.03465 | 0.14424 | 0.15926 | 0.38305 | 0.43379 | 0.57401 | 237.0301 | 232 | −0.0217 |
| Zn¹⁰⁺ | 30 | 0.03349 | 0.13925 | 0.15304 | 0.36617 | 0.41127 | 0.52997 | 282.3982 | 274 | −0.0307 |

^{a}Radius of the paired 1s inner electrons of twenty-electron atoms from Eq. (10.51) (Eq. (60)).
^{b}Radius of the paired 2s inner electrons of twenty-electron atoms from Eq. (10.62) (Eq. (60)).
^{c}Radius of the three sets of paired 2p inner electrons of twenty-electron atoms from Eq. (10.212)) (Eq. (64)).
^{d}Radius of the paired 3s inner electrons of twenty-electron atoms from Eq. (10.255)) (Eq. (60)).
^{e}Radius of the three sets of paired 3p inner electrons of twenty-electron atoms from Eq. (10.399) (Eq. (67)).
^{f}Radius of the paired 4s outer electrons of twenty-electron atoms from Eq. (10.445) (Eq. (60)) for Z > 20 and Eq. (10.436) for Ca.
^{g}Calculated ionization energies of twenty-electron atoms given by the electric energy (Eq. (10.446)) (Eq. (61)).
^{h}From theoretical calculations, interpolation of isoelectronic and spectral series, and experimental data [24-25].
ⁱ(Experimental − theoretical)/experimental.

### General Equation for the Ionization Energies of Atoms Having an Outer S-Shell

The derivation of the radii and energies of the 1 s, 2s, 3s, and 4s electrons is given in the One-Electron Atom, the Two-Electron Atom, the Three-Electron Atoms, the Four-Electron Atoms, the Eleven-Electron Atoms, the Twelve-Electron Atoms, the Nineteen-Electron Atoms, and the Twenty-Electron Atoms sections of Ref. [4]. (Reference to equations of the form Eq. (1.number), Eq. (7.number), and Eq. (10.number) will refer to the corresponding equations of Ref. [4].) The general equation for the radii of s electrons is given by

$${r}_{n} = \frac{\begin{matrix}\frac{{a}_{0} ( 1 + ( C - D ) \frac{\sqrt{3}}{2 Z} )}{( ( Z - ( n - 1 ) ) - ( \frac{A}{8} - \frac{B}{2 Z} ) \frac{\sqrt{3}}{{r}_{m}} )} \pm \\ {a}_{0} \sqrt{\begin{matrix}{( \frac{( 1 + ( C - D ) \frac{\sqrt{3}}{2 Z} )}{( ( Z - ( n - 1 ) ) - ( \frac{A}{8} - \frac{B}{2 Z} ) \frac{\sqrt{3}}{{r}_{m}} )} )}^{2} + \\ \frac{20 \sqrt{3} ( [ \frac{Z - n}{Z - ( n - 1 )} ] {Er}_{m} )}{( ( Z - ( n - 1 ) ) - ( \frac{A}{8} - \frac{B}{2 Z} ) \frac{\sqrt{3}}{{r}_{m}} )}\end{matrix}}\end{matrix}}{2} \\ {r}_{m} in units of {a}_{0} \qquad ( 60 )$$

where Z is the nuclear charge, n is the number of electrons, rₘ is the radius of the proceeding filled shell(s) given by Eq. (60) for the preceding s shell(s), Eq. (64) for the 2p shell, and Eq. (69) for the 3p shell, the parameter A given in TABLE XXI corresponds to the diamagnetic force, F_{diamagnetic}, (Eq. (10.11)), the parameter B given in TABLE XXI corresponds to the paramagnetic force, F_{mag 2} (Eq. (10.55)), the parameter C given in TABLE XXI corresponds to the diamagnetic force, F_{diamagnetic 3}, (Eq. (10.221)), the parameter D given in TABLE XXI corresponds to the paramagnetic force, F_{mag}, (Eq. (7.15)), and the parameter E given in TABLE XXI corresponds to the diamagnetic force, F_{diamagnetic 2}, due to a relativistic effect with an electric field for r>rₙ (Eqs. (10.35), (10.229), and (10.418)). The positive root of Eq. (60) must be taken in order that rₙ>0. The radii of several n-electron atoms having an outer s shell are given in TABLES I-IV, XI-XII, XIX and XX.

The ionization energy for atoms having an outer s-shell are given by the negative of the electric energy, E(electric), (Eq. (10.102) with the radii, rₙ, given by Eq. (60) and Eq. (10.447)):

$$E ( Ionization ) = - Electric Energy = \frac{( Z - ( n - 1 ) ) {e}^{2}}{8 {πɛ}_{o} {r}_{n}} \qquad ( 61 )$$

except that minor corrections due to the magnetic energy must be included in cases wherein the s electron does not couple to p electrons as given in Eqs. (7.28), (7.47), (10.25), (10.48), (10.66), and (10.68). Since the relativistic corrections were small except for one, two, and three-electron atoms, the nonrelativistic ionization energies for experimentally measured n-electron, s-filling atoms are given in most cases by Eqs. (60) and (61). The ionization energies of several n-electron atoms having an outer s shell are given in TABLES l-IV, XI-XII, XIX and XX.

TABLE XXI
Summary of the parameters of atoms filling the 1s, 2s, 3s, and 4s orbitals.

| | | | Orbital | Diamag. | Paramag. | Diamag. | Paramag. | Diamag. |
|---|---|---|---|---|---|---|---|---|
| | | Ground | Arrangement | Force | Force | Force | Force | Force |
| Atom | Electron | State | of s Electrons | Factor | Factor | Factor | Factor | Factor |
| Type | Configuration | Term^{a} | (s state) | A^{b} | B^{c} | C^{d} | D^{e} | E^{f} |
| Neutral 1 e Atom H | 1s¹ | ²S_{1/2} | $\frac{↑}{1 s}$ | 0 | 0 | 0 | 0 | 0 |
| Neutral 2 e Atom He | 1s² | ¹S₀ | $\frac{↑ ↓}{1 s}$ | 0 | 0 | 0 | 1 | 0 |
| Neutral 3 e Atom Li | 2s¹ | ²S_{1/2} | $\frac{↑}{2 s}$ | 1 | 0 | 0 | 0 | 0 |
| Neutral 4 e Atom Be | 2s² | ¹S₀ | $\frac{↑ ↓}{2 s}$ | 1 | 0 | 0 | 1 | 0 |
| Neutral 11 e Atom Na | 1s²2s²2p⁶3s¹ | ²S_{1/2} | $\frac{↑}{3 s}$ | 1 | 0 | 8 | 0 | 0 |
| Neutral 12 e Atom Mg | 1s²2s²2p⁶3s² | ¹S₀ | $\frac{↑ ↓}{3 s}$ | 1 | 3 | 12 | 1 | 0 |
| Neutral 19 e Atom K | 1s²2s²2p⁶3s²3p⁶4s¹ | ²S_{1/2} | $\frac{↑}{4 s}$ | 2 | 0 | 12 | 0 | 0 |
| Neutral 20 e Atom Ca | 1s²2s²2p⁶3s²3p⁶4s² | ¹S₀ | $\frac{↑ ↓}{4 s}$ | 1 | 3 | 24 | 1 | 0 |
| 1 e Ion | 1s¹ | ²S_{1/2} | $\frac{↑}{1 s}$ | 0 | 0 | 0 | 0 | 0 |
| 2 e Ion | 1s² | ¹S₀ | $\frac{↑ ↓}{1 s}$ | 0 | 0 | 0 | 1 | 0 |
| 3 e Ion | 2s¹ | ²S_{1/2} | $\frac{↑}{2 s}$ | 1 | 0 | 0 | 0 | 1 |
| 4 e Ion | 2s² | ¹S₀ | $\frac{↑ ↓}{2 s}$ | 1 | 0 | 0 | 1 | 1 |
| 11 e Ion | 1s²2s²2p⁶3s¹ | ²S_{1/2} | $\frac{↑}{3 s}$ | 1 | 4 | 8 | 0 | $1 + \frac{\sqrt{2}}{2}$ |
| 12 e Ion | 1s²2s²2p⁶3s² | ¹S₀ | $\frac{↑ ↓}{3 s}$ | 1 | 6 | 0 | 0 | $1 + \frac{\sqrt{2}}{2}$ |
| 19 e Ion | 1s²2s²2p⁶3s²3p⁶4s¹ | ²S_{1/2} | $\frac{↑}{4 s}$ | 3 | 0 | 24 | 0 | 2 − \sqrt{2} |
| 20 e Ion | 1s²2s²2p⁶3s²3p⁶4s¹ | ¹S₀ | $\frac{↑ ↓}{4 s}$ | 2 | 0 | 24 | 0 | 2 − \sqrt{2} |

^{a}The theoretical ground state terms match those given by NIST [26].
^{b}Eq. (10.11).
^{c}Eq. (10.55).
^{d}Eq. (10.221).
^{e}Eq. (7.15).
^{f}Eqs. (10.35), (10.229), and (10.418).

### General Equation for the Ionization Energies of Five Through Ten-Electron Atoms

The derivation of the radii and energies of the 2p electrons is given in the Five through Eight-Electron Atoms sections of Ref. [4]. Using the forces given by Eqs. (58) (Eq. (10.70)), (10.82-10.84), (10.89), (10.93), and the radii r₃ given by Eq. (10.62) (from Eq. (60)), the radii of the 2p electrons of all five through ten-electron atoms may be solved exactly. The electric energy given by Eq. (61) (Eq. (10.102)) gives the corresponding exact ionization energies. A summary of the parameters of the equations that determine the exact radii and ionization energies of all five through ten-electron atoms is given in TABLE XXII.

TABLE XXII
Summary of the parameters of five through ten-electron atoms.

| | | | Orbital | Diamagnetic | Paramagnetic |
|---|---|---|---|---|---|
| | | Ground | Arrangement of | Force | Force |
| | Electron | State | 2p Electrons | Factor | Factor |
| Atom Type | Configuration | Term^{a} | (2p state) | A^{b} | B^{c} |
| Neutral 5 e Atom B | 1s²2s²2p¹ | ²P_{1/2}⁰ | $\frac{↑}{1} \frac{ }{0} \frac{ }{- 1}$ | 2 | 0 |
| Neutral 6 e Atom C | 1s²2s²2p² | ³P₀ | $\frac{↑}{1} \frac{↑}{0} \frac{ }{- 1}$ | $\frac{2}{3}$ | 0 |
| Neutral 7 e Atom N | 1s²2s²2p³ | ⁴S_{3/2}⁰ | $\frac{↑}{1} \frac{↑}{0} \frac{↑}{- 1}$ | $\frac{1}{3}$ | 1 |
| Neutral 8 e Atom O | 1s²2s²2p⁴ | ³P₂ | $\frac{↑ ↓}{1} \frac{↑}{0} \frac{↑}{- 1}$ | 1 | 2 |
| Neutral 9 e Atom F | 1s²2s²2p⁵ | ²P_{3/2}⁰ | $\frac{↑ ↓}{1} \frac{↑ ↓}{0} \frac{↑}{- 1}$ | $\frac{2}{3}$ | 3 |
| Neutral 10 e Atom Ne | 1s²2s²2p⁶ | ¹S₀ | $\frac{↑ ↓}{1} \frac{↑ ↓}{0} \frac{↑ ↓}{- 1}$ | 0 | 3 |
| 5 e Ion | 1s²2s²2p¹ | ²P_{1/2}⁰ | $\frac{↑}{1} \frac{ }{0} \frac{ }{- 1}$ | $\frac{5}{3}$ | 1 |
| 6 e Ion | 1s²2s²2p² | ³P₀ | $\frac{↑}{1} \frac{↑}{0} \frac{ }{- 1}$ | $\frac{5}{3}$ | 4 |
| 7 e Ion | 1s²2s²2p³ | ⁴S_{3/2}⁰ | $\frac{↑}{1} \frac{↑}{0} \frac{↑}{- 1}$ | $\frac{5}{3}$ | 6 |
| 8 e Ion | 1s²2s²2p⁴ | ³P₂ | $\frac{↑ ↓}{1} \frac{↑}{0} \frac{↑}{- 1}$ | $\frac{5}{3}$ | 6 |
| 9 e Ion | 1s²2s²2p⁵ | ²P_{3/2}⁰ | $\frac{↑ ↓}{1} \frac{↑ ↓}{0} \frac{↑}{- 1}$ | $\frac{5}{3}$ | 9 |
| 10 e Ion | 1s²2s²2p⁶ | ¹S₀ | $\frac{↑ ↓}{1} \frac{↑ ↓}{0} \frac{↑ ↓}{- 1}$ | $\frac{5}{3}$ | 12 |

^{a}The theoretical ground state terms match those given by NIST [26].
^{b}Eq. (10.82).
^{c}Eqs. (10.83-10.84) and (10.89).

Fₑₗₑ and F_{diamagnetic 2} given by Eqs. (58) (Eq. (10.70)) and (10.93), respectively, are of the same form for all atoms with the appropriate nuclear charges and atomic radii. F_{diamagnetic} given by Eq. (10.82) and F_{mag 2} given by Eqs. (10.83-10.84) and (10.89) are of the same form with the appropriate factors that depend on the electron configuration wherein the electron configuration given in TABLE XXII must be a minimum of energy.

For each n-electron atom having a central charge of Z times that of the proton and an electron configuration 1s²2s²2pⁿ⁻⁴, there are two indistinguishable spin-paired electrons in an orbitsphere with radii r₁ and r₂ both given by Eqs. (7.19) and (10.51) (from Eq. (60)):

$${r}_{1} = {r}_{2} = {α}_{o} [ \frac{1}{Z - 1} - \frac{\sqrt{\frac{3}{4}}}{Z ( Z - 1 )} ] \qquad ( 62 )$$

two indistinguishable spin-paired electrons in an orbitsphere with radii r₃ and r₄ both given by Eq. (10.62) (from Eq. (60)):

$${r}_{4} = {r}_{3} = \frac{( \begin{matrix}\frac{{a}_{0} ( 1 - \frac{\sqrt{\frac{3}{4}}}{Z} )}{( ( Z - 3 ) - ( \frac{1}{4} - \frac{1}{Z} ) \frac{\sqrt{\frac{3}{4}}}{{r}_{1}} )} \pm \\ {a}_{o} \sqrt{\begin{matrix}\frac{{( 1 - \frac{\sqrt{\frac{3}{4}}}{Z} )}^{2}}{{( ( Z - 3 ) - ( \frac{1}{4} - \frac{1}{Z} ) \frac{\sqrt{\frac{3}{4}}}{{r}_{1}} )}^{2}} + \\ 4 \frac{[ \frac{Z - 3}{Z - 2} ] {r}_{1} 10 \sqrt{\frac{3}{4}}}{( ( Z - 3 ) - ( \frac{1}{4} - \frac{1}{Z} ) \frac{\sqrt{\frac{3}{4}}}{{r}_{1}} )}\end{matrix}}\end{matrix} )}{2} \\ {r}_{1} in units of {a}_{o} \qquad ( 63 )$$

where r₁ is given by Eq. (62), and n−4 electrons in an orbitsphere with radius rₙ given by

$${r}_{n} = \frac{\frac{{a}_{0}}{( \begin{matrix}( Z - ( n - 1 ) ) - \\ ( \frac{A}{8} - \frac{B}{2 Z} ) \frac{\sqrt{3}}{{r}_{3}}\end{matrix} )} \pm {a}_{0} \sqrt{\begin{matrix}{( \frac{1}{( \begin{matrix}( Z - ( n - 1 ) ) - \\ ( \frac{A}{8} - \frac{B}{2 Z} ) \frac{\sqrt{3}}{{r}_{3}}\end{matrix} )} )}^{2} + \\ \frac{20 \sqrt{3} ( [ \frac{Z - n}{Z - ( n - 1 )} ] ( 1 - \frac{\sqrt{2}}{2} ) {r}_{3} )}{( ( Z - ( n - 1 ) ) - ( \frac{A}{8} - \frac{B}{2 Z} ) \frac{\sqrt{3}}{{r}_{3}} )}\end{matrix}}}{2} \\ {r}_{3} in units of {a}_{0} \qquad ( 64 )$$

where r₃ is given by Eq. (63), the parameter A given in TABLE XXII corresponds to the diamagnetic force, F_{diamagnetic}, (Eq. (10.82)), and the parameter B given in TABLE XXII corresponds to the paramagnetic force, F_{mag 2} (Eqs. (10.83-10.84) and (10.89)). The positive root of Eq. (64) must be taken in order that rₙ>0. The radii of several n-electron atoms are given in TABLES V-X.

The ionization energy for the boron atom is given by Eq. (10.104). The ionization energies for the n-electron atoms are given by the negative of the electric energy, E(electric), (Eq. (61) with the radii, rₙ, given by Eq. (64)). Since the relativistic corrections were small, the nonrelativistic ionization energies for experimentally measured n-electron atoms are given by Eqs. (61) and (64) in TABLES V-X.

### General Equation for the Ionization Energies of Thirteen Through Eighteen-Electron Atoms

The derivation of the radii and energies of the 3p electrons is given in the Thirteen through Eighteen-Electron Atoms sections of Ref. [4]. Using the forces given by Eqs. (58) (Eq. (10.257)), (10.258-10.264), (10.268), and the radii r₁₂ given by Eq. (10.255) (from Eq. (60)), the radii of the 3p electrons of all thirteen through eighteen-electron atoms may be solved exactly. The electric energy given by Eq. (61) (Eq. (10.102)) gives the corresponding exact ionization energies. A summary of the parameters of the equations that determine the exact radii and ionization energies of all thirteen through eighteen-electron atoms is given in TABLES XIII-XVIII.

Fₑₗₑ and F_{diamagnetic 2} given by Eqs. (58) (Eq. (10.257)) and (10.268), respectively, are of the same form for all atoms with the appropriate nuclear charges and atomic radii. F_{diamagnetic} given by Eq. (10.258) and F_{mag 2} given by Eqs. (10.259-10.264) are of the same form with the appropriate factors that depend on the electron configuration given in TABLE XXIII wherein the electron configuration must be a minimum of energy.

TABLE XXIII
Summary of the parameters of thirteen through eighteen-electron atoms.

| | | | Orbital | Diamagnetic | Paramagnetic |
|---|---|---|---|---|---|
| | | Ground | Arrangement of | Force | Force |
| | Electron | State | 3p Electrons | Factor | Factor |
| Atom Type | Configuration | Term^{a} | (3p state) | A^{b} | B^{c} |
| Neutral 13 e Atom Al | 1s²2s²2p⁶3s²3p¹ | ²P_{1/2}⁰ | $\frac{↑}{1} \frac{ }{0} \frac{ }{- 1}$ | $\frac{11}{3}$ | 0 |
| Neutral 14 e Atom Si | 1s²2s²2p⁶3s²3p² | ³P₀ | $\frac{↑}{1} \frac{↑}{0} \frac{ }{- 1}$ | $\frac{7}{3}$ | 0 |
| Neutral 15 e Atom P | 1s²2s²2p⁶3s²3p³ | ⁴S_{3/2}⁰ | $\frac{↑}{1} \frac{↑}{0} \frac{↑}{- 1}$ | $\frac{5}{3}$ | 2 |
| Neutral 16 e Atom S | 1s²2s²2p⁶3s²3p⁴ | ³P₂ | $\frac{↑ ↓}{1} \frac{↑}{0} \frac{↑}{- 1}$ | $\frac{4}{3}$ | 1 |
| Neutral 17 e Atom Cl | 1s²2s²2p⁶3s²3p⁵ | ²P_{3/2}⁰ | $\frac{↑ ↓}{1} \frac{↑ ↓}{0} \frac{↑}{- 1}$ | $\frac{2}{3}$ | 2 |
| Neutral 18 e Atom Ar | 1s²2s²2p⁶3s²3p⁶ | ¹S₀ | $\frac{↑ ↓}{1} \frac{↑ ↓}{0} \frac{↑ ↓}{- 1}$ | $\frac{1}{3}$ | 4 |
| 13 e Ion | 1s²2s²2p⁶3s²3p¹ | ²P_{1/2}⁰ | $\frac{↑}{1} \frac{ }{0} \frac{ }{- 1}$ | $\frac{5}{3}$ | 12 |
| 14 e Ion | 1s²2s²2p⁶3s²3p² | ³P₀ | $\frac{↑}{1} \frac{↑}{0} \frac{ }{- 1}$ | $\frac{1}{3}$ | 16 |
| 15 e Ion | 1s²2s²2p⁶3s²3p³ | ⁴S_{3/2}⁰ | $\frac{↑}{1} \frac{↑}{0} \frac{↑}{- 1}$ | 0 | 24 |
| 16 e Ion | 1s²2s²2p⁶3s²3p⁴ | ³P₂ | $\frac{↑ ↓}{1} \frac{↑}{0} \frac{↑}{- 1}$ | $\frac{1}{3}$ | 24 |
| 17 e Ion | 1s²2s²2p⁶3s²3p⁵ | ²P_{3/2}⁰ | $\frac{↑ ↓}{1} \frac{↑ ↓}{0} \frac{↑}{- 1}$ | $\frac{2}{3}$ | 32 |
| 18 e Ion | 1s²2s²2p⁶3s²3p⁶ | ¹S₀ | $\frac{↑ ↓}{1} \frac{↑ ↓}{0} \frac{↑ ↓}{- 1}$ | 0 | 40 |

^{a}The theoretical ground state terms match those given by NIST [26].
^{b}Eq. (10.258).
^{c}Eqs. (10.260-10.264).

For each n-electron atom having a central charge of Z times that of the proton and an electron configuration 1s²s²2p⁶3s²3pⁿ⁻¹², there are two indistinguishable spin-paired electrons in an orbitsphere with radii r₁ and r₂ both given by Eq. (7.19) and (10.51) (from Eq. (60)):

$${r}_{1} = {r}_{2} = {a}_{0} [ \frac{1}{Z - 1} - \frac{\sqrt{\frac{3}{4}}}{Z ( Z - 1 )} ] \qquad ( 65 )$$

two indistinguishable spin-paired electrons in an orbitsphere with radii r₃ and r₄ both given by Eq. (10.62) (from Eq. (60)):

$${r}_{4} = {r}_{3} = \frac{( \frac{{a}_{0} ( 1 - \frac{\sqrt{\frac{3}{4}}}{Z} )}{( \begin{matrix}( Z - 3 ) - \\ ( \frac{1}{4} - \frac{1}{Z} ) \frac{\sqrt{\frac{3}{4}}}{{r}_{1}}\end{matrix} )} \pm {a}_{0} \sqrt{\begin{matrix}\frac{{( 1 - \frac{\sqrt{\frac{3}{4}}}{Z} )}^{2}}{{( \begin{matrix}( Z - 3 ) - ( \frac{1}{4} - \frac{1}{Z} ) \\ \frac{\sqrt{\frac{3}{4}}}{{r}_{1}}\end{matrix} )}^{2}} + 4 \\ \frac{[ \frac{Z - 3}{Z - 2} ] {r}_{1} 10 \sqrt{\frac{3}{4}}}{( \begin{matrix}( Z - 3 ) - ( \frac{1}{4} - \frac{1}{Z} ) \\ \frac{\sqrt{\frac{3}{4}}}{{r}_{1}}\end{matrix} )}\end{matrix}} )}{2} \\ {r}_{1} in units of {a}_{0} \qquad ( 66 )$$

where r₁ is given by Eq. (65), three sets of paired indistinguishable electrons in an orbitsphere with radius r₁₀ given by Eq. (64) (Eq. (10.212)):

$${r}_{10} = \frac{\frac{{a}_{0}}{( \begin{matrix}( Z - 9 ) - \\ ( \frac{5}{24} - \frac{6}{Z} ) \frac{\sqrt{3}}{{r}_{3}}\end{matrix} )} \pm {a}_{0} \sqrt{\begin{matrix}{( \frac{1}{( \begin{matrix}( Z - 9 ) - \\ ( \frac{5}{24} - \frac{6}{Z} ) \frac{\sqrt{3}}{{r}_{3}}\end{matrix} )} )}^{2} + \\ 20 \sqrt{3} \\ \frac{( [ \frac{Z - 10}{Z - 9} ] ( 1 - \frac{\sqrt{2}}{2} ) {r}_{3} )}{( ( Z - 9 ) - ( \frac{5}{24} - \frac{6}{Z} ) \frac{\sqrt{3}}{{r}_{3}} )}\end{matrix}}}{2} \\ {r}_{3} in units of {a}_{0} \qquad ( 67 )$$

where r₃ is given by Eq. (66) (Eqs. (10.62) and (10.402)), two indistinguishable spin-paired electrons in an orbitsphere with radius r₁₂ given by Eq. (10.255) (from Eq. (60)):

$${r}_{12} = \frac{\frac{{a}_{0}}{( \begin{matrix}( Z - 11 ) - \\ ( \frac{1}{8} - \frac{3}{Z} ) \frac{\sqrt{3}}{{r}_{10}}\end{matrix} )} \pm {a}_{0} \sqrt{\begin{matrix}{( \frac{1}{( \begin{matrix}( Z - 11 ) - \\ ( \frac{1}{8} - \frac{3}{Z} ) \frac{\sqrt{3}}{{r}_{10}}\end{matrix} )} )}^{2} + \\ \frac{\begin{matrix}20 \sqrt{3} \\ ( [ \frac{Z - 12}{Z - 11} ] ( 1 + \frac{\sqrt{2}}{2} ) {r}_{10} )\end{matrix}}{( ( Z - 11 ) - ( \frac{1}{8} - \frac{3}{Z} ) \frac{\sqrt{3}}{{r}_{10}} )}\end{matrix}}}{2} \\ {r}_{10} in units of {a}_{0} \qquad ( 68 )$$

where r₁₀ is given by Eq. (67) (Eq. (10.212)), and n−12 electrons in a 3p orbitsphere with radius rₙ given by

$${r}_{n} = \frac{\frac{{a}_{0}}{( \begin{matrix}( Z - ( n - 1 ) ) - \\ ( \frac{A}{8} - \frac{B}{2 Z} ) \\ \frac{\sqrt{3}}{{r}_{12}}\end{matrix} )} \pm {a}_{0} \sqrt{\begin{matrix}{( \frac{1}{( \begin{matrix}( Z - ( n - 1 ) ) - \\ ( \frac{A}{8} - \frac{B}{2 Z} ) \\ \frac{\sqrt{3}}{{r}_{12}}\end{matrix} )} )}^{2} + \\ \frac{\begin{matrix}20 \sqrt{3} \\ ( \begin{matrix}[ \frac{Z - n}{Z - ( n - 1 )} ] \\ ( 1 - \frac{\sqrt{2}}{2} + \frac{1}{2} ) {r}_{12}\end{matrix} )\end{matrix}}{( \begin{matrix}( Z - ( n - 1 ) ) - \\ ( \frac{A}{8} - \frac{B}{2 Z} ) \\ \frac{\sqrt{3}}{{r}_{12}}\end{matrix} )}\end{matrix}}}{2} \\ {r}_{12} in units of {a}_{0} \qquad ( 69 )$$

where r₁₂ is given by Eq. (68) (Eqs. (10.255) and (10.404)), the parameter A given in TABLE XXIII corresponds to the diamagnetic force, F_{diamagnetic}, (Eq. (10.258)), and the parameter B given in TABLE XXIII corresponds to the paramagnetic force, F_{mag 2} (Eqs. (10.260-10.264)). The positive root of Eq. (69) must be taken in order that rₙ>0. The radii of several n-electron 3p atoms are given in TABLES XIII-XVIII.

The ionization energy for the aluminum atom is given by Eq. (10.227). The ionization energies for the n-electron 3p atoms are given by the negative of the electric energy, E(electric), (Eq. (61) with the radii, rₙ, given by Eq. (69)). Since the relativistic corrections were small, the nonrelativistic ionization energies for experimentally measured n-electron 3p atoms are given by Eqs. (61) and (69) in TABLES XIII-XVIII.

### Systems

Embodiments of the system for performing computing and rendering of the nature atomic and atomic-ionic electrons using the physical solutions may comprise a general purpose computer. Such a general purpose computer may have any number of basic configurations. For example, such a general purpose computer may comprise a central processing unit (CPU), one or more specialized processors, system memory, a mass storage device such as a magnetic disk, an optical disk, or other storage device, an input means such as a keyboard or mouse, a display device, and a printer or other output device. A system implementing the present invention can also comprise a special purpose computer or other hardware system and all should be included within its scope.

The display can be static or dynamic such that spin and angular motion with corresponding momenta can be displayed in an embodiment. The displayed information is useful to anticipate reactivity and physical properties. The insight into the nature of atomic and atomic-ionic electrons can permit the solution and display of other atoms and atomic ions and provide utility to anticipate their reactivity and physical properties. Furthermore, the displayed information is useful in teaching environments to teach students the properties of electrons.

Embodiments within the scope of the present invention also include computer program products comprising computer readable medium having embodied therein program code means. Such computer readable media can be any available media which can be accessed by a general purpose or special purpose computer. By way of example, and not limitation, such computer readable media can comprise RAM, ROM, EPROM, CD ROM, DVD or other optical disk storage, magnetic disk storage or other magnetic storage devices, or any other medium which can embody the desired program code means and which can be accessed by a general purpose or special purpose computer. Combinations of the above should also be included within the scope of computer readable media. Program code means comprises, for example, executable instructions and data which cause a general purpose computer or special purpose computer to perform a certain function of a group of functions.

A specific example of the rendering of the electron of atomic hydrogen using Mathematica and computed on a PC is shown in FIG. 1. The algorithm used was

### To Generate a Spherical Shell:

SphericalPlot3D[1,{q,0,p},{f,0,2p},Boxed®False,Axes®False];. The rendering can be viewed from different perspectives. A specific example of the rendering of atomic hydrogen using Mathematica and computed on a PC is shown in FIG. 1. The algorithm used was

### To Generate the Picture of the Electron and Proton:

Electron=SphericalPlot3D[1,{q,0,p},{f,0,2p-p/2},Boxed®False,Axes®False]; Proton=Show[Graphics3D[{Blue,PointSize[0.03],Point[{0,0,0}]}],Boxed®False]; Show[Electron,Proton];

Specific examples of the rendering of the spherical-and-time-harmonic-electron-charge-density functions using Mathematica and computed on a PC are shown in FIG. 3. The algorithm used was

### To Generate L1MO:

L1MOcolors[theta_,phi_,det_]=Which[det<0.1333,RGBColor[1.000,0.070,0.079],det<0.2666,RGBColor[1.000,0.369,0.067],det<0.4,RGBColor[1.000,0.681,0.049],det<0.5333,RGBColor[0.984,1.000,0.051],det<0.6666,RGBColor[0.673,1.000,0.058],det<0.8,RGBColor[0.364,1.000,0.055],det<0.9333,RGBColor[0.071,1.000,0.060],det<1.066,RGBColor[0.085,1.000,0.388],det<1.2,RGBColor[0.070,1.000,0.678],det<1.333,RGBColor[0.070,1.000,1.000],det<1.466,RGBColor[0.067,0.698,1.000],det<1.6,RGBColor[0.075,0.401,1.000],det<1.733,RGBColor[0.067,0.082,1.000],det<1.866,RGBColor[0.326,0.056,1.000],det£2,RGBColor[0.674,0.079,1.000]];
L1MO=ParametricPlot3D[{Sin[theta] Cos[phi],Sin[theta] Sin[phi],Cos[theta],L1 MOcolors[theta,phi,1+Cos[theta]]},{theta,0,Pi},{phi,0,2Pi},Boxed®False,Axes®False,Lighting®False,PlotPoints®{20,20},ViewPoint®{−0.273,−2.030,3.494)];

### To Generate L1MX:

L1MXcolors[theta_, phi_, det_]=Which[det<0.1333, RGBColor[1.000, 0.070, 0.079],det<0.2666, RGBColor[1.000, 0.369, 0.067],det<0.4, RGBColor[1.000, 0.681, 0.049],det<0.5333, RGBColor[0.984, 1.000, 0.051], det<0.6666, RGBColor[0.673, 1.000, 0.058], det<0.8, RGBColor[0.364, 1.000, 0.055],det<0.9333, RGBColor[0.071, 1.000, 0.060], det<1.066, RGBColor[0.085, 1.000, 0.388],det<1.2, RGBColor[0.070, 1.000, 0.678], det<1.333, RGBColor[0.070, 1.000, 1.000],det<1.466, RGBColor[0.067,0.698,1.000], det<1.6, RGBColor[0.075, 0.401, 1.000],det<1.733, RGBColor[0.067, 0.082, 1.000], det<1.866, RGBColor[0.326, 0.056, 1.000],det<=2, RGBColor[0.674, 0.079, 1.000]];
L1MX=ParametricPlot3D[{Sin[theta] Cos[phi],Sin[theta]
Sin[phi],Cos[theta],L1MXcolors[theta,phi,1+Sin[theta]
Cos[phi]]},{theta,0,Pi),{phi,0,2Pi},Boxed®False,Axes®False,Lighting®False,PlotPoints®{20,20},ViewPoint®{−0.273,−2.030,3.494}];

### To Generate L1MY:

L1MYcolors[theta_,phi_,det_=Which[det<0.1333,RGBColor[1.000,0.070,0.079],det<0.2666,RGBColor[1.000,0.369,0.067],det<0.4,RGBColor[1.000,0.681,0.049],det<0.5333,RGBColor[0.984,1.000,0.051],det<0.6666,RGBColor[0.673,1.000,0.058],det<0.8,RGBColor[0.364,1.000,0.055],det<0.9333,RGBColor[0.071,1.000,0.060],det<1.066,RGBColor[0.085,1.000,0.388],det<1.2,RGBColor[0.070,1.000,0.678],det<1.333,RGBColor[0.070,1.000,1.000],det<1.466,RGBColor[0.067,0.698,1.000],det<1.6,RGBColor[0.075,0.401,1.000],det<1.733,RGBCoor[0.067,0.082,1.000],det<1.866,RGBColor[0.326,0.056,1.000],det£2,RGBColor[0.674,0.079,1.000]];
L1MY=ParametricPlot3D[{Sin[theta] Cos[phi],Sin[theta]
Sin[phi],Cos[theta],L1 MYcolors[theta,phi,1+Sin[theta]
Sin[phi]]},{theta,0,Pi},{phi,0,2 Pi},Boxed®False,Axes®False,Lighting®False,PlotPoints®{20,20}];

### To Generate L2MO:

L2MOcolors[theta_, phi_, det_=Which[det<0.2, RGBColor[1.000, 0.070, 0.079],det<0.4, RGBColor[1.000, 0.369, 0.067],det<0.6, RGBColor[1.000, 0.681, 0.049],det<0.8, RGBColor[0.984, 1.000, 0.051],det<1, RGBColor[0.673, 1.000, 0.058],det<1.2, RGBColor[0.364,1.000, 0.055],det<1.4, RGBColor[0.071, 1.000, 0.060],det<1.6, RGBColor[0.085,1.000, 0.388],det<1.8, RGBColor[0.070, 1.000, 0.678],det<2, RGBColor[0.070, 1.000, 1.000],det<2.2, RGBColor[0.067, 0.698, 1.000],det<2.4, RGBColor[0.075, 0.401, 1.000],det<2.6, RGBColor[0.067, 0.082, 1.000],det<2.8, RGBColor[0.326, 0.056, 1.000],det<=3, RGBColor[0.674, 0.079, 1.000]];
L2MO=ParametricPlot3D[{Sin[theta] Cos[phi], Sin[theta] Sin[phi], Cos[theta],

L2MOcolors[theta, phi, 3Cos[theta] Cos[theta]]},

{theta, 0, Pi}, {phi, 0, 2Pi},

Boxed->False, Axes->False, Lighting->False,

PlotPoints->{20, 20},

ViewPoint->{−0.273, −2.030, 3.494}];

### To Generate L2MF:

L2MFcolors[theta_,phi_,det_=Which[det<0.1333,RGBColor[1.000,0.070,0.079],det<0.2666,RGBColor[1.000,0.369,0.067],det<0.4,RGBColor[1.000,0.681,0.049],det<0.5333,RGBColor(0.984,1.000,0.051],det<0.6666,RGBColor[0.673,1.000,0.058],det<0.8,RGBColor[0.364,1.000,0.055],det<0.9333,RGBColor[0.071,1.000,0.060],det<1.066,RGBColor[0.085,1.000,0.388],det<1.2,RGBColor[0.070,1.000,0.678],det<1.333,RGBColor 0.070,1.000,1.000],det<1.466,RGBColor[0.067,0.698,1.000],det<1.6,RGBColor[0.075,0.401,1.000],det<1.733,RGBColor[0.067,0.082,1.000],det<1.866,RGBColor[0.326, 0.056,1.000],det£2,RGBColor[0.674,0.079,1.000]];
L2MF=ParametricPlot3D[{Sin[theta] Cos[phi],Sin[theta]
Sin[phi],Cos[theta],L2MFcolors[theta,phi,1+0.72618 Sin[theta] Cos[phi] 5 Cos[theta] Cos[theta]−0.72618 Sin[theta]
Cos[phi]]},{theta,0,Pi},{phi,0,2Pi},Boxed®False,Axes®False,Lighting®False,PlotPoints®{20,20},ViewPoint®(−0.273,−2.030,2.494}];

### To Generate L2MX2Y2:

L2MX2Y2colors[theta_,phi_,det_=Which[det<0.1333,RGBColor[1.000,0.070,0.079], det<0.2666,RGBColor[1.000,0.369,0.067],det<0.4,RGBColor(1.000,0.681,0.049],det<0.5333,RGBColor[0.984, 1.000,0.051],det<0.6666,RGBColor[0.673, 1.000,0.058],det<0.8, RGBColor[0.364, 1.000,0.055],det<0.9333,RGBColor[0.071,1.000,0.060],det<1.066,RGBColor[0.085,1.000,0.3881,det<1.2,RGBColor[0.070,1.000,0.678],det<1.333,RGBColor[0.070,1.000,1.000],det<1.466,RGBColor[0.067,0.698,1.000],det<1.6,RGBColor[0.075,0.401,1.000],det<1.733,RGBColor[0.067,0.082, 1.000],det<1.866,RGBColor[0.326,0.056,1.000],det£2,RGBColor[0.674,0.079, 1.0001];
L2MX2Y2=ParametricPlot3D[{Sin[theta] Cos[phi],Sin[theta]
Sin[phi],Cos[theta],L2MX2Y2colors[theta,phi,1+Sin[theta] Sin[theta] Cos[2 phi]]},{theta,0,Pi},{phi,0,2Pi},Boxed®False,Axes®False,Lighting®False,PlotPoints®{20,20},ViewPoint®{−0.273,−2.030,3.494}];

### To Generate L2MXY:

L2MXYcolors[theta_,phi_,det_=Which[det<0.1333,RGBColor[1.000,0.070,0.079],de t<0.2666,RGBColor[1.000,0.369,0.067],det<0.4,RGBColor[1.000,0.681,0.049],det<0.5333,RGBColor[0.984,1.000,0.051],det<0.6666,RGBColor[0.673, 1.000,0.058],det<0.8,RGBColor[0.364, 1.000,0.055],det<0.9333,RGBColor[0.071,1.000,0.060],det<1.066,RGBColor[0.085, 1.000,0.388],det<1.2,RGBColor[0.070, 1.000,0.678],det<1.333,RGBColor[0.070,1.000,1.000],det<1.466,RGBColor[0.067,0.698,1.000],det<1.6,RGBColor[0.075,0.401,1.000],det<1.733,RGBColor[0.067,0.082,1.000],det<1.866,RGBColor[0.326,0.056,1.000],det£2,RGBColor[0.674,0.079, 1.000]];
ParametricPlot3D[{Sin[theta] Cos[phi],Sin[theta]
Sin[phi],Cos[theta],L2MXYcolors[theta,phi,1+Sin[theta] Sin[theta] Sin[2
phi]]),{theta,0,Pi},{phi,0,2Pi},Boxed®False,Axes®False,Lighting®False,PlotPoints®{20,20},ViewPoint®{0.273,−2.030,3.494}];

The present invention may be embodied in other specific forms without departing from the spirit or essential attributes thereof and, accordingly, reference should be made to the appended claims, rather than to the foregoing specification, as indicating the scope of the invention.

The following list of references are incorporated by reference in their entirety and referred to throughout this application by use of brackets.
1. F. Laloë, Do we really understand quantum mechanics? Strange correlations, paradoxes, and theorems, Am. J. Phys. 69 (6), June 2001, 655-701.
2. R. L. Mills, “Classical Quantum Mechanics”, submitted; posted at http://www.blacklightpower.com/pdf/CQMTheoryPaperTablesand%20Figures080403.pdf.
3. R. L. Mills, “The Nature of the Chemical Bond Revisited and an Alternative Maxwellian Approach”, submitted; posted at http://www.blacklightpower.com/pdf/technicai/H2PaperTableFiguresCaptions111303.pdf.
4. R. Mills, The Grand Unified Theory of Classical Quantum Mechanics, September 2001 Edition, BlackLight Power, Inc., Cranbury, N.J., Distributed by Amazon.com; January 2004 Edition posted at http://www.blacklightpower.com/bookdownload.shtml.
5. R. L. Mills, “Exact Classical Quantum Mechanical Solution for Atomic Helium Which Predicts Conjugate Parameters from a Unique Solution for the First Time”, submitted; posted at http://www.blacklightpower.com/pdf/technical/ExactCQMSolutionforAtomicHelium073004.pdf.
6. R. L. Mills, “Maxwell's Equations and QED: Which is Fact and Which is Fiction”, submitted; posted at http://www.blacklightpower.com/pdf/technical/MaxwellianEquationsandQED080604.pdf.
7. R. L. Mills, The Fallacy of Feynman's Argument on the Stability of the Hydrogen Atom According to Quantum Mechanics, submitted; posted at http://www.blacklightpower.com/pdf/Feynman%27s%20Argument%20Spec%20UPDATE%20091003.pdf.
8. R. Mills, “The Nature of Free Electrons in Superfluid Helium-a Test of Quantum Mechanics and a Basis to Review its Foundations and Make a Comparison to Classical Theory”, Int. J. Hydrogen Energy, Vol. 26, No. 10, (2001), pp. 1059-1096.
9. R. Mills, “The Hydrogen Atom Revisited”, Int. J. of Hydrogen Energy, Vol. 25, Issue 12, December, (2000), pp. 1171-1183.
10. H. Margenau, G. M. Murphy, The Mathematics of Physics and Chemistry, D. Van Nostrand Company, Inc., New York, (1956), Second Edition, pp. 363-367.
11. V. F. Weisskopf, Reviews of Modern Physics, Vol. 21, No. 2, (1949), pp. 305-315.
12. H. Wergeland, “The Klein Paradox Revisited”, Old and New Questions in Physics, Cosmology, Philosophy, and Theoretical Biology, A. van der Merwe, Editor, Plenum Press, New York, (1983), pp. 503-515.
13. A. Einstein, B. Podolsky, N. Rosen, Phys. Rev., Vol. 47, (1935), p. 777.
14. P. Pearle, Foundations of Physics, “Absence of radiationless motions of relativistically rigid classical electron”, Vol. 7, Nos. 11/12, (1977), pp. 931-945.
15. F. Dyson, “Feynman's proof of Maxwell equations”, Am. J. Phys., Vol. 58, (1990), pp. 209-211.
16. H. A. Haus, On the radiation from point charges, American Journal of Physics, Vol. 54, 1126-1129 (1986).
17. http://www.blacklightpower.com/new.shtml.
18. D. A. McQuarrie, Quantum Chemistry, University Science Books, Mill Valley, Calif., (1983), pp. 206-225.
19. J. Daboul and J. H. D. Jensen, Z. Physik, Vol. 265, (1973), pp. 455-478.
20. T. A. Abbott and D. J. Griffiths, Am. J. Phys., Vol. 53, No. 12, (1985), pp. 1203-1211.
21. G. Goedecke, Phys. Rev 135B, (1964), p. 281.
22. D. A. McQuarrie, Quantum Chemistry, University Science Books, Mill Valley, Calif., (1983), pp. 238-241.
23. R. S. Van Dyck, Jr., P. Schwinberg, H. Dehmelt, “New high precision comparison of electron and positron g factors”, Phys. Rev. Lett., Vol. 59, (1987), p. 26-29.
24. C. E. Moore, “Ionization Potentials and Ionization Limits Derived from the Analyses of Optical Spectra, Nat. Stand. Ref. Data Ser.-Nat. Bur. Stand. (U.S.), No. 34, 1970.
25. R. C. Weast, CRC Handbook of Chemistry and Physics, 58 Edition, CRC Press, West Palm Beach, Fla., (1977), p. E-68.
26. NIST Atomic Spectra Database, www.physics.nist.gov/cgi-bin/AtData/display.ksh.
27. R. Mills, The Grand Unified Theory of Classical Quantum Mechanics, January 2004 Edition, Mathematical Relationship Between the Theories of Bohr and Schrödinger with Respect to Classical Quantum Mechanics section; posted at http://www.blacklightpower.com/pdf/GUT/TOE%2002.10.03/Chapters/Introduction.pdf
28. P. A. M. Dirac, From a Life of Physics, ed. A. Salam, et al., World Scientific, Singapore, (1989).
29. Milonni, P. W., The Quantum Vacuum, Academic Press, Inc., Boston, p. 90.
30. P. A. M. Dirac, Directions in Physics, ed. H. Hora and J. R. Shepanski, Wiley, New York, (1978), p. 36.
31. H. Dehmelt, “Experiments on the structure of an individual elementary particle, Science, (1990), Vol. 247, pp. 539-545.
32. W. E. Lamb, R. C. Retherford, “Fine structure of the hydrogen atom by a microwave method”, Phys. Rev., Vol. 72, No. 3, (1947), pp. 241-243.
33. H. A. Bethe., The Electromagnetic Shift of Energy Levels”, Physical Review, Vol. 72, No. 4, August, 15, (1947), pp. 339-341.
34. L. de Broglie, “On the true ideas underlying wave mechanics”, Old and New Questions in Physics, Cosmology, Philosophy, and Theoretical Biology, A. van der Merwe, Editor, Plenum Press, New York, (1983), pp. 83-86.
35. D.C. Cassidy, Uncertainty the Life and Science of Werner Heisenberg, W. H. Freeman and Company, New York, (1992), pp. 224-225.
36. R. L. Mills, “Exact Classical Quantum Mechanical Solutions for One-Through Twenty-Electron Atoms”, submitted; posted at http://www.blacklightpower.com/pdf/technical/Exact%20Classical%20Quantum% 20Mechanical%20Solutions%20for%20One-%20 Through%20Twenty-Electron%20Atoms%20042204.pdf.

I claim:

1. A system of computing and rendering the nature of bound atomic and atomic ionic electrons from physical solutions of the charge, mass, and current density functions of atoms and atomic ions, which solutions are derived from Maxwell's equations using a constraint that the bound electron(s) does not radiate under acceleration, comprising:
processing means for processing and solving the equations for charge, mass, and current density functions of electron(s) in a selected atom or ion, wherein the equations are derived from Maxwell's equations using a constraint that the bound electron(s) does not radiate under acceleration; and
a display in communication with the processing means for displaying the current and charge density representation of the electron(s) of the selected atom or ion.

2. The system of claim 1, wherein the display is at least one of visual or graphical media.

3. The system of claim 1, wherein the display is at least one of static or dynamic.

4. The system of claim 3, wherein the processing means is constructed and arranged so that at least one of spin and orbital angular motion can be displayed.

5. The system of claim 1, wherein the processing means is constructed and arranged so that the displayed information can be used to model reactivity and physical properties.

6. The system of claim 1, wherein the processing means is constructed and arranged so that the displayed information can be used to model other atoms and atomic ions and provide utility to anticipate their reactivity and physical properties.

7. The system of claim 1, wherein the processing means is a general purpose computer.

8. The system of claim 7, wherein the general purpose computer comprises a central processing unit (CPU), one or more specialized processors, system memory, a mass storage device such as a magnetic disk, an optical disk, or other storage device, an input means such as a keyboard or mouse, a display device, and a printer or other output device.

9. The system of claim 1, wherein the processing means comprises a special purpose computer or other hardware system.

10. The system of claim 1, further comprising computer program products.

11. The system of claim 1, further comprising computer readable media having embodied therein program code means in communication with the processing means.

12. The system of claim 11, wherein the computer readable media is any available media that can be accessed by a general purpose or special purpose computer.

13. The system of claim 12, wherein the computer readable media comprises at least one of RAM, ROM, EPROM, CD ROM, DVD or other optical disk storage, magnetic disk storage or other magnetic storage devices, or any other medium that can embody a desired program code means and that can be accessed by a general purpose or special purpose computer.

14. The system of claim 13, wherein the program code means comprises executable instructions and data which cause a general purpose computer or special purpose computer to perform a certain function of a group of functions.

15. The system of claim 14, wherein the program code is Mathematica programmed with an algorithm based on the physical solutions.

16. The system of claim 15, wherein the algorithm for the rendering of the electron of atomic hydrogen using Mathematica is
SphericalPlot3D[1,{q,0,p},{f,0,2p},Boxed®False,Axes®False];
and the algorithm for the rendering of atomic hydrogen using Mathematica and computed on a PC is
Electron=SphericalPlot3D[1,{q,0,p},{f,0,2p-p/2},Boxed®False,Axes®False]; Proton=Show[Graphics3D[{Blue,PointSize[0.03],Point[{0,0,0}]}],Boxed®False]; Show[Electron,Proton];

17. The system of claim 15, wherein the algorithm for the rendering of the spherical-and-time-harmonic-electron-charge-density functions using Mathematica are
To Generate L1MO:
L1MOcolors[theta_,phi_,det_]=Which[det<0.1333,RGBColor[1.000,0.070,0.079],det<0.2666,RGBColor[1.000,0.369,0.067],det<0.4,RGBColor[1.000,0.681,0.049],det<0.5333,RGBColor[0.984,1.000,0.051],det<0.6666,RGBColor[0.673,1.000,0.058],det<0.8,RGBColor[0.364,1.000,0.055],det<0.9333,RGBColor[0.071,1.000,0.060],det<1.066,RGBColor[0.085,1.000,0.388],det<1.2,RGBColor[0.070,1.000,0.678],det<1.333,RGBColor[0.070,1.000,1.000],det<1.466,RGBColor[0.067,0.698,1.000],det<1.6,RGBColor[0.075,0.401,1.000],det<1.733,RGBColor[0.067,0.082,1.000],det<1.866,RGBColor[0.326,0.056,1.000],det£2,RGBColor[0.674,0.079,1.000]];
L1MO=ParametricPlot3D[{Sin[theta] Cos[phi],Sin[theta] Sin[phi],Cos[theta],L1 MOcolors[theta,phi,1+Cos[theta]]},{theta,0,Pi},{phi,0,2Pi},Boxed®False,Axes®False,Lighting®False,PlotPoints®{20,20},ViewPoint®{−0.273,−2.030,3.494)];
To Generate L1MX:
L1MXcolors[theta_, phi_, det_]=Which[det<0.1333, RGBColor[1.000, 0.070, 0.079],det<0.2666, RGBColor[1.000, 0.369, 0.067],det<0.4, RGBColor[1.000, 0.681, 0.049],det<0.5333, RGBColor[0.984, 1.000, 0.051], det<0.6666, RGBColor[0.673, 1.000, 0.058], det<0.8, RGBColor[0.364, 1.000, 0.055],det<0.9333, RGBColor[0.071, 1.000, 0.060], det<1.066, RGBColor[0.085, 1.000, 0.388],det<1.2, RGBColor[0.070, 1.000, 0.678], det<1.333, RGBColor[0.070, 1.000, 1.000],det<1.466, RGBColor[0.067,0.698,1.000], det<1.6, RGBColor[0.075, 0.401, 1.000],det<1.733, RGBColor[0.067, 0.082, 1.000], det<1.866, RGBColor[0.326, 0.056, 1.000],det<=2, RGBColor[0.674, 0.079, 1.000]];
L1MX=ParametricPlot3D[{Sin[theta] Cos[phi],Sin[theta]
Sin[phi],Cos[theta],L1MXcolors[theta,phi,1+Sin[theta]
Cos[phi]]},{theta,0,Pi),{phi,0,2Pi},Boxed®False,Axes®False,Lighting®False,PlotPoints®{20,20},ViewPoint®{−0.273,−2.030,3.494}];
To Generate L1MY:
L1MYcolors[theta_,phi_,det_=Which[det<0.1333,RGBColor[1.000,0.070,0.079],det<0.2666,RGBColor[1.000,0.369,0.067],det<0.4,RGBColor[1.000,0.681,0.049],det<0.5333,RGBColor[0.984,1.000,0.051],det<0.6666,RGBColor[0.673,1.000,0.058],det<0.8,RGBColor[0.364,1.000,0.055],det<0.9333,RGBColor[0.071,1.000,0.060],det<1.066,RGBColor[0.085,1.000,0.388],det<1.2,RGBColor[0.070,1.000,0.678],det<1.333,RGBColor[0.070,1.000,1.000],det<1.466,RGBColor[0.067,0.698,1.000],det<1.6,RGBColor[0.075,0.401,1.000],det<1.733,RGBCoor[0.067,0.082,1.000],det<1.866,RGBColor[0.326,0.056,1.000],det£2,RGBColor[0.674,0.079,1.000]];
L1MY=ParametricPlot3D[{Sin[theta] Cos[phi],Sin[theta]
Sin[phi],Cos[theta],L1 MYcolors[theta,phi,1+Sin[theta]
Sin[phi]]},{theta,0,Pi},{phi,0,2 Pi},Boxed®False,Axes®False,Lighting®False,PlotPoints®{20,20}];
To Generate L2MO:
L2MOcolors[theta_, phi_, det_=Which[det<0.2, RGBColor[1.000, 0.070, 0.079],det<0.4, RGBColor[1.000, 0.369, 0.067],det<0.6, RGBColor[1.000, 0.681, 0.049],det<0.8, RGBColor[0.984, 1.000, 0.051],det<1, RGBColor[0.673, 1.000, 0.058],det<1.2, RGBColor[0.364,1.000, 0.055],det<1.4, RGBColor[0.071, 1.000, 0.060],det<1.6, RGBColor[0.085,1.000, 0.388],det<1.8, RGBColor[0.070, 1.000, 0.678],det<2, RGBColor[0.070, 1.000, 1.000],det<2.2, RGBColor[0.067, 0.698, 1.000],det<2.4, RGBColor[0.075, 0.401, 1.000],det<2.6, RGBColor[0.067, 0.082, 1.000],det<2.8, RGBColor[0.326, 0.056, 1.000],det<=3, RGBColor[0.674, 0.079, 1.000]];
L2MO=ParametricPlot3D[{Sin[theta] Cos[phi], Sin[theta] Sin[phi], Cos[theta],
L2MOcolors[theta, phi, 3Cos[theta] Cos[theta]]},
{theta, 0, Pi}, {phi, 0, 2Pi},
Boxed->False, Axes->False, Lighting->False,
PlotPoints->{20, 20},
ViewPoint->{−0.273, −2.030, 3.494}];
To Generate L2MF;
L2MFcolors[theta_,phi_,det_=Which[det<0.1333,RGBColor[1.000,0.070,0.079],det<0.2666,RGBColor[1.000,0.369,0.067],det<0.4,RGBColor[1.000,0.681,0.049],det<0.5333,RGBColor(0.984,1.000,0.051],det<0.6666,RGBColor[0.673,1.000,0.058],det<0.8,RGBColor[0.364,1.000,0.055],det<0.9333,RGBColor[0.071,1.000,0.060],det<1.066,RGBColor[0.085,1.000,0.388],det<1.2,RGBColor[0.070,1.000,0.678],det<1.333,RGBColor 0.070,1.000,1.000],det<1.466,RGBColor[0.067,0.698,1.000],det<1.6,RGBColor[0.075,0.401,1.000],det<1.733,RGBColor[0.067,0.082,1.000],det<1.866,RGBColor[0.326, 0.056,1.000],det£2,RGBColor[0.674,0.079,1.000]];
L2MF=ParametricPlot3D[{Sin[theta] Cos[phi],Sin[theta]
Sin[phi],Cos[theta],L2MFcolors[theta,phi,1+0.72618 Sin[theta] Cos[phi] 5 Cos[theta] Cos[theta]−0.72618 Sin[theta]
Cos[phi]]},{theta,0,Pi},{phi,0,2Pi},Boxed®False,Axes®False,Lighting®False,PlotPoints®{20,20},ViewPoint®(−0.273,−2.030,2.494}];
To Generate L2MX2Y2:
L2MX2Y2colors[theta_,phi_,det_=Which[det<0.1333,RGBColor[1.000,0.070,0.079], det<0.2666,RGBColor[1.000,0.369,0.067],det<0.4,RGBColor(1.000,0.681,0.049],det<0.5333,RGBColor[0.984, 1.000,0.051],det<0.6666,RGBColor[0.673, 1.000,0.058],det<0.8, RGBColor[0.364, 1.000,0.055],det<0.9333,RGBColor[0.071,1.000,0.060],det<1.066,RGBColor[0.085,1.000,0.3881,det<1.2,RGBColor[0.070,1.000,0.678],det<1.333,RGBColor[0.070,1.000,1.000],det<1.466,RGBColor[0.067,0.698,1.000],det<1.6,RGBColor[0.075,0.401,1.000],det<1.733,RGBColor[0.067,0.082, 1.000],det<1.866,RGBColor[0.326,0.056,1.000],det£2,RGBColor[0.674,0.079, 1.0001];
L2MX2Y2=ParametricPlot3D[{Sin[theta] Cos[phi],Sin[theta]
Sin[phi],Cos[theta],L2MX2Y2colors[theta,phi,1+Sin[theta] Sin[theta] Cos[2 phi]]},{theta,0,Pi},{phi,0,2Pi},Boxed®False,Axes®False,Lighting®False,PlotPoints®{20,20},ViewPoint®{−0.273,−2.030,3.494}];
To Generate L2MXY:
L2MXYcolors[theta_,phi_,det_=Which[det<0.1333,RGBColor[1.000,0.070,0.079],de t<0.2666,RGBColor[1.000,0.369,0.067],det<0.4,RGBColor[1.000,0.681,0.049],det<0.5333,RGBColor[0.984,1.000,0.051],det<0.6666,RGBColor[0.673, 1.000,0.058],det<0.8,RGBColor[0.364, 1.000,0.055],det<0.9333,RGBColor[0.071,1.000,0.060],det<1.066,RGBColor[0.085, 1.000,0.388],det<1.2,RGBColor[0.070, 1.000,0.678],det<1.333,RGBColor[0.070,1.000,1.000],det<1.466,RGBColor[0.067,0.698,1.000],det<1.6,RGBColor[0.075,0.401,1.000],det<1.733,RGBColor[0.067,0.082,1.000],det<1.866,RGBColor[0.326,0.056,1.000],det£2,RGBColor[0.674,0.079, 1.000]];
ParametricPlot3D[{Sin[theta] Cos[phi],Sin[theta]
Sin[phi],Cos[theta],L2MXYcolors[theta,phi,1+Sin[theta] Sin[theta] Sin[2
phi]]),{theta,0,Pi},{phi,0,2Pi},Boxed®False,Axes®False,Lighting®False,PlotPoints®{20,20},ViewPoint®{{0.273,−2.030,3.494}].

18. The system of claim 1 wherein the physical, Maxwellian solutions of the charge, mass, and current density functions of atoms and atomic ions comprises a solution of the classical wave equation
$$[ {∇}^{2} - \frac{1}{{v}^{2}} \frac{{\partial }^{2}}{\partial {t}^{2}} ] ρ ( r , θ , φ , t ) = 0.$$

19. The system of claim 18, wherein the time, radial, and angular solutions of the wave equation are separable.

20. The system of claim 18, wherein the boundary constraint of the wave equation solution is nonradiation according to Maxwell's equations.

21. The system of claim 20, wherein a radial function that satisfies the boundary condition is a radial delta function
$$f ( r ) = \frac{1}{{r}^{2}} δ ( r - {r}_{n} ) .$$

22. The system of claim 21, wherein the boundary condition is met for a time harmonic function when the relationship between an allowed radius and the electron wavelength is given by
$$2 π {r}_{n} = {λ}_{n} , \\ ω = \frac{ℏ}{{m}_{e} {r}^{2}} , and$$
$$v = \frac{ℏ}{{m}_{e} r}$$
where ω is the angular velocity of each point on the electron surface, v is the velocity of each point on the electron surface, and r is the radius of the electron.

23. The system of claim 22, wherein the spin function is given by the uniform function Y₀⁰(φ,θ) comprising angular momentum components of
$${L}_{xy} = \frac{ℏ}{4} and$$
$${L}_{z} = \frac{ℏ}{2} .$$

24. The system of claim 23, wherein the atomic and atomic ionic charge and current density functions of bound electrons are described by a charge-density (mass-density) function which is the product of a radial delta function, two angular functions (spherical harmonic functions), and a time harmonic function:
$$\begin{matrix}ρ ( r , θ , φ , t ) = f ( r ) A ( θ , φ , t ) \\ = \frac{1}{{r}^{2}} δ ( r - {r}_{n} ) A ( θ , φ , t ) ;\end{matrix}$$
$$A ( θ , φ , t ) = Y ( θ , φ ) k ( t )$$
wherein the spherical harmonic functions correspond to a traveling charge density wave confined to the spherical shell which gives rise to the phenomenon of orbital angular momentum.

25. The system of claim 24, wherein based on the radial solution, the angular charge and current-density functions of the electron, A(θ,φ,t), must be a solution of the wave equation in two dimensions (plus time),
$$[ {∇}^{2} - \frac{1}{{v}^{2}} \frac{{\partial }^{2}}{\partial {t}^{2}} ] A ( θ , φ , t ) = 0 where$$
$$ρ ( r , θ , φ , t ) = f ( r ) A ( θ , φ , t ) = \frac{1}{{r}^{2}} δ ( r - {r}_{n} ) A ( θ , φ , t ) and$$
$$A ( θ , φ , t ) = Y ( θ , φ ) k ( t ) \\ [ \begin{matrix}\frac{1}{{r}^{2} sin θ} \frac{\partial }{\partial θ} {( sin θ \frac{\partial }{\partial θ} )}_{r , φ} + \\ \frac{1}{{r}^{2} {sin}^{2} θ} {( \frac{{\partial }^{2}}{\partial {φ}^{2}} )}_{r , θ} - \frac{1}{{v}^{2}} \frac{{\partial }^{2}}{\partial {t}^{2}}\end{matrix} ] A ( θ , φ , t ) = 0$$
where v is the linear velocity of the electron.

26. The system of claim 25, wherein the charge-density functions including the time-function factor are
$$l = 0$$
$$ρ ( r , θ , φ , t ) = \frac{e}{8 π {r}^{2}} [ δ ( r - {r}_{n} ) ] [ {Y}_{0}^{0} ( θ , φ ) + {Y}_{l}^{m} ( θ , φ ) ]$$
$$l \neq 0$$
$$ρ ( r , θ , φ , t ) = \frac{e}{4 π {r}^{2}} [ δ ( r - {r}_{n} ) ] [ {Y}_{0}^{0} ( θ , φ ) + Re \{ {Y}_{l}^{m} ( θ , φ ) {e}^{{iω}_{n} t} \} ]$$
where Yₗ^{m}(θ,φ) are the spherical harmonic functions that spin about the z-axis with angular frequency ωₙ with Y₀⁰(θ,φ) the constant function
Re{Yₗ^{m}(θ,φ)e^{iω}^{ₙ}^{t}}=Pₗ^{m}(cos θ)cos(mφ+ωₙt) where to keep the form of the spherical harmonic as a traveling wave about the z-axis, ω′ₙ=mωₙ.

27. The system of claim 26, wherein the spin and angular moment of inertia, I, angular momentum, L, and energy, E, for quantum number [symbol] are given by
$$l = 0$$
$${I}_{z} = {I}_{spin} = \frac{{m}_{e} {r}_{n}^{2}}{2}$$
$${L}_{z} = I ω {i}_{z} = \pm \frac{ℏ}{2}$$
$${E}_{rotational} = {E}_{rotational , spin} = \frac{1}{2} [ {{I}_{spin} ( \frac{ℏ}{{m}_{e} {r}_{n}^{2}} )}^{2} ] = \frac{1}{2} [ \frac{{m}_{e} {r}_{n}^{2}}{2} {( \frac{ℏ}{{m}_{e} {r}_{n}^{2}} )}^{2} ] = \frac{1}{4} [ \frac{{ℏ}^{2}}{2 {I}_{spin}} ]$$
$$l \neq 0$$
$${I}_{orbital} = {m}_{e} {{r}_{n}^{2} [ \frac{l ( l + 1 )}{{l}^{2} + l + 1} ]}^{\frac{1}{2}}$$
$${L}_{z} = m ℏ$$
$${L}_{z total} = {L}_{zspin} + {L}_{z orbital}$$
$${E}_{rotational , orbital} = \frac{{ℏ}^{2}}{2 I} [ \frac{l ( l + 1 )}{{l}^{2} + 2 l + 1} ]$$
$$T = \frac{{ℏ}^{2}}{2 {m}_{e} {r}_{n}^{2}}$$
$$〈 {E}_{rotational , orbital} 〉 = 0.$$

28. The system of claim 1, wherein the force balance equation for one-electron atoms and ions is
$$\frac{{m}_{e}}{4 π {r}_{1}^{2}} \frac{{v}_{1}^{2}}{{r}_{1}} = \frac{e}{4 π {r}_{1}^{2}} \frac{Z e}{4 π {ɛ}_{o} {r}_{1}^{2}} - \frac{1}{4 π {r}_{1}^{2}} \frac{{ℏ}^{2}}{{m}_{p} {r}_{n}^{3}}$$
$${r}_{1} = \frac{{a}_{H}}{Z}$$
where α_{H} is the radius of the hydrogen atom.

29. The system of claim 28, wherein from Maxwell's equations, the potential energy V, kinetic energy T, electric energy or binding energy Eₑₗₑ are
$$\begin{matrix}V = \frac{- {Ze}^{2}}{4 π {ɛ}_{o} {r}_{1}} \\ = \frac{- {Z}^{2} {e}^{2}}{4 π {ɛ}_{o} {a}_{H}} \\ = - {Z}^{2} \times 4.3675 \times {10}^{- 18} J \\ = - {Z}^{2} \times 27.2 eV\end{matrix}$$
$$T = \frac{{Z}^{2} {e}^{2}}{8 π {ɛ}_{o} {a}_{H}} = {Z}^{2} \times 13.59 eV$$
$$T = {E}_{ele} = - \frac{1}{2} {ɛ}_{o} {\int }_{∞}^{{r}_{1}} {E}^{2} d v$$
$$where$$
$$E = - \frac{Ze}{4 π {ɛ}_{o} {r}^{2}}$$
$$\begin{matrix}{E}_{ele} = - \frac{{Z}^{2} {e}^{2}}{8 π {ɛ}_{0} {a}_{H}} \\ = - {Z}^{2} \times 2.1786 \times {10}^{- 18} J \\ = - {Z}^{2} \times 13.598 eV .\end{matrix}$$

30. The system of claim 1, wherein the force balance equation solution of two electron atoms is a central force balance equation with the nonradiation condition given by
$$\frac{{m}_{e}}{4 π {r}_{2}^{2}} \frac{{v}_{2}^{2}}{{r}_{2}} = \frac{e}{4 π {r}_{2}^{2}} \frac{( Z - 1 ) e}{4 π {ɛ}_{o} {r}_{2}^{2}} + \frac{1}{4 π {r}_{2}^{2}} \frac{{ℏ}^{2}}{{Zm}_{e} {r}_{2}^{3}} \sqrt{s ( s + 1 )}$$
which gives the radius of both electrons as
$${r}_{2} = {r}_{1} = {a}_{0} ( \frac{1}{Z - 1} - \frac{\sqrt{s ( s + 1 )}}{Z ( Z - 1 )} ) ; s = \frac{1}{2} .$$

31. The system of claim 30, wherein the ionization energy for helium, which has no electric field beyond r₁ is given by
$$Ionization Energy ( He ) = - E ( electric ) + E ( magnetic )$$
$$where , \\ E ( electric ) = - \frac{( Z - 1 ) {e}^{2}}{8 π {ɛ}_{o} {r}_{1}}$$
$$E ( magnetic ) = \frac{2 π {μ}_{0} {e}^{2} {ℏ}^{2}}{{m}_{e}^{2} {r}_{1}^{3}}$$
$$For 3 \leq Z$$
$$Ionization Energy = - Electric Energy - \frac{1}{Z} Magnetic Energy .$$

32. The system of claim 1, wherein the electrons of multielectron atoms all exist as orbitspheres of discrete radii which are given by rₙ of the radial Dirac delta function, δ(r−rₙ).

33. The system of claim 32, wherein electron orbitspheres may be spin paired or unpaired depending on the force balance which applies to each electron wherein the electron configuration is a minimum of energy.

34. The system of claim 33, wherein the minimum energy configurations are given by solutions to Laplace's equation.

35. The system of claim 34, wherein the electrons of an atom with the same principal and [symbol] quantum numbers align parallel until each of the mₗ levels are occupied, and then pairing occurs until each of the [symbol] levels contain paired electrons.

36. The system of claim 35, wherein the electron configuration for one through twenty-electron atoms that achieves an energy minimum is: 1s<2s<2p<3s<3p<4s.

37. The system of claim 36, wherein the corresponding force balance of the central centrifical, Coulombic, paramagnetic, magnetic, and diamagnetic forces for an electron configuration was derived for each n-electron atom that was solved for the radius of each electron.

38. The system of claim 37, wherein the central Coulombic force is that of a point charge at the origin since the electron charge-density functions are spherically symmetrical with a time dependence that is nonradiative.

39. The system of claim 38, wherein the ionization energies are obtained using the calculated radii in the determination of the Coulombic and any magnetic energies.

40. The system of claim 39, wherein the general equation for the radii of s electrons is given by
$${r}_{n} = \frac{\begin{matrix}\frac{{a}_{0} ( 1 + ( C - D ) \frac{\sqrt{3}}{2 Z} )}{( ( Z - ( n - 1 ) ) - ( \frac{A}{8} - \frac{B}{2 Z} ) \frac{\sqrt{3}}{{r}_{m}} )} \pm \\ {a}_{0} \sqrt{\begin{matrix}{( \frac{( 1 + ( C - D ) \frac{\sqrt{3}}{2 Z} )}{( ( Z - ( n - 1 ) ) - ( \frac{A}{8} - \frac{B}{2 Z} ) \frac{\sqrt{3}}{{r}_{m}} )} )}^{2} + \\ \frac{20 \sqrt{3} ( [ \frac{Z - n}{Z - ( n - 1 )} ] {Er}_{m} )}{( ( Z - ( n - 1 ) ) - ( \frac{A}{8} - \frac{B}{2 Z} ) \frac{\sqrt{3}}{{r}_{m}} )}\end{matrix}}\end{matrix}}{2}$$
$${r}_{m} in units of {a}_{0}$$
where positive root must be taken in order that rₙ>0;
Z is the nuclear charge, n is the number of electrons,
rₘ is the radius of the proceeding filled shell(s) given by
$${r}_{n} = \frac{\begin{matrix}\frac{{a}_{0} ( 1 + ( C - D ) \frac{\sqrt{3}}{2 Z} )}{( ( Z - ( n - 1 ) ) - ( \frac{A}{8} - \frac{B}{2 Z} ) \frac{\sqrt{3}}{{r}_{m}} )} \pm \\ {a}_{0} \sqrt{\begin{matrix}{( \frac{( 1 + ( C - D ) \frac{\sqrt{3}}{2 Z} )}{( ( Z - ( n - 1 ) ) - ( \frac{A}{8} - \frac{B}{2 Z} ) \frac{\sqrt{3}}{{r}_{m}} )} )}^{2} + \\ \frac{20 \sqrt{3} ( [ \frac{Z - n}{Z - ( n - 1 )} ] {Er}_{m} )}{( ( Z - ( n - 1 ) ) - ( \frac{A}{8} - \frac{B}{2 Z} ) \frac{\sqrt{3}}{{r}_{m}} )}\end{matrix}}\end{matrix}}{2}$$
$${r}_{m} in units of {a}_{0}$$
for the preceding s shell(s);
$${r}_{n} = \frac{\begin{matrix}\frac{{a}_{0}}{( ( Z - ( n - 1 ) ) - ( \frac{A}{8} - \frac{B}{2 Z} ) \frac{\sqrt{3}}{{r}_{3}} )} \pm \\ {a}_{0} \sqrt{\begin{matrix}{( \frac{1}{( ( Z - ( n - 1 ) ) - ( \frac{A}{8} - \frac{B}{2 Z} ) \frac{\sqrt{3}}{{r}_{3}} )} )}^{2} + \\ \frac{20 \sqrt{3} ( [ \frac{Z - n}{Z - ( n - 1 )} ] ( 1 - \frac{\sqrt{2}}{2} ) {r}_{3} )}{( ( Z - ( n - 1 ) ) - ( \frac{A}{8} - \frac{B}{2 Z} ) \frac{\sqrt{3}}{{r}_{3}} )}\end{matrix}}\end{matrix}}{2}$$
$${r}_{3} in units of {a}_{0}$$
for the 2p shell and
$${r}_{n} = \frac{\begin{matrix}\frac{{a}_{0}}{( ( Z - ( n - 1 ) ) - ( \frac{A}{8} - \frac{B}{2 Z} ) \frac{\sqrt{3}}{{r}_{12}} )} \pm \\ {a}_{0} \sqrt{\begin{matrix}{( \frac{1}{( ( Z - ( n - 1 ) ) - ( \frac{A}{8} - \frac{B}{2 Z} ) \frac{\sqrt{3}}{{r}_{12}} )} )}^{2} + \\ \frac{20 \sqrt{3} ( [ \frac{Z - n}{Z - ( n - 1 )} ] ( 1 - \frac{\sqrt{2}}{2} + \frac{1}{2} ) {r}_{12} )}{( ( Z - ( n - 1 ) ) - ( \frac{A}{8} - \frac{B}{2 Z} ) \frac{\sqrt{3}}{{r}_{12}} )}\end{matrix}}\end{matrix}}{2}$$
$${r}_{12} in units of {a}_{0}$$
for the 3p shell;
the parameter A corresponds to the diamagnetic force, F_{diamagnetic}:
$${F}_{diamagnetic} = \frac{{ℏ}^{2}}{4 {m}_{e} {r}_{3}^{2} {r}_{1}} \sqrt{s ( s + 1 )} {i}_{r} ;$$
the parameter B corresponds to the paramagnetic force, F_{mag 2}:
$${F}_{mag 2} = \frac{1}{Z} \frac{{ℏ}^{2}}{{m}_{e} {r}_{1} {r}_{4}^{2}} \sqrt{s ( s + 1 )} {i}_{r} ;$$
the parameter C corresponds to the diamagnetic force, F_{diamagnetic 3}:
$${F}_{diamagnetic 3} = - \frac{1}{Z} \frac{8 {ℏ}^{2}}{{m}_{e} {r}_{11}^{3}} \sqrt{s ( s + 1 )} {i}_{r} ;$$
the parameter D corresponds to the paramagnetic force, F_{mag}:
$${F}_{mag} = \frac{1}{4 π {r}_{2}^{2}} \frac{1}{Z} \frac{{ℏ}^{2}}{{m}_{e} {r}^{3}} \sqrt{s ( s + 1 )} ,$$
and
the parameter E corresponds to the diamagnetic force, F_{diamagnetic 2}, due to a relativistic effect with an electric field for r>rₙ:
$${F}_{diamagnetic 2} = - [ \frac{Z - 3}{Z - 2} ] \frac{{r}_{1} {ℏ}^{2}}{{m}_{e} {r}_{3}^{4}} 10 \sqrt{3 / 4} {i}_{r}$$
$${F}_{diamagnetic 2} = - [ \frac{Z - 11}{Z - 10} ] ( 1 + \frac{\sqrt{2}}{2} ) \frac{{r}_{10} {ℏ}^{2}}{{m}_{e} {r}_{11}^{4}} 10 \sqrt{s ( s + 1 )} {i}_{r} , \\ and$$
$${F}_{diamagnetic 2} = - [ \frac{Z - n}{Z - ( n - 1 )} ] ( 1 - \frac{\sqrt{2}}{2} + \frac{1}{2} - \frac{\sqrt{2}}{2} + \frac{1}{2} ) \frac{{r}_{18} {ℏ}^{2}}{{m}_{e} {r}_{n}^{4}} 10 \sqrt{s ( s + 1 )} {i}_{r} .$$
wherein the parameters of atoms filling the 1s, 2s, 3s, and 4s orbitals are

| | | | Orbital | Diamag. | Paramag. | Diamag. | Paramag. | Diamag. |
|---|---|---|---|---|---|---|---|---|
| | | Ground | Arrangement | Force | Force | Force | Force | Force |
| Atom | Electron | State | of s Electrons | Factor | Factor | Factor | Factor | Factor |
| Type | Configuration | Term^{a} | (s state) | A | B | C | D | E |
| Neutral 1 e Atom H | 1s¹ | ²S_{1/2} | $\frac{↑}{1 s}$ | 0 | 0 | 0 | 0 | 0 |
| Neutral 2 e Atom He | 1s² | ¹S₀ | $\frac{↑ ↓}{1 s}$ | 0 | 0 | 0 | 1 | 0 |
| Neutral 3 e Atom Li | 2s¹ | ²S_{1/2} | $\frac{↑}{2 s}$ | 1 | 0 | 0 | 0 | 0 |
| Neutral 4 e Atom Be | 2s² | ¹S₀ | $\frac{↑ ↓}{2 s}$ | 1 | 0 | 0 | 1 | 0 |
| Neutral 11 e Atom Na | 1s²2s²2p⁶3s¹ | ²S_{1/2} | $\frac{↑}{3 s}$ | 1 | 0 | 8 | 0 | 0 |
| Neutral 12 e Atom Mg | 1s²2s²2p⁶3s² | ¹S₀ | $\frac{↑ ↓}{3 s}$ | 1 | 3 | 12 | 1 | 0 |
| Neutral 19 e Atom K | 1s²2s²2p⁶3s²3p⁶4s¹ | ²S_{1/2} | $\frac{↑}{4 s}$ | 2 | 0 | 12 | 0 | 0 |
| Neutral 20 e Atom Ca | 1s²2s²2p⁶3s²3p⁶4s² | ¹S₀ | $\frac{↑ ↓}{4 s}$ | 1 | 3 | 24 | 1 | 0 |
| 1 e Ion | 1s¹ | ²S_{1/2} | $\frac{↑}{1 s}$ | 0 | 0 | 0 | 0 | 0 |
| 2 e Ion | 1s² | ¹S₀ | $\frac{↑ ↓}{1 s}$ | 0 | 0 | 0 | 1 | 0 |
| 3 e Ion | 2s¹ | ²S_{1/2} | $\frac{↑}{2 s}$ | 1 | 0 | 0 | 0 | 1 |
| 4 e Ion | 2s² | ¹S₀ | $\frac{↑ ↓}{2 s}$ | 1 | 0 | 0 | 1 | 1 |
| 11 e Ion | 1s²2s²2p⁶3s¹ | ²S_{1/2} | $\frac{↑}{3 s}$ | 1 | 4 | 8 | 0 | $1 + \frac{\sqrt{2}}{2}$ |
| 12 e Ion | 1s²2s²2p⁶3s² | ¹S₀ | $\frac{↑ ↓}{3 s}$ | 1 | 6 | 0 | 0 | $1 + \frac{\sqrt{2}}{2}$ |
| 19 e Ion | 1s²2s²2p⁶3s²3p⁶4s¹ | ²S_{1/2} | $\frac{↑}{4 s}$ | 3 | 0 | 24 | 0 | 2 − \sqrt{2} |
| 20 e Ion | 1s²2s²2p⁶3s²3p⁶4s² | ¹S₀ | $\frac{↑ ↓}{4 s}$ | 2 | 0 | 24 | 0 | 2 − \sqrt{2} |

41. The system of claim 40, with the radii, rₙ, wherein the ionization energy for atoms having an outer s-shell are given by the negative of the electric energy, E(electric), given by:
$$E ( Ionization ) = - Electric Energy = \frac{( Z - ( n - 1 ) ) {e}^{2}}{8 π {ɛ}_{o} {r}_{n}}$$
except that minor corrections due to the magnetic energy must be included in cases wherein the s electron does not couple to p electrons as given by
$$Ionization Energy ( He ) = - E ( electric ) + E ( magnetic ) ( 1 - \frac{1}{2} ( {( \frac{2}{3} cos \frac{π}{3} )}^{2} + α ) )$$
$$Ionization Energy = - Electric Energy - \frac{1}{Z} Magnetic Energy$$
$$\begin{matrix} E ( ionization ; Li ) = \frac{( Z - 2 ) {e}^{2}}{8 π {ɛ}_{o} {r}_{3}} + Δ {E}_{mag} \\ = 5.3178 eV + 0.0860 eV \\ = 5.4038 eV\end{matrix}$$
$$E ( Ionization ) = E ( Electric ) + {E}_{T}$$
$$\begin{matrix} E ( ionization ; Be ) = \frac{( Z - 3 ) {e}^{2}}{8 π {ɛ}_{o} {r}_{4}} + \frac{2 π {μ}_{0} {e}^{2} {ℏ}^{2}}{{m}_{e}^{2} {r}_{4}^{3}} + Δ {E}_{mag} \\ = 8.9216 eV + 0.03226 eV + 0.33040 eV \\ = 9.28430 eV ,\end{matrix}$$
$$and$$
$$E ( Ionization ) = - Electric Energy - \frac{1}{Z} Magnetic Energy - {E}_{T} .$$

42. The system of claim 41, wherein the radii and energies of the 2p electrons are solved using the forces given by
$${F}_{ele} = \frac{( Z - n ) {e}^{2}}{4 {πɛ}_{o} {r}_{n}^{2}} {i}_{r}$$
$${F}_{diamagnetic} = - {\sum }_{m} \frac{( l + \vert m \vert ) !}{( 2 l + 1 ) ( l - \vert m \vert ) !} \frac{{ℏ}^{2}}{4 {m}_{e} {r}_{n}^{2} {r}_{3}} \sqrt{s ( s + 1 )} {i}_{r}$$
$${F}_{mag 2} = \frac{1}{Z} \frac{{ℏ}^{2}}{{m}_{e} {r}_{n}^{2} {r}_{3}} \sqrt{s ( s + 1 )} {i}_{r}$$
$${F}_{mag 2} = \frac{1}{Z} \frac{4 {ℏ}^{2}}{{m}_{e} {r}_{n}^{2} {r}_{3}} \sqrt{s ( s + 1 )} {i}_{r}$$
$${F}_{mag 2} = \frac{1}{Z} \frac{{ℏ}^{2}}{{m}_{e} {r}_{n}^{2} {r}_{3}} \sqrt{s ( s + 1 )} {i}_{r}$$
$${F}_{diamagnetic 2} = - [ \frac{Z - n}{Z - ( n - 1 )} ] ( 1 - \frac{\sqrt{2}}{2} ) \frac{{r}_{3} {ℏ}^{2}}{{m}_{e} {r}_{n}^{4}} 10 \sqrt{s ( s + 1 )} {i}_{r} ,$$
and the radii r₃ are given by
$${r}_{4} = {r}_{3} = \frac{( \begin{matrix}\frac{{a}_{0} ( 1 - \frac{\sqrt{\frac{3}{4}}}{Z} )}{( ( Z - 3 ) - ( \frac{1}{4} - \frac{1}{Z} ) \frac{\sqrt{\frac{3}{4}}}{{r}_{1}} )} \pm {a}_{0} \\ \sqrt{\frac{{( 1 - \frac{\sqrt{\frac{3}{4}}}{Z} )}^{2}}{{( ( Z - 3 ) - ( \frac{1}{4} - \frac{1}{Z} ) \frac{\sqrt{\frac{3}{4}}}{{r}_{1}} )}^{2}} + 4 \frac{[ \frac{Z - 3}{Z - 2} ] {r}_{1} 10 \sqrt{\frac{3}{4}}}{( ( Z - 3 ) - ( \frac{1}{4} - \frac{1}{Z} ) \frac{\sqrt{\frac{3}{4}}}{{r}_{1}} )}}\end{matrix} ) }{2}$$
$${r}_{1} in units of {a}_{0}$$

43. The system of claim 42, wherein the electric energy given by
$$E ( Ionization ) = - Electric Energy = \frac{( Z - ( n - 1 ) ) {e}^{2}}{8 {πɛ}_{o} {r}_{n}}$$
gives the corresponding ionization energies.

44. The system of claim 43, wherein for each n-electron atom having a central charge of Z times that of the proton and an electron configuration 1s²2s²2pⁿ⁻⁴, there are two indistinguishable spin-paired electrons in an orbitsphere with radii r₁ and r₂ both given by:
$${r}_{1} = {r}_{2} = {a}_{0} [ \frac{1}{Z - 1} - \frac{\sqrt{\frac{3}{4}}}{Z ( Z - 1 )} ] ;$$
two indistinguishable spin-paired electrons in an orbitsphere with radii r₃ and r₄ both given by:
$${r}_{4} = {r}_{3} = \frac{( \begin{matrix}\frac{{a}_{0} ( 1 - \frac{\sqrt{\frac{3}{4}}}{Z} )}{( ( Z - 3 ) - ( \frac{1}{4} - \frac{1}{Z} ) \frac{\sqrt{\frac{3}{4}}}{{r}_{1}} )} \pm {a}_{o} \\ \sqrt{\frac{{( 1 - \frac{\sqrt{\frac{3}{4}}}{Z} )}^{2}}{{( \begin{matrix}( Z - 3 ) - ( \frac{1}{4} - \frac{1}{Z} ) \\ \frac{\sqrt{\frac{3}{4}}}{{r}_{1}}\end{matrix} )}^{2}} + 4 \frac{[ \frac{Z - 3}{Z - 2} ] {r}_{1} 10 \sqrt{\frac{3}{4}}}{( \begin{matrix}( Z - 3 ) - ( \frac{1}{4} - \frac{1}{Z} ) \\ \frac{\sqrt{\frac{3}{4}}}{{r}_{1}}\end{matrix} )} }\end{matrix} )}{2}$$
$${r}_{1} in units of {a}_{o}$$
and n−4 electrons in an orbitsphere with radius rₙ given by
$${r}_{n} = \frac{\frac{{a}_{0}}{( \begin{matrix}( Z - ( n - 1 ) ) - \\ ( \frac{A}{8} - \frac{B}{2 Z} ) \frac{\sqrt{3}}{{r}_{3}}\end{matrix} )} \pm {a}_{0} \sqrt{\begin{matrix}{( \frac{1}{( ( Z - ( n - 1 ) ) - ( \frac{A}{8} - \frac{B}{2 Z} ) \frac{\sqrt{3}}{{r}_{3}} )} )}^{2} + \\ \frac{20 \sqrt{3} ( [ \frac{Z - n}{Z - ( n - 1 )} ] ( 1 - \frac{\sqrt{2}}{2} ) {r}_{3} )}{( ( Z - ( n - 1 ) ) - ( \frac{A}{8} - \frac{B}{2 Z} ) \frac{\sqrt{3}}{{r}_{3}} )}\end{matrix}}}{2} ;$$
$${r}_{3 } in units of {a}_{0}$$
the positive root must be taken in order that rₙ>0;
the parameter A corresponds to the diamagnetic force, F_{diamagnetic}:
$${F}_{diamagnetic} = - {\sum }_{m} \frac{( l + \vert m \vert ) !}{( 2 l + 1 ) ( l - \vert m \vert ) !} \frac{{ℏ}^{2}}{4 {m}_{e} {r}_{n}^{2} {r}_{3}} \sqrt{s ( s + 1 )} {i}_{r} ;$$
and the parameter B corresponds to the paramagnetic force, F_{mag 2}:
$${F}_{mag 2} = \frac{1}{Z} \frac{{ℏ}^{2}}{{m}_{e} {r}_{n}^{2} {r}_{3}} \sqrt{s ( s + 1 )} {i}_{r} , \\ {F}_{mag 2} = \frac{1}{Z} \frac{4 {ℏ}^{2}}{{m}_{e} {r}_{n}^{2} {r}_{3}} \sqrt{s ( s + 1 )} {i}_{r} , \\ and$$
$${F}_{mag 2} = \frac{1}{Z} \frac{{ℏ}^{2}}{{m}_{e} {r}_{n}^{2} {r}_{3}} \sqrt{s ( s + 1 )} {i}_{r}$$
wherein the Parameters of five through ten-electron atoms are

| | | | Orbital | Diamagnetic | Paramagnetic |
|---|---|---|---|---|---|
| | | Ground | Arrangement of | Force | Force |
| | Electron | State | 2p Electrons | Factor | Factor |
| Atom Type | Configuration | Term | (2p state) | A | B |
| Neutral 5 e Atom B | 1s²2s²2p¹ | ²P_{1/2}⁰ | $\frac{↑}{1} \frac{ }{0} \frac{ }{- 1}$ | 2 | 0 |
| Neutral 6 e Atom C | 1s²2s²2p² | ³P₀ | $\frac{↑}{1} \frac{↑}{0} \frac{ }{- 1}$ | $\frac{2}{3}$ | 0 |
| Neutral 7 e Atom N | 1s²2s²2p³ | ⁴S_{3/2}⁰ | $\frac{↑}{1} \frac{↑}{0} \frac{↑}{- 1}$ | $\frac{1}{3}$ | 1 |
| Neutral 8 e Atom O | 1s²2s²2p⁴ | ³P₂ | $\frac{↑ ↓}{1} \frac{↑}{0} \frac{↑}{- 1}$ | 1 | 2 |
| Neutral 9 e Atom F | 1s²2s²2p⁵ | ²P_{3/2}⁰ | $\frac{↑ ↓}{1} \frac{↑ ↓}{0} \frac{↑}{- 1}$ | $\frac{2}{3}$ | 3 |
| Neutral 10 e Atom Ne | 1s²2s²2p⁶ | ¹S₀ | $\frac{↑ ↓}{1} \frac{↑ ↓}{0} \frac{↑ ↓}{- 1}$ | 0 | 3 |
| 5 e Ion | 1s²2s²2p¹ | ²P_{1/2}⁰ | $\frac{↑}{1} \frac{ }{0} \frac{ }{- 1}$ | $\frac{5}{3}$ | 1 |
| 6 e Ion | 1s²2s²2p² | ³P₀ | $\frac{↑}{1} \frac{↑}{0} \frac{ }{- 1}$ | $\frac{5}{3}$ | 4 |
| 7 e Ion | 1s²2s²2p³ | ⁴S_{3/2}⁰ | $\frac{↑}{1} \frac{↑}{0} \frac{↑}{- 1}$ | $\frac{5}{3}$ | 6 |
| 8 e Ion | 1s²2s²2p⁴ | ³P₂ | $\frac{↑ ↓}{1} \frac{↑}{0} \frac{↑}{- 1}$ | $\frac{5}{3}$ | 6 |
| 9 e Ion | 1s²2s²2p⁵ | ²P_{3/2}⁰ | $\frac{↑ ↓}{1} \frac{↑ ↓}{0} \frac{↑}{- 1}$ | $\frac{5}{3}$ | 9 |
| 10 e Ion | 1s²2s²2p⁶ | ¹S₀ | $\frac{↑ ↓}{1} \frac{↑ ↓}{0} \frac{↑ ↓}{- 1}$ | $\frac{5}{3}$ | 12 |

45. The system of claim 44, wherein the ionization energy for the boron atom is given by
$$\begin{matrix}E ( ionization ; B ) = \frac{( Z - 4 ) {e}^{2}}{8 {πɛ}_{o} {r}_{5}} + Δ {E}_{mag} \\ = 8.147170901 eV + 0.15548501 eV \\ = 8.30265592 eV .\end{matrix}$$

46. The system of claim 44, wherein the ionization energies for the n-electron atoms having the radii, rₙ,are given by the negative of the electric energy, E(electric), given by
$$E ( Ionization ) = - Electric Energy = \frac{( Z - ( n - 1 ) ) {e}^{2}}{8 {πɛ}_{o} {r}_{n}} .$$

47. The system of claim 1, wherein the radii of the 3p electrons are given using the forces given by
$${F}_{ele} = \frac{( Z - n ) {e}^{2}}{4 {πɛ}_{o} {r}_{n}^{2}} {i}_{r}$$
$${F}_{diamagnetic} = - {\sum }_{m} \frac{( l + \vert m \vert ) !}{( 2 l + 1 ) ( l - \vert m \vert ) !} \frac{{ℏ}^{2}}{4 {m}_{e} {r}_{n}^{2} {r}_{12}} \sqrt{s ( s + 1 )} {i}_{r}$$
$$\begin{matrix}{F}_{diamagnetic} = - ( \frac{2}{3} + \frac{2}{3} + \frac{1}{3} ) \frac{{ℏ}^{2}}{4 {m}_{e} {r}_{n}^{2} {r}_{12}} \sqrt{s ( s + 1 )} {i}_{r} \\ = - ( \frac{5}{3} ) \frac{{ℏ}^{2}}{4 {m}_{e} {r}_{n}^{2} {r}_{12}} \sqrt{s ( s + 1 )} {i}_{r}\end{matrix}$$
$${F}_{mag 2} = \frac{1}{Z} \frac{{ℏ}^{2}}{{m}_{e} {r}_{n}^{2} {r}_{12}} \sqrt{s ( s + 1 )} {i}_{r}$$
$$\begin{matrix}{F}_{mag 2} = ( 4 + 4 + 4 ) \frac{1}{Z} \frac{4 {ℏ}^{2}}{{m}_{e} {r}_{n}^{2} {r}_{12}} \sqrt{s ( s + 1 )} {i}_{r} \\ = \frac{1}{Z} \frac{12 {ℏ}^{2}}{{m}_{e} {r}_{n}^{2} {r}_{12}} \sqrt{s ( s + 1 )} {i}_{r}\end{matrix}$$
$${F}_{mag 2} = \frac{1}{Z} \frac{4 {ℏ}^{2}}{{m}_{e} {r}_{n}^{2} {r}_{12}} \sqrt{s ( s + 1 )} {i}_{r}$$
$${F}_{mag 2} = \frac{1}{Z} \frac{4 {ℏ}^{2}}{{m}_{e} {r}_{n}^{2} {r}_{12}} \sqrt{s ( s + 1 )} {i}_{r}$$
$${F}_{mag 2} = \frac{1}{Z} \frac{8 {ℏ}^{2}}{{m}_{e} {r}_{n}^{2} {r}_{12}} \sqrt{s ( s + 1 )} {i}_{r}$$
and the radii r₁₂ are given by
$${r}_{12} = \frac{\frac{{a}_{0}}{( \begin{matrix}( Z - 11 ) - \\ ( \frac{1}{8} - \frac{3}{Z} ) \frac{\sqrt{3}}{{r}_{10}}\end{matrix} )} \pm {a}_{0} \sqrt{{( \frac{1}{( ( Z - 11 ) - ( \frac{1}{8} - \frac{3}{Z} ) \frac{\sqrt{3}}{{r}_{10}} )} )}^{2} + \\ \frac{20 \sqrt{3} ( [ \frac{Z - 12}{Z - 11} ] ( 1 + \frac{\sqrt{2}}{2} ) {r}_{10} )}{( ( Z - 11 ) - ( \frac{1}{8} - \frac{3}{Z} ) \frac{\sqrt{3}}{{r}_{10}} )}}}{2}$$
$${r}_{10} in units of {a}_{0}$$

48. The system of claim 47, wherein the ionization energies are given by electric energy given by:
$$E ( Ionization ) = - Electric Energy = \frac{( Z - ( n - 1 ) ) {e}^{2}}{8 {πɛ}_{o} {r}_{n}} .$$

49. The system of claim 1, wherein for each n-electron atom having a central charge of Z times that of the proton and an electron configuration 1S²2s²2p⁶3s²3pⁿ⁻¹², there are two indistinguishable spin-paired electrons in an orbitsphere with radii r₁ and r₂ both given by:
$${r}_{1} = {r}_{2} = {a}_{o} [ \frac{1}{Z - 1} - \frac{\sqrt{\frac{3}{4}}}{Z ( Z - 1 )} ]$$
two indistinguishable spin-paired electrons in an orbitsphere with radii r₃ and r₄ both given by:
$${r}_{4} = {r}_{3} = \frac{( \begin{matrix}\frac{{a}_{0} ( 1 - \frac{\sqrt{\frac{3}{4}}}{Z} )}{( ( Z - 3 ) - ( \frac{1}{4} - \frac{1}{Z} ) \frac{\sqrt{\frac{3}{4}}}{{r}_{1}} )} \pm {a}_{o} \\ \sqrt{\frac{{( 1 - \frac{\sqrt{\frac{3}{4}}}{Z} )}^{2}}{{( \begin{matrix}( Z - 3 ) - ( \frac{1}{4} - \frac{1}{Z} ) \\ \frac{\sqrt{\frac{3}{4}}}{{r}_{1}}\end{matrix} )}^{2}} + 4 \frac{[ \frac{Z - 3}{Z - 2} ] {r}_{1} 10 \sqrt{\frac{3}{4}}}{( \begin{matrix}( Z - 3 ) - ( \frac{1}{4} - \frac{1}{Z} ) \\ \frac{\sqrt{\frac{3}{4}}}{{r}_{1}}\end{matrix} )} }\end{matrix} )}{2}$$
$${r}_{1} in units of {a}_{o}$$
three sets of paired indistinguishable electrons in an orbitsphere with radius r₁₀ given by:
$${r}_{10} = \frac{\frac{{a}_{0}}{( \begin{matrix}( Z - 9 ) - \\ ( \frac{5}{24} - \frac{6}{Z} ) \frac{\sqrt{3}}{{r}_{3}}\end{matrix} )} \pm {a}_{0} \sqrt{{( \frac{1}{( ( Z - 9 ) - ( \frac{5}{24} - \frac{6}{Z} ) \frac{\sqrt{3}}{{r}_{3}} )} )}^{2} + \\ \frac{20 \sqrt{3} ( [ \frac{Z - 10}{Z - 9} ] ( 1 + \frac{\sqrt{2}}{2} ) {r}_{3} )}{( ( Z - 9 ) - ( \frac{5}{24} - \frac{6}{Z} ) \frac{\sqrt{3}}{{r}_{3}} )}}}{2}$$
$${r}_{3} in units of {a}_{0}$$
two indistinguishable spin-paired electrons in an orbitsphere with radius r₁₂ given by:
$${r}_{12} = \frac{\frac{{a}_{0}}{( \begin{matrix}( Z - 11 ) - \\ ( \frac{1}{8} - \frac{3}{Z} ) \frac{\sqrt{3}}{{r}_{10}}\end{matrix} )} \pm {a}_{0} \sqrt{\begin{matrix}{( \frac{1}{\begin{matrix}( Z - 11 ) - \\ ( \frac{1}{8} - \frac{3}{Z} ) \frac{\sqrt{3}}{{r}_{10}}\end{matrix}} )}^{2} + \\ \frac{20 \sqrt{3} ( [ \frac{Z - 12}{Z - 11} ] ( 1 + \frac{\sqrt{2}}{2} ) {r}_{10} )}{( ( Z - 11 ) - ( \frac{1}{8} - \frac{3}{Z} ) \frac{\sqrt{3}}{{r}_{10}} )}\end{matrix}}}{2}$$
$${r}_{10} in units of {a}_{0}$$
and n−12 electrons in a 3p orbitsphere with radius rₙ given by
$${r}_{n} = \frac{\frac{{a}_{0}}{( \begin{matrix}( Z - ( n - 1 ) ) - \\ ( \frac{A}{8} - \frac{B}{2 Z} ) \frac{\sqrt{3}}{{r}_{12}}\end{matrix} )} \pm {a}_{0} \sqrt{\begin{matrix}{( \frac{1}{\begin{matrix}( Z - ( n - 1 ) ) - \\ ( \frac{A}{8} - \frac{B}{2 Z} ) \frac{\sqrt{3}}{{r}_{12}}\end{matrix}} )}^{2} + \\ \frac{20 \sqrt{3} ( \begin{matrix}[ \frac{Z - n}{Z - ( n - 1 )} ] \\ ( 1 - \frac{\sqrt{2}}{2} + \frac{1}{2} ) {r}_{12}\end{matrix} )}{( \begin{matrix}( Z - ( n - 1 ) ) - \\ ( \frac{A}{8} - \frac{B}{2 Z} ) \frac{\sqrt{3}}{{r}_{12}}\end{matrix} )}\end{matrix}}}{2}$$
$${r}_{12} in units of {a}_{0}$$
where the positive root must be taken in order that rₙ>0;
the parameter A corresponds to the diamagnetic force, F_{diamagnetic},
$${F}_{diamagnetic} = - {\sum }_{m} \frac{( l + \vert m \vert ) !}{( 2 l + 1 ) ( l - \vert m \vert ) !} \frac{{ℏ}^{2}}{4 {m}_{e} {r}_{n}^{2} {r}_{12}} \sqrt{s ( s + 1 )} {i}_{r} ,$$
and the parameter B corresponds to the paramagnetic force, F_{mag 2}:
$${F}_{mag 2} = \frac{1}{Z} \frac{{ℏ}^{2}}{{m}_{e} {r}_{n}^{2} {r}_{12}} \sqrt{s ( s + 1 )} {i}_{r}$$
$$\begin{matrix}{F}_{mag 2} = ( 4 + 4 + 4 ) \frac{1}{Z} \frac{{ℏ}^{2}}{{m}_{e} {r}_{n}^{2} {r}_{12}} \sqrt{s ( s + 1 )} {i}_{r} \\ = \frac{1}{Z} \frac{12 {ℏ}^{2}}{{m}_{e} {r}_{n}^{2} {r}_{12}} \sqrt{s ( s + 1 )} {i}_{r}\end{matrix}$$
$${F}_{mag 2} = \frac{1}{Z} \frac{4 {ℏ}^{2}}{{m}_{e} {r}_{n}^{2} {r}_{12}} \sqrt{s ( s + 1 )} {i}_{r}$$
$${F}_{mag 2} = \frac{1}{Z} \frac{4 {ℏ}^{2}}{{m}_{e} {r}_{n}^{2} {r}_{12}} \sqrt{s ( s + 1 )} {i}_{r} , \\ and$$
$${F}_{mag 2} = \frac{1}{Z} \frac{8 {ℏ}^{2}}{{m}_{e} {r}_{n}^{2} {r}_{12}} \sqrt{s ( s + 1 )} {i}_{r}$$
wherein the parameters of thirteen through eighteen-electron atoms are

| | | | Orbital | Diamagnetic | Paramagnetic |
|---|---|---|---|---|---|
| | | Ground | Arrangement of | Force | Force |
| | Electron | State | 3p Electrons | Factor | Factor |
| Atom Type | Configuration | Term | (3p state) | A | B |
| Neutral 13 e Atom Al | 1s²2s²2p⁶3s²3p¹ | ²P_{1/2}⁰ | $\frac{↑}{1} \frac{ }{0} \frac{ }{- 1}$ | $\frac{11}{3}$ | 0 |
| Neutral 14 e Atom Si | 1s²2s²2p⁶3s²3p² | ³P₀ | $\frac{↑}{1} \frac{↑}{0} \frac{ }{- 1}$ | $\frac{7}{3}$ | 0 |
| Neutral 15 e Atom P | 1s²2s²2p⁶3s²3p³ | ⁴S_{3/2}⁰ | $\frac{↑}{1} \frac{↑}{0} \frac{↑}{- 1}$ | $\frac{5}{3}$ | 2 |
| Neutral 16 e Atom S | 1s²2s²2p⁶3s²3p⁴ | ³P₂ | $\frac{↑ ↓}{1} \frac{↑}{0} \frac{↑}{- 1}$ | $\frac{4}{3}$ | 1 |
| Neutral 17 e Atom Cl | 1s²2s²2p⁶3s²3p⁵ | ²P_{3/2}⁰ | $\frac{↑ ↓}{1} \frac{↑ ↓}{0} \frac{↑}{- 1}$ | $\frac{2}{3}$ | 2 |
| Neutral 18 e Atom Ar | 1s²2s²2p⁶3s²3p⁶ | ¹S₀ | $\frac{↑ ↓}{1} \frac{↑ ↓}{0} \frac{↑ ↓}{- 1}$ | $\frac{1}{3}$ | 4 |
| 13 e Ion | 1s²2s²2p⁶3s²3p¹ | ²P_{1/2}⁰ | $\frac{↑}{1} \frac{ }{0} \frac{ }{- 1}$ | $\frac{5}{3}$ | 12 |
| 14 e Ion | 1s²2s²2p⁶3s²3p² | ³P₀ | $\frac{↑}{1} \frac{↑}{0} \frac{ }{- 1}$ | $\frac{1}{3}$ | 16 |
| 15 e Ion | 1s²2s²2p⁶3s²3p³ | ⁴S_{3/2}⁰ | $\frac{↑}{1} \frac{↑}{0} \frac{↑}{- 1}$ | 0 | 24 |
| 16 e Ion | 1s²2s²2p⁶3s²3p⁴ | ³P₂ | $\frac{↑ ↓}{1} \frac{↑}{0} \frac{↑}{- 1}$ | $\frac{1}{3}$ | 24 |
| 17 e Ion | 1s²2s²2p⁶3s²3p⁵ | ²P_{3/2}⁰ | $\frac{↑ ↓}{1} \frac{↑ ↓}{0} \frac{↑}{- 1}$ | $\frac{2}{3}$ | 32 |
| 18 e Ion | 1s²2s²2p⁶3s²3p⁶ | ¹S₀ | $\frac{↑ ↓}{1} \frac{↑ ↓}{0} \frac{↑ ↓}{- 1}$ | 0 | 40 |

50. The system of claim 49, wherein the ionization energies for the n-electron 3p atoms are given by electric energy given by:
$$E ( Ionization ) = - Electric Energy = \frac{( Z - ( n - 1 ) ) {e}^{2}}{8 {πɛ}_{o} {r}_{n}} .$$

51. The system of claim 50, wherein the ionization energy for the aluminum atom is given by
$$\begin{matrix}E ( ionization ; Al ) = \frac{( Z - 12 ) {e}^{2}}{8 {πɛ}_{o} {r}_{13}} + Δ {E}_{mag} \\ = 5.95270 eV + 0.031315 eV \\ = 5.98402 eV .\end{matrix}$$

52. A system of computing the nature of bound atomic and atomic ionic electrons from physical solutions of the charge, mass, and current density functions of atoms and atomic ions, which solutions are derived from Maxwell's equations using a constraint that the bound electron(s) does not radiate under acceleration, comprising:
processing means for processing and solving the equations for charge, mass, and current density functions of electron(s) in selected atoms or ions, wherein the equations are derived from Maxwell's equations using a constraint that the bound electron(s) does not radiate under acceleration; and
output means for outputting the solutions of the charge, mass, and current density functions of the atoms and atomic ions.

53. A method comprising the steps of;
a.) inputting electron functions that are derived from Maxwell's equations using a constraint that the bound electron(s) does not radiate under acceleration;
b.) inputting a trial electron configuration;
c.) inputting the corresponding centrifugal, Coulombic, diamagnetic and paramagnetic forces,
d.) forming the force balance equation comprising the centrifugal force equal to the sum of the Coulombic, diamagnetic and paramagnetic forces;
e.) solving the force balance equation for the electron radii;
f.) calculating the energy of the electrons using the radii and the corresponding electric and magnetic energies;
g.) repeating Steps a-f for all possible electron configurations, and
h.) outputting the lowest energy configuration and the corresponding electron radii for that configuration.

54. The method of claim 53, wherein the output is rendered using the electron functions.

55. The method of claim 54, wherein the electron functions are given by at least one of the group comprising:
$$l = 0$$
$$ρ ( r , θ , φ , t ) = \frac{e}{8 π {r}^{2}} [ δ ( r - {r}_{n} ) ] [ {Y}_{0}^{0} ( θ , φ ) + {Y}_{l}^{m} ( θ , φ ) ]$$
$$l \neq 0 \\ ρ ( r , θ , φ , t ) = \frac{e}{4 π {r}^{2}} [ δ ( r - {r}_{n} ) ] [ {Y}_{0}^{0} ( θ , φ ) + Re \{ {Y}_{l}^{m} ( θ , φ ) {e}^{{iω}_{n} t} \} ]$$
where Yₗ^{m}(θ,φ) are the spherical harmonic functions that spin about the z-axis with angular frequency ωₙ with Y₀⁰(θ,φ) the constant function. Re{Yₗ^{m}(θ,φ)e^{iω}^{ₙ}^{t}}=Pₗ^{m}(cos θ)cos(mφ+ω′ₙt) where to keep the form of the spherical harmonic as a traveling wave about the z-axis, ω′ₙ=mωₙ.

56. The method of claim 55, wherein the forces are given by at least one of the group comprising:
$${F}_{ele} = \frac{( Z - n ) {e}^{2}}{4 {πɛ}_{o} {r}_{n}^{2}} {i}_{r}$$
$${F}_{ele} = \frac{( Z - ( n - 1 ) ) {e}^{2}}{4 {πɛ}_{o} {r}_{n}^{2}} {i}_{r}$$
$${F}_{mag} = \frac{1}{4 π {r}_{2}^{2}} \frac{1}{Z} \frac{{ℏ}^{2}}{{m}_{e} {r}^{3}} \sqrt{s ( s + 1 )}$$
$${F}_{diamagnetic} = - \frac{{ℏ}^{2}}{4 {m}_{e} {r}_{3}^{2} {r}_{1}} \sqrt{s ( s + 1 )} {i}_{r}$$
$${F}_{diamagnetic} = - {\sum }_{m} \frac{( l + \vert m \vert ) !}{( 2 l + 1 ) ( l - \vert m \vert ) !} \frac{{ℏ}^{2}}{4 {m}_{e} {r}_{n}^{2} {r}_{3}} \sqrt{s ( s + 1 )} {i}_{r}$$
$${F}_{diamagnetic} = - {\sum }_{m} \frac{( l + \vert m \vert ) !}{( 2 l + 1 ) ( l - \vert m \vert ) !} \frac{{ℏ}^{2}}{4 {m}_{e} {r}_{n}^{2} {r}_{12}} \sqrt{s ( s + 1 )} {i}_{r}$$
$$\begin{matrix}{F}_{diamagnetic} = - ( \frac{2}{3} + \frac{2}{3} + \frac{1}{3} ) \frac{{ℏ}^{2}}{4 {m}_{e} {r}_{n}^{2} {r}_{12}} \sqrt{s ( s + 1 )} {i}_{r} \\ = - ( \frac{5}{3} ) \frac{{ℏ}^{2}}{4 {m}_{e} {r}_{n}^{2} {r}_{12}} \sqrt{s ( s + 1 )} {i}_{r}\end{matrix}$$
$${F}_{diamagnetic 2} = - [ \frac{Z - 3}{Z - 2} ] \frac{{r}_{1} {ℏ}^{2}}{{m}_{e} {r}_{3}^{4}} 10 \sqrt{3 / 4} {i}_{r}$$
$${F}_{diamagnetic 2} = - [ \frac{Z - n}{Z - ( n - 1 )} ] ( 1 - \frac{\sqrt{2}}{2} ) \frac{{r}_{3} {ℏ}^{2}}{{m}_{e} {r}_{n}^{4}} 10 \sqrt{s ( s + 1 )} {i}_{r}$$
$${F}_{diamagnetic 2} = - [ \frac{Z - 11}{Z - 10} ] ( 1 + \frac{\sqrt{2}}{2} ) \frac{{r}_{10} {ℏ}^{2}}{{m}_{e} {r}_{11}^{4}} 10 \sqrt{s ( s + 1 )} {i}_{r}$$
$${F}_{diamagnetic 2} = - [ \frac{Z - n}{Z - ( n - 1 )} ] ( \begin{matrix}1 - \frac{\sqrt{2}}{2} + \frac{1}{2} - \\ \frac{\sqrt{2}}{2} + \frac{1}{2}\end{matrix} ) \frac{{r}_{18} {ℏ}^{2}}{{m}_{e} {r}_{n}^{4}} 10 \sqrt{s ( s + 1 )} {i}_{r}$$
$${F}_{diamagnetic 3} = - \frac{1}{Z} \frac{8 {ℏ}^{2}}{{m}_{e} {r}_{11}^{3}} \sqrt{s ( s + 1 )} {i}_{r}$$
$${F}_{mag 2} = \frac{1}{Z} \frac{{ℏ}^{2}}{{m}_{e} {r}_{n}^{2} {r}_{3}} \sqrt{s ( s + 1 )} {i}_{r}$$
$${F}_{mag 2} = \frac{1}{Z} \frac{4 {ℏ}^{2}}{{m}_{e} {r}_{n}^{2} {r}_{3}} \sqrt{s ( s + 1 )} {i}_{r}$$
$${F}_{mag 2} = \frac{1}{Z} \frac{{ℏ}^{2}}{{m}_{e} {r}_{1} {r}_{4}^{2}} \sqrt{s ( s + 1 )} {i}_{r}$$
$${F}_{mag 2} = \frac{1}{Z} \frac{{ℏ}^{2}}{{m}_{e} {r}_{n}^{2} {r}_{12}} \sqrt{s ( s + 1 )} {i}_{r}$$
$$\begin{matrix}{F}_{mag 2} = ( 4 + 4 + 4 ) \frac{1}{Z} \frac{{ℏ}^{2}}{{m}_{e} {r}_{n}^{2} {r}_{12}} \sqrt{s ( s + 1 )} {i}_{r} \\ = \frac{1}{Z} \frac{12 {ℏ}^{2}}{{m}_{e} {r}_{n}^{2} {r}_{12}} \sqrt{s ( s + 1 )} {i}_{r}\end{matrix}$$
$${F}_{mag 2} = \frac{1}{Z} \frac{4 {ℏ}^{2}}{{m}_{e} {r}_{n}^{2} {r}_{12}} \sqrt{s ( s + 1 )} {i}_{r} , \\ and$$
$${F}_{mag 2} = \frac{1}{Z} \frac{8 {ℏ}^{2}}{{m}_{e} {r}_{n}^{2} {r}_{12}} \sqrt{s ( s + 1 )} {i}_{r}$$

57. The method of claim 53, wherein the radii are given by at least one of the group comprising:
$${r}_{1} = {r}_{2} = {a}_{o} [ \frac{1}{Z - 1} - \frac{\sqrt{\frac{3}{4}}}{Z ( Z - 1 )} ]$$
$${r}_{4} = {r}_{3} = \frac{\frac{{a}_{0} ( 1 - \frac{\sqrt{\frac{3}{4}}}{Z} )}{( \begin{matrix}( Z - 3 ) - \\ ( \frac{1}{4} - \frac{1}{Z} ) \frac{\sqrt{\frac{3}{4}}}{{r}_{1}}\end{matrix} )} \pm {a}_{o} \sqrt{\begin{matrix}\frac{{( 1 - \frac{\sqrt{\frac{3}{4}}}{Z} )}^{2}}{( \begin{matrix}( Z - 3 ) - \\ ( \frac{1}{4} - \frac{1}{Z} ) \frac{\sqrt{\frac{3}{4}}}{{r}_{1}}\end{matrix} )} \\ \frac{[ \frac{Z - 3}{Z - 2} ] {r}_{1} 10 \sqrt{\frac{3}{4}}}{( \begin{matrix}( Z - 3 ) - \\ ( \frac{1}{4} - \frac{1}{Z} ) \frac{\sqrt{\frac{3}{4}}}{{r}_{1}}\end{matrix} )}\end{matrix} + 4}}{2}$$
$${r}_{1} in units of {a}_{o}$$
$${r}_{n} = \frac{\frac{{a}_{0}}{( \begin{matrix}( Z - ( n - 1 ) ) - \\ ( \frac{A}{8} - \frac{B}{2 Z} ) \frac{\sqrt{3}}{{r}_{3}}\end{matrix} )} \pm {a}_{0} \sqrt{\begin{matrix}{( \frac{1}{\begin{matrix}( Z - ( n - 1 ) ) - \\ ( \frac{A}{8} - \frac{B}{2 Z} ) \frac{\sqrt{3}}{{r}_{3}}\end{matrix}} )}^{2} + \\ \frac{20 \sqrt{3} ( \begin{matrix}[ \frac{Z - n}{Z - ( n - 1 )} ] \\ ( 1 - \frac{\sqrt{2}}{2} ) {r}_{3}\end{matrix} )}{( \begin{matrix}( Z - ( n - 1 ) ) - \\ ( \frac{A}{8} - \frac{B}{2 Z} ) \frac{\sqrt{3}}{{r}_{3}}\end{matrix} )}\end{matrix}}}{2}$$
$${r}_{3} in units of {a}_{0}$$
$${r}_{10} = \frac{\frac{{a}_{0}}{( \begin{matrix}( Z - 9 ) - \\ ( \frac{5}{24} - \frac{6}{Z} ) \frac{\sqrt{3}}{{r}_{3}}\end{matrix} )} \pm {a}_{0} \sqrt{\begin{matrix}{( \frac{1}{\begin{matrix}( Z - 9 ) - \\ ( \frac{5}{24} - \frac{6}{Z} ) \frac{\sqrt{3}}{{r}_{3}}\end{matrix}} )}^{2} + \\ \frac{20 \sqrt{3} ( \begin{matrix}[ \frac{Z - 10}{Z - 9} ] \\ ( 1 - \frac{\sqrt{2}}{2} ) {r}_{3}\end{matrix} )}{( \begin{matrix}( Z - 9 ) - \\ ( \frac{5}{24} - \frac{6}{Z} ) \frac{\sqrt{3}}{{r}_{3}}\end{matrix} )}\end{matrix}}}{2}$$
$${r}_{3} in units of {a}_{0}$$
$${r}_{11} = \frac{{a}_{0} ( 1 + \frac{8}{Z} \sqrt{\frac{3}{4}} )}{( Z - 10 ) - \frac{\sqrt{\frac{3}{4}}}{4 {r}_{10}}} , \\ {r}_{10} in units of {a}_{0}$$
$${r}_{12} = \frac{\frac{{a}_{0}}{( \begin{matrix}( Z - 11 ) - \\ ( \frac{1}{8} - \frac{3}{Z} ) \frac{\sqrt{3}}{{r}_{10}}\end{matrix} )} \pm {a}_{0} \sqrt{\begin{matrix}{( \frac{1}{\begin{matrix}( Z - 11 ) - \\ ( \frac{1}{8} - \frac{3}{Z} ) \frac{\sqrt{3}}{{r}_{10}}\end{matrix}} )}^{2} + \\ \frac{20 \sqrt{3} ( \begin{matrix}[ \frac{Z - 12}{Z - 11} ] \\ ( 1 + \frac{\sqrt{2}}{2} ) {r}_{10}\end{matrix} )}{( \begin{matrix}( Z - 11 ) - \\ ( \frac{1}{8} - \frac{3}{Z} ) \frac{\sqrt{3}}{{r}_{10}}\end{matrix} )}\end{matrix}}}{2}$$
$${r}_{10} in units of {a}_{0}$$
$${r}_{n} = \frac{\frac{{a}_{0}}{( \begin{matrix}( Z - ( n - 1 ) ) - \\ ( \frac{A}{8} - \frac{B}{2 Z} ) \frac{\sqrt{3}}{{r}_{12}}\end{matrix} )} \pm {a}_{0} \sqrt{\begin{matrix}{( \frac{1}{\begin{matrix}( Z - ( n - 1 ) ) - \\ ( \frac{A}{8} - \frac{B}{2 Z} ) \frac{\sqrt{3}}{{r}_{12}}\end{matrix}} )}^{2} + \\ \frac{20 \sqrt{3} ( \begin{matrix}[ \frac{Z - n}{Z - ( n - 1 )} ] \\ ( 1 - \frac{\sqrt{2}}{2} + \frac{1}{2} ) {r}_{12}\end{matrix} )}{( \begin{matrix}( Z - ( n - 1 ) ) - \\ ( \frac{A}{8} - \frac{B}{2 Z} ) \frac{\sqrt{3}}{{r}_{12}}\end{matrix} )}\end{matrix}}}{2}$$
$${r}_{12} in units of {a}_{0}$$
$${r}_{n} = \frac{\frac{{a}_{0} ( 1 + ( C - D ) \frac{\sqrt{3}}{2 Z} )}{( \begin{matrix}( Z - ( n - 1 ) ) - \\ ( \frac{A}{8} - \frac{B}{2 Z} ) \frac{\sqrt{3}}{{r}_{m}}\end{matrix} )} \pm {a}_{0} \sqrt{\begin{matrix}{( \frac{( 1 + ( C - D ) \frac{\sqrt{3}}{2 Z} )}{\begin{matrix}( Z - ( n - 1 ) ) - \\ ( \frac{A}{8} - \frac{B}{2 Z} ) \frac{\sqrt{3}}{{r}_{m}}\end{matrix}} )}^{2} + \\ \frac{20 \sqrt{3} ( [ \frac{Z - n}{Z - ( n - 1 )} ] {Er}_{m} )}{( \begin{matrix}( Z - ( n - 1 ) ) - \\ ( \frac{A}{8} - \frac{B}{2 Z} ) \frac{\sqrt{3}}{{r}_{m}}\end{matrix} )}\end{matrix}}}{2}$$
$${r}_{m} in units of {a}_{0}$$

58. The method of claim 53, wherein the electric energy of each electron of radius rₙ is given by at least one of the group comprising:
$$E ( electric ) = - \frac{( Z - ( n - 1 ) ) {e}^{2}}{8 {πɛ}_{o} {r}_{n}}$$
$$Ionization Energy ( He ) = - E ( electric ) + E ( magnetic ) ( 1 - \frac{1}{2} ( {( \frac{2}{3} cos \frac{π}{3} )}^{2} + α ) )$$
$$Ionization Energy = - Electric Energy - \frac{1}{Z} Magnetic Energy$$
$$E ( Ionization ) = - Electric Energy - \frac{1}{Z} Magnetic Energy - {E}_{T}$$
$$\begin{matrix}E ( ionization ; Li ) = \frac{( Z - 2 ) {e}^{2}}{8 {πɛ}_{o} {r}_{3}} + Δ {E}_{mag} \\ = 5.3178 eV + 0.0860 eV \\ = 5.4038 eV\end{matrix}$$
$$\begin{matrix}E ( ionization ; B ) = \frac{( Z - 4 ) {e}^{2}}{8 {πɛ}_{o} {r}_{5}} + Δ {E}_{mag} \\ = 8.147170901 eV + 0.15548501 eV \\ = 8.30265592 eV\end{matrix}$$
$$\begin{matrix}E ( ionization ; Be ) = \frac{( Z - 3 ) {e}^{2}}{8 {πɛ}_{o} {r}_{4}} + \frac{2 {πμ}_{0} {e}^{2} {ℏ}^{2}}{{m}_{e}^{2} {r}_{r}^{3}} Δ {E}_{mag} \\ = 8.9216 eV + 0.03226 eV + 0.33040 eV \\ = 9.28430 eV\end{matrix}$$
$$\begin{matrix}E ( ionization ; Na ) = - Electric Energy \\ = \frac{( Z - 10 ) {e}^{2}}{8 {πɛ}_{o} {r}_{11}} \\ = 5.12592 eV\end{matrix}$$

59. The method of claim 53, wherein the radii of s electrons are given by
$${r}_{n} = \frac{\frac{{a}_{0} ( 1 + ( C - D ) \frac{\sqrt{3}}{2 Z} )}{( \begin{matrix}( Z - ( n - 1 ) ) - \\ ( \frac{A}{8} - \frac{B}{2 Z} ) \frac{\sqrt{3}}{{r}_{m}}\end{matrix} )} \pm {a}_{0} \sqrt{\begin{matrix}{( \frac{( 1 + ( C - D ) \frac{\sqrt{3}}{2 Z} )}{\begin{matrix}( Z - ( n - 1 ) ) - \\ ( \frac{A}{8} - \frac{B}{2 Z} ) \frac{\sqrt{3}}{{r}_{m}}\end{matrix}} )}^{2} + \\ \frac{20 \sqrt{3} ( [ \frac{Z - n}{Z - ( n - 1 )} ] {Er}_{m} )}{( ( Z - ( n - 1 ) ) - ( \frac{A}{8} - \frac{B}{2 Z} ) \frac{\sqrt{3}}{{r}_{m}} )}\end{matrix}}}{2}$$
$${r}_{m} in units of {a}_{0}$$
where positive root must be taken in order that rₙ>0;
Z is the nuclear charge, n is the number of electrons,
rₘ is the radius of the proceeding filled shell(s) given by
$${r}_{n} = \frac{\frac{{a}_{0} ( 1 + ( C - D ) \frac{\sqrt{3}}{2 Z} )}{( \begin{matrix}( Z - ( n - 1 ) ) - \\ ( \frac{A}{8} - \frac{B}{2 Z} ) \frac{\sqrt{3}}{{r}_{m}}\end{matrix} )} \pm {a}_{0} \sqrt{\begin{matrix}{( \frac{( 1 + ( C - D ) \frac{\sqrt{3}}{2 Z} )}{\begin{matrix}( Z - ( n - 1 ) ) - \\ ( \frac{A}{8} - \frac{B}{2 Z} ) \frac{\sqrt{3}}{{r}_{m}}\end{matrix}} )}^{2} + \\ \frac{20 \sqrt{3} ( [ \frac{Z - n}{Z - ( n - 1 )} ] {Er}_{m} )}{( ( Z - ( n - 1 ) ) - ( \frac{A}{8} - \frac{B}{2 Z} ) \frac{\sqrt{3}}{{r}_{m}} )}\end{matrix}}}{2}$$
$${r}_{m} in units of {a}_{0}$$
for the preceding s shell(s);
$${r}_{n} = \frac{\frac{{a}_{0}}{( \begin{matrix}( Z - ( n - 1 ) ) - \\ ( \frac{A}{8} - \frac{B}{2 Z} ) \frac{\sqrt{3}}{{r}_{3}}\end{matrix} )} \pm {a}_{0} \sqrt{\begin{matrix}{( \frac{1}{\begin{matrix}( Z - ( n - 1 ) ) - \\ ( \frac{A}{8} - \frac{B}{2 Z} ) \frac{\sqrt{3}}{{r}_{3}}\end{matrix}} )}^{2} + \\ \frac{20 \sqrt{3} ( [ \frac{Z - n}{Z - ( n - 1 )} ] ( 1 - \frac{\sqrt{2}}{2} ) {r}_{3} )}{( ( Z - ( n - 1 ) ) - ( \frac{A}{8} - \frac{B}{2 Z} ) \frac{\sqrt{3}}{{r}_{3}} )}\end{matrix}}}{2}$$
$${r}_{3} in units of {a}_{0}$$
for the 2p shell, and
$${r}_{n} = \frac{\frac{{a}_{0}}{( \begin{matrix}( Z - ( n - 1 ) ) - \\ ( \frac{A}{8} - \frac{B}{2 Z} ) \frac{\sqrt{3}}{{r}_{12}}\end{matrix} )} \pm {a}_{0} \sqrt{\begin{matrix}{( \frac{1}{\begin{matrix}( Z - ( n - 1 ) ) - \\ ( \frac{A}{8} - \frac{B}{2 Z} ) \frac{\sqrt{3}}{{r}_{12}}\end{matrix}} )}^{2} + \\ \frac{20 \sqrt{3} ( \begin{matrix}[ \frac{Z - n}{Z - ( n - 1 )} ] \\ ( 1 - \frac{\sqrt{2}}{2} + \frac{1}{2} ) {r}_{12}\end{matrix} )}{( \begin{matrix}( Z - ( n - 1 ) ) - \\ ( \frac{A}{8} - \frac{B}{2 Z} ) \frac{\sqrt{3}}{{r}_{12}}\end{matrix} )}\end{matrix}}}{2}$$
$${r}_{12} in units of {a}_{0}$$
for the 3p shell;
the parameter A corresponds to the diamagnetic force, F_{diamagnetic}:
$${F}_{diamagnetic} = - \frac{{ℏ}^{2}}{4 {m}_{e} {r}_{3}^{2} {r}_{1}} \sqrt{s ( s + 1 )} {i}_{r} ;$$
the parameter B corresponds to the paramagnetic force, F_{mag 2}:
$${F}_{mag 2} = \frac{1}{Z} \frac{{ℏ}^{2}}{{m}_{e} {r}_{1} {r}_{4}^{2}} \sqrt{s ( s + 1 )} {i}_{r} ;$$
the parameter C corresponds to the diamagnetic force, F_{diamagnetic 3}:
$${F}_{diamagnetic 3} = - \frac{1}{Z} \frac{8 {ℏ}^{2}}{{m}_{e} {r}_{11}^{3}} \sqrt{s ( s + 1 )} {i}_{r} ;$$
the parameter D corresponds to the paramagnetic force, F_{mag}:
$${F}_{mag} = \frac{1}{4 π {r}_{2}^{2}} \frac{1}{Z} \frac{{ℏ}^{2}}{{m}_{e} {r}^{3}} \sqrt{s ( s + 1 )} ,$$
and
the parameter E corresponds to the diamagnetic force, F_{diamagnetic 2}, due to a relativistic effect with an electric field for r>rₙ:
$${F}_{diamagnetic 2} = - [ \frac{Z - 3}{Z - 2} ] \frac{{r}_{1} {ℏ}^{2}}{{m}_{e} {r}_{3}^{4}} 10 \sqrt{3 / 4} {i}_{r}$$
$${F}_{diamagnetic 2} = - [ \frac{Z - 11}{Z - 10} ] ( 1 + \frac{\sqrt{2}}{2} ) \frac{{r}_{10} {ℏ}^{2}}{{m}_{e} {r}_{11}^{4}} 10 \sqrt{s ( s + 1 )} {i}_{r} , \\ and$$
$${F}_{diamagnetic 2} = - [ \frac{Z - n}{Z - ( n - 1 )} ] ( \begin{matrix}1 - \frac{\sqrt{2}}{2} + \frac{1}{2} - \\ \frac{\sqrt{2}}{2} + \frac{1}{2}\end{matrix} ) \frac{{r}_{18} {ℏ}^{2}}{{m}_{e} {r}_{n}^{4}} 10 \sqrt{s ( s + 1 )} {i}_{r} .$$
wherein the parameters of atoms filling the 1 s, 2s, 3s, and 4s orbitals are

| | | | Orbital | Diamag. | Paramag. | Diamag. | Paramag. | Diamag. |
|---|---|---|---|---|---|---|---|---|
| | | Ground | Arrangement | Force | Force | Force | Force | Force |
| Atom | Electron | State | of s Electrons | Factor | Factor | Factor | Factor | Factor |
| Type | Configuration | Term | (s state) | A | B | C | D | E |
| Neutral 1 e Atom H | 1s¹ | ²S_{1/2} | $\frac{↑}{1 s}$ | 0 | 0 | 0 | 0 | 0 |
| Neutral 2 e Atom He | 1s² | ¹S₀ | $\frac{↑ ↓}{1 s}$ | 0 | 0 | 0 | 1 | 0 |
| Neutral 3 e Atom Li | 2s¹ | ²S_{1/2} | $\frac{↑}{2 s}$ | 1 | 0 | 0 | 0 | 0 |
| Neutral 4 e Atom Be | 2s² | ¹S₀ | $\frac{↑ ↓}{2 s}$ | 1 | 0 | 0 | 1 | 0 |
| Neutral 11 e Atom Na | 1s²2s²2p⁶3s¹ | ²S_{1/2} | $\frac{↑}{3 s}$ | 1 | 0 | 8 | 0 | 0 |
| Neutral 12 e Atom Mg | 1s²2s²2p⁶3s² | ¹S₀ | $\frac{↑ ↓}{3 s}$ | 1 | 3 | 12 | 1 | 0 |
| Neutral 19 e Atom K | 1s²2s²2p⁶3s²3p⁶4s¹ | ²S_{1/2} | $\frac{↑}{4 s}$ | 2 | 0 | 12 | 0 | 0 |
| Neutral 20 e Atom Ca | 1s²2s²2p⁶3s²3p⁶4s² | ¹S₀ | $\frac{↑ ↓}{4 s}$ | 1 | 3 | 24 | 1 | 0 |
| 1 e Ion | 1s¹ | ²S_{1/2} | $\frac{↑}{1 s}$ | 0 | 0 | 0 | 0 | 0 |
| 2 e Ion | 1s² | ¹S₀ | $\frac{↑ ↓}{1 s}$ | 0 | 0 | 0 | 1 | 0 |
| 3 e Ion | 2s¹ | ²S_{1/2} | $\frac{↑}{2 s}$ | 1 | 0 | 0 | 0 | 1 |
| 4 e Ion | 2s² | ¹S₀ | $\frac{↑ ↓}{2 s}$ | 1 | 0 | 0 | 1 | 1 |
| 11 e Ion | 1s²2s²2p⁶3s¹ | ²S_{1/2} | $\frac{↑}{3 s}$ | 1 | 4 | 8 | 0 | $1 + \frac{\sqrt{2}}{2}$ |
| 12 e Ion | 1s²2s²2p⁶3s² | ¹S₀ | $\frac{↑ ↓}{3 s}$ | 1 | 6 | 0 | 0 | $1 + \frac{\sqrt{2}}{2}$ |
| 19 e Ion | 1s²2s²2p⁶3s²3p⁶4s¹ | ²S_{1/2} | $\frac{↑}{4 s}$ | 3 | 0 | 24 | 0 | 2 − \sqrt{2} |
| 20 e Ion | 1s²2s²2p⁶3s²3p⁶4s² | ¹S₀ | $\frac{↑ ↓}{4 s}$ | 2 | 0 | 24 | 0 | 2 − \sqrt{2} |

60. The method of claim 59, with the radii, rₙ, wherein the ionization energy for atoms having an outer s-shell are given by the negative of the electric energy, E(electric), given by:
$$E ( Ionization ) = - Electric Energy = \frac{( Z - ( n - 1 ) ) {e}^{2}}{8 {πɛ}_{o} {r}_{n}}$$
except that minor corrections due to the magnetic energy must be included in cases wherein the s electron does not couple to p electrons as given by
$$Ionization Energy ( He ) = - E ( electric ) + E ( magnetic ) ( 1 - \frac{1}{2} ( {( \frac{2}{3} cos \frac{π}{3} )}^{2} + α ) )$$
$$Ionization Energy = - Electric Energy - \frac{1}{Z} Magnetic Energy$$
$$\begin{matrix}E ( ionization ; Li ) = \frac{( Z - 2 ) {e}^{2}}{8 {πɛ}_{o} {r}_{3}} + Δ {E}_{mag} \\ = 5.3178 eV + 0.0860 eV \\ = 5.4038 eV\end{matrix}$$
$$E ( Ionization ) = E ( Electric ) + {E}_{T}$$
$$\begin{matrix}E ( ionization ; Be ) = \frac{( Z - 3 ) {e}^{2}}{8 {πɛ}_{o} {r}_{4}} + \frac{2 {πμ}_{0} {e}^{2} {ℏ}^{2}}{{m}_{e}^{r} {r}_{4}^{3}} + Δ {E}_{mag} \\ = 8.9216 eV + 0.03226 eV + 0.33040 eV \\ = 9.28430 eV ,\end{matrix}$$
$$and$$
$$E ( Ionization ) = - Electric Energy - \frac{1}{Z} Magnetic Energy - {E}_{T} .$$

61. The method of claim 53, wherein the radii and energies of the 2p electrons are solved using the forces given by
$${F}_{ele} = \frac{( Z - n ) {e}^{2}}{4 {πɛ}_{o} {r}_{n}^{2}} {i}_{r}$$
$${F}_{diamagnetic} = - {\sum }_{m} \frac{( l + \vert m \vert ) !}{( 2 l + 1 ) ( l - \vert m \vert ) !} \frac{{ℏ}^{2}}{4 {m}_{e} {r}_{n}^{2} {r}_{3}} \sqrt{s ( s + 1 )} {i}_{r}$$
$${F}_{mag 2} = \frac{1}{Z} \frac{{ℏ}^{2}}{{m}_{e} {r}_{n}^{2} {r}_{3}} \sqrt{s ( s + 1 )} {i}_{r}$$
$${F}_{mag 2} = \frac{1}{Z} \frac{4 {ℏ}^{2}}{{m}_{e} {r}_{n}^{2} {r}_{3}} \sqrt{s ( s + 1 )} {i}_{r}$$
$${F}_{mag 2} = \frac{1}{Z} \frac{{ℏ}^{2}}{{m}_{e} {r}_{n}^{2} {r}_{3}} \sqrt{s ( s + 1 )} {i}_{r}$$
$${F}_{diamagnetic 2 } = - [ \frac{Z - n}{Z - ( n - 1 )} ] ( 1 - \frac{\sqrt{2}}{2} ) \frac{{r}_{3} {ℏ}^{2}}{{m}_{e} {r}_{n}^{4}} 10 \sqrt{s ( s + 1 )} {i}_{r} ,$$
and the radii r₂ are given by
$${r}_{4} = {r}_{3} = \frac{( \begin{matrix}\frac{{a}_{0} ( 1 - \frac{\sqrt{\frac{3}{4}}}{Z} )}{( ( Z - 3 ) - ( \frac{1}{4} - \frac{1}{Z} ) \frac{\sqrt{\frac{3}{4}}}{{r}_{1}} )} \pm {a}_{o} \\ \sqrt{\frac{{( 1 - \frac{\sqrt{\frac{3}{4}}}{Z} )}^{2}}{{( \begin{matrix}( Z - 3 ) - \\ ( \frac{1}{4} - \frac{1}{Z} ) \frac{\sqrt{\frac{3}{4}}}{{r}_{1}}\end{matrix} )}^{2}} + 4 \frac{[ \frac{Z - 3}{Z - 2} ] {r}_{1} 10 \sqrt{\frac{3}{4}}}{( \begin{matrix}( Z - 3 ) - \\ ( \frac{1}{4} - \frac{1}{Z} ) \frac{\sqrt{\frac{3}{4}}}{{r}_{1}}\end{matrix} )}}\end{matrix} )}{2}$$
$${r}_{1} in units of {a}_{o}$$

62. The method of claim 61, wherein the electric energy given by
$$E ( Ionization ) = - Electric Energy = \frac{( Z - ( n - 1 ) ) {e}^{2}}{8 {πɛ}_{o} {r}_{n}}$$
gives the corresponding ionization energies.

63. The method of claim 53, wherein for each n-electron atom having a central charge of Z times that of the proton and an electron configuration 1s²2s²2pⁿ⁻⁴, there are two indistinguishable spin-paired electrons in an orbitsphere with radii r₁ and r₂ both given by:
$${r}_{1} = {r}_{2} = {a}_{o} [ \frac{1}{Z - 1} - \frac{\sqrt{\frac{3}{4}}}{Z ( Z - 1 )} ] ;$$
two indistinguishable spin-paired electrons in an orbitsphere with radii r₃ and r₄ both given by:
$${r}_{4} = {r}_{3} = \frac{( \begin{matrix}\frac{{a}_{0} ( 1 - \frac{\sqrt{\frac{3}{4}}}{Z} )}{( ( Z - 3 ) - ( \frac{1}{4} - \frac{1}{Z} ) \frac{\sqrt{\frac{3}{4}}}{{r}_{1}} )} \pm {a}_{o} \\ \sqrt{\frac{{( 1 - \frac{\sqrt{\frac{3}{4}}}{Z} )}^{2}}{{( \begin{matrix}( Z - 3 ) - \\ ( \frac{1}{4} - \frac{1}{Z} ) \frac{\sqrt{\frac{3}{4}}}{{r}_{1}}\end{matrix} )}^{2}} + 4 \frac{[ \frac{Z - 3}{Z - 2} ] {r}_{1} 10 \sqrt{\frac{3}{4}}}{( \begin{matrix}( Z - 3 ) - \\ ( \frac{1}{4} - \frac{1}{Z} ) \frac{\sqrt{\frac{3}{4}}}{{r}_{1}}\end{matrix} )}}\end{matrix} )}{2}$$
$${r}_{1} in units of {a}_{o}$$
and n−4 electrons in an orbitsphere with radius rₙ given by
$${r}_{n} = \frac{\frac{{a}_{0}}{( \begin{matrix}( Z - ( n - 1 ) ) - \\ ( \frac{A}{8} - \frac{B}{2 Z} ) \frac{\sqrt{3}}{{r}_{3}}\end{matrix} )} \pm {a}_{0} \sqrt{+ \frac{\begin{matrix}{( \frac{1}{( \begin{matrix}( Z - ( n - 1 ) ) - \\ ( \frac{A}{8} - \frac{B}{2 Z} ) \frac{\sqrt{3}}{{r}_{3}}\end{matrix} )} )}^{2} \\ 20 \sqrt{3} ( [ \frac{Z - n}{Z - ( n - 1 )} ] ( 1 - \frac{\sqrt{2}}{2} ) {r}_{3} )\end{matrix}}{( \begin{matrix}( Z - ( n - 1 ) ) - \\ ( \frac{A}{8} - \frac{B}{2 Z} ) \frac{\sqrt{3}}{{r}_{3}}\end{matrix} )}}}{2} ;$$
$${r}_{3} in units of {a}_{0}$$
the positive root must be taken in order that rₙ>0;
the parameter A corresponds to the diamagnetic force, F_{diamagnetic}:
$${F}_{diamagnetic} = - {\sum }_{m} \frac{( l + \vert m \vert ) !}{( 2 l + 1 ) ( l - \vert m \vert ) !} \frac{{ℏ}^{2}}{4 {m}_{e} {r}_{n}^{2} {r}_{3}} \sqrt{s ( s + 1 )} {i}_{r} ;$$
and the parameter B corresponds to the paramagnetic force, F_{mag 2}:
$${F}_{mag 2} = \frac{1}{Z} \frac{{ℏ}^{2}}{{m}_{e} {r}_{n}^{2} {r}_{3}} \sqrt{s ( s + 1 )} {i}_{r} , \\ {F}_{mag 2} = \frac{1}{Z} \frac{4 {ℏ}^{2}}{{m}_{e} {r}_{n}^{2} {r}_{3}} \sqrt{s ( s + 1 )} {i}_{r} , \\ and$$
$${F}_{mag 2} = \frac{1}{Z} \frac{{ℏ}^{2}}{{m}_{e} {r}_{n}^{2} {r}_{3}} \sqrt{s ( s + 1 )} {i}_{r} .$$
wherein the parameters of five through ten-electron atoms are

| | | | Orbital | Diamagnetic | Paramagnetic |
|---|---|---|---|---|---|
| | | Ground | Arrangement of | Force | Force |
| | Electron | State | 2p Electrons | Factor | Factor |
| Atom Type | Configuration | Term | (2p state) | A | B |
| Neutral 5 e Atom B | 1s²2s²2p¹ | ²P_{1/2}⁰ | $\frac{↑}{1} \frac{ }{0} \frac{ }{- 1}$ | 2 | 0 |
| Neutral 6 e Atom C | 1s²2s²2p² | ³P₀ | $\frac{↑}{1} \frac{↑}{0} \frac{ }{- 1}$ | $\frac{2}{3}$ | 0 |
| Neutral 7 e Atom N | 1s²2s²2p³ | ⁴S_{3/2}⁰ | $\frac{↑}{1} \frac{↑}{0} \frac{↑}{- 1}$ | $\frac{1}{3}$ | 1 |
| Neutral 8 e Atom O | 1s²2s²2p⁴ | ³P₂ | $\frac{↑ ↓}{1} \frac{↑}{0} \frac{↑}{- 1}$ | 1 | 2 |
| Neutral 9 e Atom F | 1s²2s²2p⁵ | ²P_{3/2}⁰ | $\frac{↑ ↓}{1} \frac{↑ ↓}{0} \frac{↑}{- 1}$ | $\frac{2}{3}$ | 3 |
| Neutral 10 e Atom Ne | 1s²2s²2p⁶ | ¹S₀ | $\frac{↑ ↓}{1} \frac{↑}{0} \frac{↑ ↓}{- 1}$ | 0 | 3 |
| 5 e Ion | 1s²2s²2p¹ | ²P_{1/2}⁰ | $\frac{↑}{1} \frac{ }{0} \frac{ }{- 1}$ | $\frac{5}{3}$ | 1 |
| 6 e Ion | 1s²2s²2p² | ³P₀ | $\frac{↑}{1} \frac{↑}{0} \frac{ }{- 1}$ | $\frac{5}{3}$ | 4 |
| 7 e Ion | 1s²2s²2p³ | ⁴S_{3/2}⁰ | $\frac{↑}{1} \frac{↑}{0} \frac{↑}{- 1}$ | $\frac{5}{3}$ | 6 |
| 8 e Ion | 1s²2s²2p⁴ | ³P₂ | $\frac{↑ ↓}{1} \frac{↑}{0} \frac{↑}{- 1}$ | $\frac{5}{3}$ | 6 |
| 9 e Ion | 1s²2s²2p⁵ | ²P_{3/2}⁰ | $\frac{↑ ↓}{1} \frac{↑ ↓}{0} \frac{↑}{- 1}$ | $\frac{5}{3}$ | 9 |
| 10 e Ion | 1s²2s²2p⁶ | ¹S₀ | $\frac{↑ ↓}{1} \frac{↑ ↓}{0} \frac{↑ ↓}{- 1}$ | $\frac{5}{3}$ | 12 |

64. The method of claim 63, wherein the ionization energy for the boron atom is given by
$$\begin{matrix}E ( ionization ; B ) = \frac{( Z - 4 ) {e}^{2}}{8 {πɛ}_{o} {r}_{5}} + Δ {E}_{mag} \\ = 8.147170901 eV + 0.15548501 eV \\ = 8.30265592 eV .\end{matrix}$$

65. The method of claim 63, wherein the ionization energies for the n-electron atoms having the radii, rₙ, are given by the negative of the electric energy, E(electric), given by
$$E ( Ionization ) = - Electric Energy = \frac{( Z - ( n - 1 ) ) {e}^{2}}{8 π {ɛ}_{o} {r}_{n}} .$$

66. The method of claim 53, wherein the radii of the 3p electrons are given using the forces given by
$$\begin{matrix}{F}_{ele} = \frac{( Z - n ) {e}^{2}}{4 π {ɛ}_{o} {r}_{n}^{2}} {i}_{r} \\ {F}_{diamagnetic} = - {\sum }_{m}^{ } \frac{( l + \vert m \vert ) l}{( 2 l + 1 ) ( l - \vert m \vert ) l} \frac{{ℏ}^{2}}{4 {m}_{e} {r}_{n}^{2} {r}_{12}} \sqrt{s ( s + 1 )} {i}_{r} \\ {F}_{diamagnetic} = - ( \frac{2}{3} + \frac{2}{3} + \frac{1}{3} ) \frac{{ℏ}^{2}}{4 {m}_{e} {r}_{n}^{2} {r}_{12}} \sqrt{s ( s + 1 )} {i}_{r} \\ = - ( \frac{5}{3} ) \frac{{ℏ}^{2}}{4 {m}_{e} {r}_{n}^{2} {r}_{12}} \sqrt{s ( s + 1 )} {i}_{r} \\ {F}_{mag2} = \frac{1}{Z} \frac{{ℏ}^{2}}{ {m}_{e} {r}_{n}^{2} {r}_{12}} \sqrt{s ( s + 1 )} {i}_{r} \\ {F}_{mag2} = ( 4 + 4 + 4 ) \frac{1}{Z} \frac{{ℏ}^{2}}{{m}_{e} {r}_{n}^{2} {r}_{12}} \sqrt{s ( s + 1 )} {i}_{r} \\ = \frac{1}{Z} \frac{12 {ℏ}^{2}}{{m}_{e} {r}_{n}^{2} {r}_{12}} \sqrt{s ( s + 1 )} {i}_{r} \\ {F}_{mag2} = \frac{1}{Z} \frac{4 {ℏ}^{2}}{{m}_{e} {r}_{n}^{2} {r}_{12}} \sqrt{s ( s + 1 )} {i}_{r} \\ {F}_{mag2} = \frac{1}{Z} \frac{4 {ℏ}^{2}}{{m}_{e} {r}_{n}^{2} {r}_{12}} \sqrt{s ( s + 1 )} {i}_{r} \\ {F}_{mag2} = \frac{1}{Z} \frac{8 {ℏ}^{2}}{{m}_{e} {r}_{n}^{2} {r}_{12}} \sqrt{s ( s + 1 )} {i}_{r}\end{matrix}$$
and the radii r₁₂ are given by
$${r}_{12} = \frac{\frac{{a}_{0}}{( ( Z - 11 ) - ( \frac{1}{8} - \frac{3}{Z} ) \frac{\sqrt{3}}{{r}_{10}} )} \pm {a}_{0} \sqrt{\begin{matrix}{( \frac{1}{( ( Z - 11 ) - ( \frac{1}{8} - \frac{3}{Z} ) \frac{\sqrt{3}}{{r}_{10}} )} )}^{2} + \\ \frac{20 \sqrt{3} ( [ \frac{Z - 12}{Z - 11} ] ( 1 + \frac{\sqrt{2}}{2} ) {r}_{10} )}{( ( Z - 11 ) - ( \frac{1}{8} - \frac{3}{Z} ) \frac{\sqrt{3}}{{r}_{10}} )}\end{matrix}}}{2} . \\ {r}_{10} in units of {a}_{0}$$

67. The method of claim 66, wherein the ionization energies are given by electric energy given by:
$$E ( Ionization ) = - Electric Energy = \frac{( Z - ( n - 1 ) ) {e}^{2}}{8 {πɛ}_{0} {r}_{n}} .$$

68. The method of claim 53, wherein for each n-electron atom having a central charge of Z times that of the proton and an electron configuration 1s²2s²2p⁶3s²3pⁿ⁻², there are two indistinguishable spin-paired electrons in an orbitsphere with radii r₁ and r₂ both given by:
$${r}_{1} = {r}_{2} = {a}_{0} [ \frac{1}{Z - 1} - \frac{\sqrt{\frac{3}{4}}}{Z ( Z - 1 )} ]$$
two indistinguishable spin-paired electrons in an orbitsphere with radii r₃ and r₄ both given by:
$${r}_{4} = {r}_{3} = \frac{( \begin{matrix}\frac{{a}_{0} ( 1 - \frac{\sqrt{\frac{3}{4}}}{Z} )}{( ( Z - 3 ) - ( \frac{1}{4} - \frac{1}{Z} ) \frac{\sqrt{\frac{3}{4}}}{{r}_{1}} )} \pm {a}_{0} \\ \sqrt{\frac{{( 1 - \frac{\sqrt{\frac{3}{4}}}{Z} )}^{2}}{{( ( Z - 3 ) - ( \frac{1}{4} - \frac{1}{Z} ) \frac{\sqrt{\frac{3}{4}}}{{r}_{1}} )}^{2}} + 4 \frac{[ \frac{Z - 3}{Z - 2} ] {r}_{1} 10 \sqrt{\frac{3}{4}}}{( ( Z - 3 ) - ( \frac{1}{4} - \frac{1}{Z} ) \frac{\sqrt{\frac{3}{4}}}{{r}_{1}} )}}\end{matrix} ) }{2}$$
$${r}_{1} in units of {a}_{0}$$
three sets of paired indistinguishable electrons in an orbitsphere with radius r₁₀ given by:
$${r}_{10} = \frac{\frac{{a}_{0}}{( ( Z - 9 ) - ( \frac{5}{24} - \frac{6}{Z} ) \frac{\sqrt{3}}{{r}_{3}} )} \pm {a}_{0} \sqrt{\begin{matrix}{( \frac{1}{( ( Z - 9 ) - ( \frac{5}{24} - \frac{6}{Z} ) \frac{\sqrt{3}}{{r}_{3}} )} )}^{2} + \\ \frac{20 \sqrt{3} ( [ \frac{Z - 10}{Z - 9} ] ( 1 - \frac{\sqrt{2}}{2} ) {r}_{3} )}{( ( Z - 9 ) - ( \frac{5}{24} - \frac{6}{Z} ) \frac{\sqrt{3}}{{r}_{3}} )}\end{matrix}}}{2}$$
$${r}_{3} in units of {a}_{0}$$
two indistinguishable spin-paired electrons in an orbitsphere with radius r₁₂ given by:
$${r}_{12} = \frac{\frac{{a}_{0}}{( ( Z - 11 ) - ( \frac{1}{8} - \frac{3}{Z} ) \frac{\sqrt{3}}{{r}_{10}} )} \pm {a}_{0} \sqrt{\begin{matrix}{( \frac{1}{( ( Z - 11 ) - ( \frac{1}{8} - \frac{3}{Z} ) \frac{\sqrt{3}}{{r}_{10}} )} )}^{2} + \\ \frac{20 \sqrt{3} ( [ \frac{Z - 12}{Z - 11} ] ( 1 + \frac{\sqrt{2}}{2} ) {r}_{10} )}{( ( Z - 11 ) - ( \frac{1}{8} - \frac{3}{Z} ) \frac{\sqrt{3}}{{r}_{10}} )}\end{matrix}}}{2}$$
$${r}_{10} in units of {a}_{0}$$
and n−12 electrons in a 3p orbitsphere with radius rₙ given by
$${r}_{n} = \frac{\frac{{a}_{0}}{( \begin{matrix}( Z - ( n - 1 ) ) - \\ ( \frac{A}{8} - \frac{B}{2 Z} ) \frac{\sqrt{3}}{{r}_{12}}\end{matrix} )} \pm {a}_{0} \sqrt{\begin{matrix}{( \frac{1}{( ( Z - ( n - 1 ) ) - ( \frac{A}{8} - \frac{B}{2 Z} ) \frac{\sqrt{3}}{{r}_{12}} )} )}^{2} + \\ \frac{20 \sqrt{3} ( [ \frac{Z - n}{Z - ( n - 1 )} ] ( 1 - \frac{\sqrt{2}}{2} + \frac{1}{2} ) {r}_{12} )}{( ( Z - ( n - 1 ) ) - ( \frac{A}{8} - \frac{B}{2 Z} ) \frac{\sqrt{3}}{{r}_{12}} )}\end{matrix}}}{( 2 )}$$
$${r}_{12} in units of {a}_{0}$$
where the positive root must be taken in order that r₁>0;
the parameter A corresponds to the diamagnetic force, F_{diamagnetic}:
$${F}_{diamagnetic} = - {\sum }_{m}^{ } \frac{( l + \vert m \vert ) l}{( 2 l + 1 ) ( l - \vert m \vert ) l} \frac{{ℏ}^{2}}{4 {m}_{e} {r}_{n}^{2} {r}_{12}} \sqrt{s ( s + 1 )} {i}_{r} ,$$
and the parameter B corresponds to the paramagnetic force, F_{mag 2}:
$$\begin{matrix}{F}_{mag 2} = \frac{1}{Z} \frac{{ℏ}^{2}}{ {m}_{e} {r}_{n}^{2} {r}_{12}} \sqrt{s ( s + 1 )} {i}_{r} \\ {F}_{mag 2} = ( 4 + 4 + 4 ) \frac{1}{Z} \frac{{ℏ}^{2}}{ {m}_{e} {r}_{n}^{2} {r}_{12}} \sqrt{s ( s + 1 )} {i}_{r} \\ = \frac{1}{Z} \frac{12 {ℏ}^{2}}{ {m}_{e} {r}_{n}^{2} {r}_{12}} \sqrt{s ( s + 1 )} {i}_{r} \\ {F}_{mag 2} = \frac{1}{Z} \frac{4 {ℏ}^{2}}{ {m}_{e} {r}_{n}^{2} {r}_{12}} \sqrt{s ( s + 1 )} {i}_{r} \\ {F}_{mag 2} = \frac{1}{Z} \frac{4 {ℏ}^{2}}{ {m}_{e} {r}_{n}^{2} {r}_{12}} \sqrt{s ( s + 1 )} {i}_{r} , and \\ {F}_{mag 2} = \frac{1}{Z} \frac{8 {ℏ}^{2}}{ {m}_{e} {r}_{n}^{2} {r}_{12}} \sqrt{s ( s + 1 )} {i}_{r} ,\end{matrix}$$
wherein the parameters of thirteen to eighteen-electron atoms are

| | | | Orbital | Diamagnetic | Paramagnetic |
|---|---|---|---|---|---|
| | | Ground | Arrangement of | Force | Force |
| | Electron | State | 3p Electrons | Factor | Factor |
| Atom Type | Configuration | Term | (3p state) | A | B |
| Neutral 13 e Atom Al | 1s²2s²2p⁶3s²3p¹ | ²P_{1/2}⁰ | $\frac{↑}{1} \frac{ }{0} \frac{ }{- 1}$ | $\frac{11}{3}$ | 0 |
| Neutral 14 e Atom Si | 1s²2s²2p⁶3s²3p² | ³P₀ | $\frac{↑}{1} \frac{↑}{0} \frac{ }{- 1}$ | $\frac{7}{3}$ | 0 |
| Neutral 15 e Atom P | 1s²2s²2p⁶3s²3p³ | ⁴S_{3/2}⁰ | $\frac{↑}{1} \frac{↑}{0} \frac{↑}{- 1}$ | $\frac{5}{3}$ | 2 |
| Neutral 16 e Atom S | 1s²2s²2p⁶3s²3p⁴ | ³P₂ | $\frac{↑ ↓}{1} \frac{↑}{0} \frac{↑}{- 1}$ | $\frac{4}{3}$ | 1 |
| Neutral 17 e Atom Cl | 1s²2s²2p⁶3s²3p⁵ | ²P_{3/2}⁰ | $\frac{↑ ↓}{1} \frac{↑ ↓}{0} \frac{↑}{- 1}$ | $\frac{2}{3}$ | 2 |
| Neutral 18 e Atom Ar | 1s²2s²2p⁶3s²3p⁶ | ¹S₀ | $\frac{↑ ↓}{1} \frac{↑ ↓}{0} \frac{↑ ↓}{- 1}$ | $\frac{1}{3}$ | 4 |
| 13 e Ion | 1s²2s²2p⁶3s²3p¹ | ²P_{1/2}⁰ | $\frac{↑}{1} \frac{ }{0} \frac{ }{- 1}$ | $\frac{5}{3}$ | 12 |
| 14 e Ion | 1s²2s²2p⁶3s²3p² | ³P₀ | $\frac{↑}{1} \frac{↑}{0} \frac{ }{- 1}$ | $\frac{1}{3}$ | 16 |
| 15 e Ion | 1s²2s²2p⁶3s²3p³ | ⁴S_{3/2}⁰ | $\frac{↑}{1} \frac{↑}{0} \frac{↑}{- 1}$ | 0 | 24 |
| 16 e Ion | 1s²2s²2p⁶3s²3p⁴ | ³P₂ | $\frac{↑ ↓}{1} \frac{↑}{0} \frac{↑}{- 1}$ | $\frac{1}{3}$ | 24 |
| 17 e Ion | 1s²2s²2p⁶3s²3p⁵ | ²P_{3/2}⁰ | $\frac{↑ ↓}{1} \frac{↑ ↓}{0} \frac{↑}{- 1}$ | $\frac{2}{3}$ | 32 |
| 18 e Ion | 1s²2s²2p⁶3s²3p⁶ | ¹S₀ | $\frac{↑ ↓}{1} \frac{↑ ↓}{0} \frac{↑ ↓}{- 1}$ | 0 | 40 |

69. The method of claim 68 wherein the ionization energies for the n-electron 3p atoms are given by electric energy given by:
$$E ( Ionization ) = - Electric Energy = \frac{( Z - ( n - 1 ) ) {e}^{2}}{8 {πɛ}_{0} {r}_{n}} .$$

70. The method of claim 68 wherein the ionization energy for the aluminum atom is given by
$$\begin{matrix} E ( ionization ; Al ) = \frac{( Z - 12 ) {e}^{2}}{8 {πɛ}_{0} {r}_{13}} + Δ {E}_{mag} \\ = 5.95270 eV + 0.031315 eV \\ = 5.98402 eV\end{matrix}$$
